(19) United States
(12) Patent Application Publication
(10) Pub. No.: US 2015/0363725 A1
(43) Pub. Date: Dec. 17, 2015

(54) Systems and Methods for Flexible Sourcing Systems

(71) Applicant: Trade Extensions TradeExt AB, Uppsala (SE)

(72) Inventors: Arne Andersson, Uppsala (SE); Fredrik Ygge, Vastra Frolunda (SE); Mattias Willman, Uppsala (SE); Ulf Ekström, Knivsta (SE); Claes Ekström, Uppsala (SE); Roger Björnstedt, Helsingborg (SE)

(21) Appl. No.: 14/738,315

(22) Filed: Jun. 12, 2015

Related U.S. Application Data
(60) Provisional application No. 62/012,079, filed on Jun. 13, 2014.
(60) Provisional application No. 62/083,793, filed on Nov. 24, 2014.

(51) Int. Cl. G06Q 10/06

(52) U.S. Cl. CPC G06Q 10/06313

(57) ABSTRACT

Systems, apparatuses, and methods for managing advanced projects such as optimization-based e-sourcing and resource allocation. A number of components and methods allow a user to specify complex content in a tender or project. Advantageously, manual work outside the system and the need for tailoring an existing system by custom programming is decreased.

### PRIORITY INFORMATION

This application claims benefit of priority to U.S. Provisional Application Ser. No. 62/012,079, filed Jun. 13, 2014, which is hereby incorporated by reference in its entirety as though fully and completely set forth herein. This application also claims benefit of priority to U.S. Provisional Application Ser. No. 62/083,793, filed Nov. 24, 2014, which is hereby incorporated by reference in its entirety as though fully and completely set forth herein.

### BACKGROUND

1. Technical Field

This invention relates to improved systems and methods for e-sourcing, and more particularly to systems and methods for providing flexible sourcing systems.

2. Description of the Related Art

E-sourcing (electronic sourcing) systems provide ways to electronically manage tenders where suppliers compete for the opportunity to provide products and/or services. In the past, tenders have been run using different solutions. The classic approach has been the semi-manual approach. The semi-manual approach is generally based on spreadsheet/e-mail and entails the burden of collecting, compiling, and analyzing numerous replies. This becomes particularly cumbersome when dealing with numerous potential suppliers and numerous items to collect. There are a number of disadvantages to this approach. For example, the manual approach is time consuming, incomplete bid forms and data errors require manual correction, and it is difficult to quickly have a global view of the progress and results of the tender.

More recently, automated approaches have arisen to manage tenders. Modern global sourcing tenders can concern tens of thousands of bought items, hundreds of bidders distributed over several continents, and collected data can include price and large number of quality attributes, environmental attributes etc. Such computerized and network based systems are essential for being able to conduct large and complex tenders. They cannot be performed with manual approaches, and also semi-manual computer and network processes as described above are inadequate for managing such tenders.

While such approaches can alleviate some of the disadvantages of the manual approach described above, these approaches generally require specific tools that are customized for particular areas. For example, a tender system may be developed to manage marine tenders. Accordingly, such approaches are relatively expensive in that they are only useful in certain contexts, and are relatively inflexible.

Furthermore, in electronic bidding systems buyers may want costs broken down into various components. For example, a buyer may want a break down between manufacturing costs and handling costs for one or more products. In the prior art, the buyer may configure the system to receive bids that have (for example) two fields (manufacturing and handling) and then specify that the total price is the sum. However, when there are many products, this approach can be burdensome. For example, if there are 1000 products divided into 50 groups, and handling costs are the same for products in a given product group, requiring submission of a handling costs for every bid is cumbersome.

E-sourcing (electronic sourcing) systems provide ways to electronically manage tenders where suppliers compete for the opportunity to provide products and/or services. In the past, tenders have been run using different solutions. The classic approach has been the manual approach. The manual approach is generally based on spreadsheet/e-mail and entails the burden of collecting, compiling, and analyzing numerous replies. This becomes particularly cumbersome when dealing with numerous potential suppliers and numerous items to collect. There are a number of disadvantages to this approach. For example, the manual approach is time consuming, incomplete bid forms and data errors require manual correction, and it is difficult to quickly have a global view of the progress and results of the tender.

More recently, automated approaches have arisen to manage tenders. While such approaches can alleviate some of the disadvantages of the manual approach described above, these approaches generally require specific tools that are customized for particular areas.

Furthermore, e-sourcing has developed from small e-auctions over tens of independent items and tens of bidders to covering very large and complex tenders over hundreds of thousands of, sometimes heavily interdependent, items and thousands of bidders. On top of this, expressiveness in terms of constraints and conditions on the bidder side, as well business rules and considerations on the manager's side, has resulted in long processing times.

Current methods and systems do not handle this complexity well, with long waiting times and inefficient processes as a result. For example, the time needed to calculate and provide desired bidder feedback may be long.

Embodiments described herein speed up several core tasks of an e-sourcing system as well as providing methods and systems which are responsive and efficient even when some or many of the involved tasks are computationally complex.

In view of the above, what is desired is a dynamic and flexible system and method for generating and manipulating data in an electronic bidding system. The challenge is to provide a computer-implemented method of constructing and solving optimization models for e-sourcing without the need for custom software development.

### SUMMARY OF EMBODIMENTS

Systems, apparatuses, and methods for managing advanced projects such as optimization-based e-sourcing and resource allocation are contemplated. A number of components and methods allow a user to specify complex content in a tender or project.

In one embodiment, a system is contemplated that comprises a rules component. The rules component is configured to receive a specification including a reference to an item and a reference to an object. The rules component is further configured to create an artificial bid associated with the item and derive an attribute value of the artificial bid based at least in part on the object. In various embodiments, the object may be a bid, an item, a bidder, or a fact row.

Also contemplated are methods and mechanisms for constructing and solving optimization models for e-sourcing. In various embodiments, a component is configured to receive a user-defined specification of a calculation of a first attribute value associated with a first bid, where the specification includes a formula that references a second attribute value associated with a different second bid. The component may further receive a user-defined specification of a rule including a reference to the first attribute value, where the rule describes a desired property of an allocation. A solver component formulates an optimization problem in which the allocation is directed by said rule and solves the optimization problem. The result may then be output or otherwise provided for further use.

Still further, embodiments are contemplated in which a component is configured to receive a user-defined formula specifying how a value of a first field is calculated based on values of a second field associated with a set of two or more bids. Also received may be a user-defined specification of feedback including a reference to the value of the first field. In response to receiving a bid, calculation of feedback is initiated, based on the received specification of feedback. Such feedback may then be output to a user and the process repeated until a termination condition is met.

These and other features and advantages will become apparent to those of ordinary skill in the art in view of the following detailed descriptions of the approaches presented herein.

### BRIEF DESCRIPTION OF THE DRAWINGS

The following detailed description makes reference to the accompanying drawings, which are now briefly described.

FIG. 1 illustrates a prior art approach for a supply chain project.

FIG. 2A illustrates an embodiment of a customizable system for supporting advanced e-sourcing projects, including supply chain.

FIG. 2B illustrates prior art: E-sourcing process for simple tenders.

FIG. 2C illustrates approaches in prior art for managing complex projects.

FIG. 2D illustrates the principles of an improved technology for sourcing.

FIG. 3 illustrates a method to evaluate formulas.

FIG. 4 illustrates a method to evaluate formulas.

FIG. 5 illustrates relations between formulas.

FIG. 6A illustrates one embodiment of a formula tuning tool.

FIG. 6B illustrates method of object modification.

FIG. 7A illustrates one embodiment of a solver.

FIG. 7B illustrates post-processing.

FIG. 8 illustrates one embodiment of a report definition.

FIG. 9 illustrates a supply chain.

FIG. 10 illustrates one embodiment of sub-bid creation.

FIG. 11 illustrates one embodiment of sub-bid creation.

FIG. 12 illustrates one embodiment of method for optimization formulation.

FIG. 13 illustrates one embodiment of report generation.

FIG. 14A illustrates one embodiment of a form template.

FIG. 14B illustrates one embodiment of document mark-up.

FIG. 14C illustrates one embodiment of document mark-up.

FIG. 14D illustrates one embodiment of document mark-up.

FIG. 14E is a sequence diagram of one embodiment of access restriction.

FIG. 15 illustrates one embodiment of stored data structures.

FIG. 16 illustrates one embodiment of a computing network for use in an e-sourcing system.

FIG. 17 illustrates one embodiment of data in a database.

FIG. 18 is a sequence diagram of one embodiment of processing of user input.

FIG. 19 illustrates one embodiment of a processing engine.

FIG. 20 illustrates one embodiment of transaction data corresponding to user input and database results.

FIG. 21 illustrates one embodiment of a method for processing user input.

FIG. 22A illustrates one embodiment of a method for managing feedback.

FIG. 22B illustrates one embodiment of a method providing asynchronous feedback.

FIG. 22C illustrates one embodiment of a method providing asynchronous feedback.

FIG. 23 illustrates one embodiment of a rules editor and the generation of a rule.

FIG. 24 illustrates one embodiment of a rule for artificial bid creation.

FIG. 25 illustrates one embodiment of a rule for artificial bid creation.

FIG. 26 illustrates one embodiment of data transformation.

FIG. 27 illustrates one embodiment in which sub-bids are stored separately.

FIG. 28 illustrates one embodiment of a balance rule specification.

FIG. 29 illustrates one embodiment of a balance rule specification.

FIG. 30 illustrates a balance rule where time is taken into account.

FIG. 31 illustrates one embodiment of a balance rule with several quantifying expressions.

FIG. 32 illustrates one embodiment of the creation of a bid form from template and the receiving of bids.

FIG. 33 illustrates one embodiment of bid form management.

FIG. 34 illustrates one embodiment of a form generator.

FIG. 35 illustrates one embodiment of a form interpreter.

FIG. 36 illustrates one embodiment of generating and storing sub-bids.

FIG. 37 illustrates one embodiment of rule based data cleaning.

FIG. 38 illustrates one embodiment of a data cleaning process.

FIG. 39 illustrates one embodiment of data cleaning rule generation.

FIG. 40 illustrates one embodiment of data enrichment.

FIG. 41 illustrates one embodiment of cube creation and visualization.

FIG. 42 illustrates one embodiment of an interactive aggregated table and chart view.

While the embodiments described herein are susceptible to various modifications and alternative forms, specific embodiments thereof are shown by way of example in the drawings and will herein be described in detail. It should be understood, however, that the drawings and detailed description thereto are not intended to limit the embodiments to the particular forms disclosed, but on the contrary, the intention is to cover all modifications, equivalents and alternatives falling within the spirit and scope of the present embodiments as defined by the appended claims. The headings used herein are for organizational purposes only and are not meant to be used to limit the scope of the description. As used throughout this application, the words “may” and “can” are used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component.

### DETAILED DESCRIPTION

When a software application is developed for a specific need, it is normally a rather straightforward task to capture a client's needs and transfer them into programming code. Following such a method, the resulting software product will be tailored to a specific type of solution. For example, the application may contain a fixed set of data tables with pre-defined columns and pre-defined code for how to combine them. However, in some application areas such as e-sourcing, the above approach may create obstacles.

Although e-sourcing has existed for many years, a large share of today's sourcing and negotiations are handled manually. One reason for this is that e-sourcing systems are not flexible enough to handle complex data models. Instead, applications for more complex sourcing projects typically need to be tailored by a team of skilled developers writing program code (e.g., such as SQL, Java, Javascript, Python, etc.). Alternatively, they are handled with a combination of e-sourcing and manual work using spreadsheets.

Methods and systems described herein are applied to the particular technology of e-sourcing and resource allocation, including, but not limited to, buying, logistics and transport technology, large scale resource allocation, industrial planning etc.

The embodiments described herein provide systems and methods that can handle complex e-sourcing, resource allocation, and optimization without the need for tailored programming by software developers. Instead, there is sufficiently high level expressive power to allow necessary functionality to appear in the form of defined objects such as templates, forms, fields, tables, functions, formulas, rules, and reports.

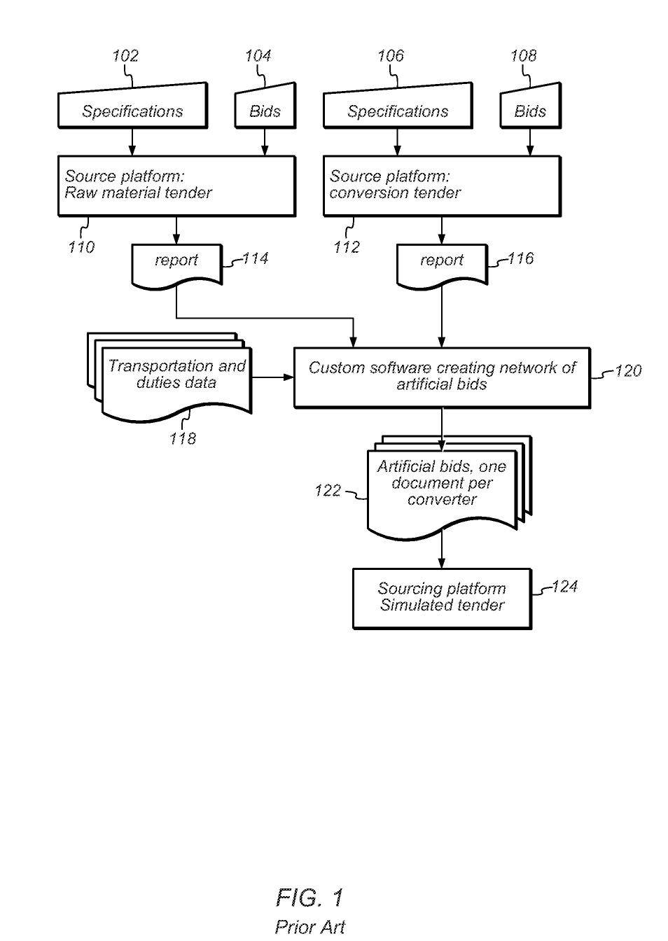

FIG. 1 illustrates a prior art method custom developed software for a supply chain project with multi-level production. As can be seen, separate instances (110, 112) are required that perform separate tenders for raw material and conversion. Each tender separately receives specifications (102, 106) and bids (104, 108). From each tender reports (114, 116) are generated. These reports are then provided to custom tailored software 120 that combines the reports into new, artificial bids 122. Each of these simulated bids is based on a combination of two bids, one from each of the two separate tenders, and the simulated bids also contains transportation and duties costs 118. Finally, a simulated tender 124 is created, taking the simulated bids as input.

When the artificial bids 122 are created in FIG. 1, a significant amount of data is copied from the original bids to these simulated bids. If there are hundreds of thousands, or even millions, of such bids generated, the computational efficiency will be low. There is also a lot of custom programming involved to split or combine the original bids into such simulated bids.

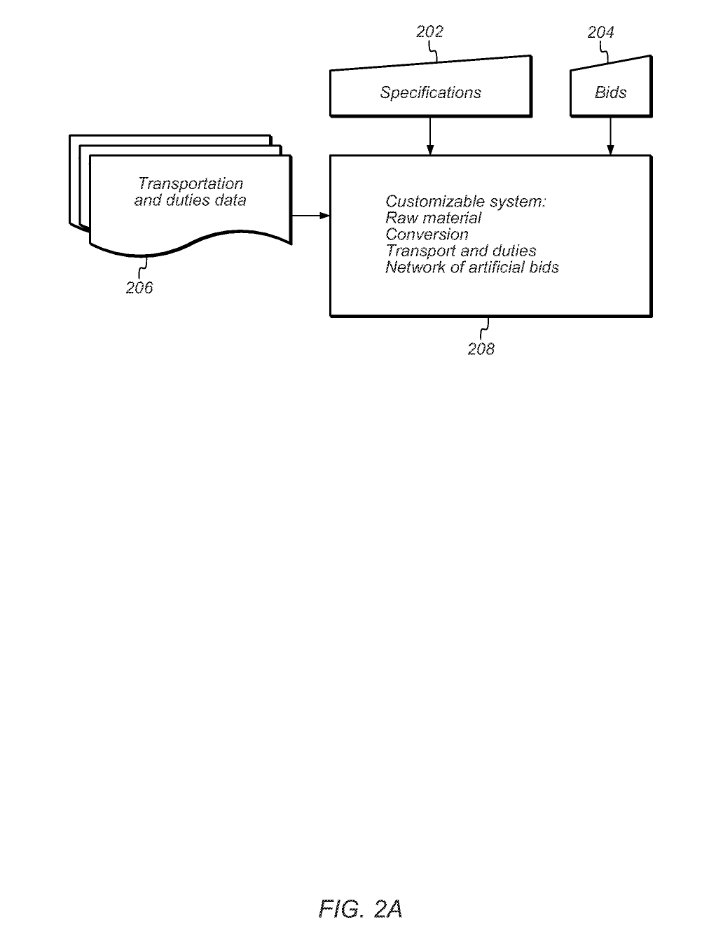

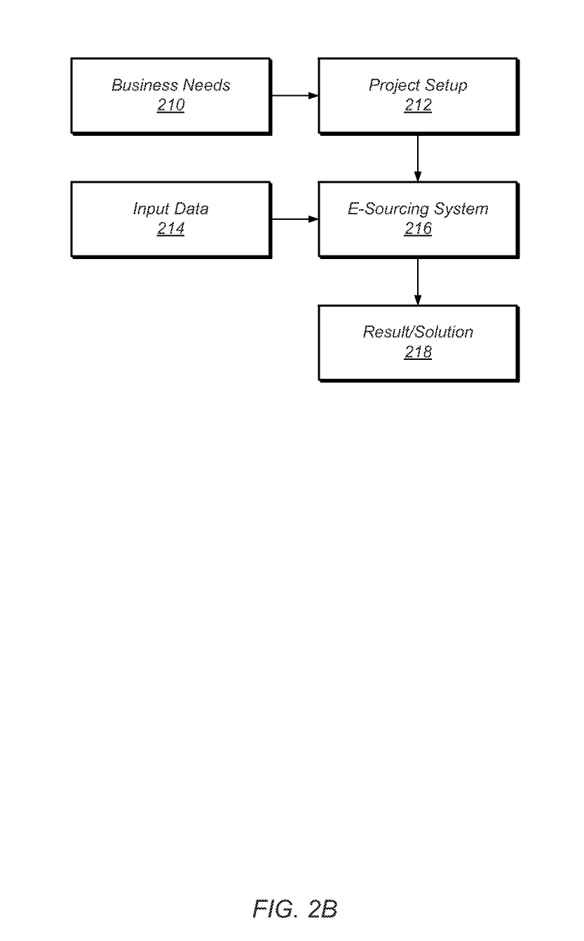

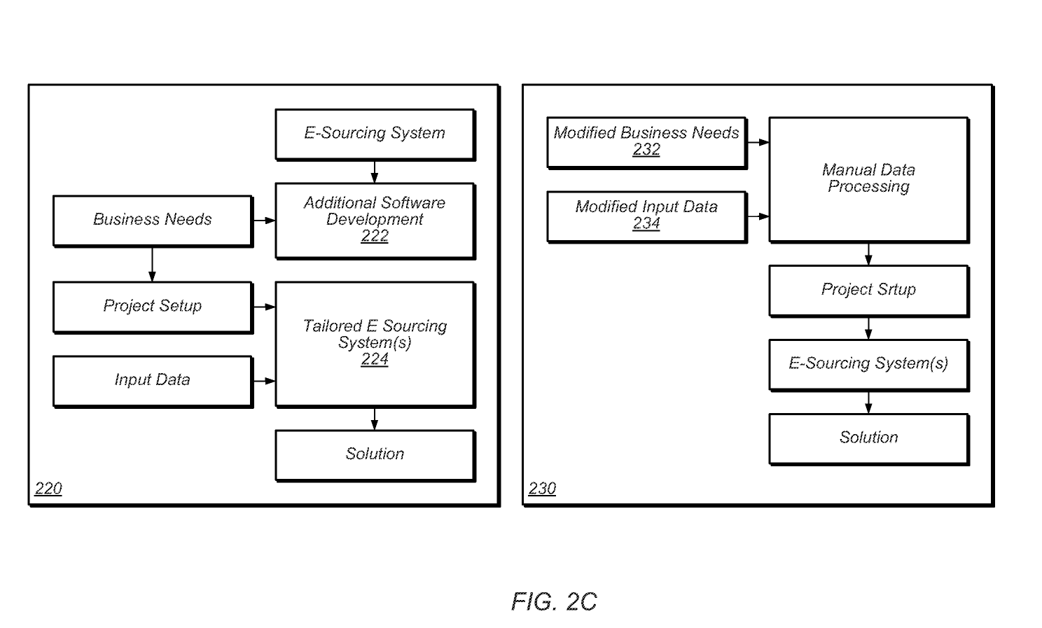

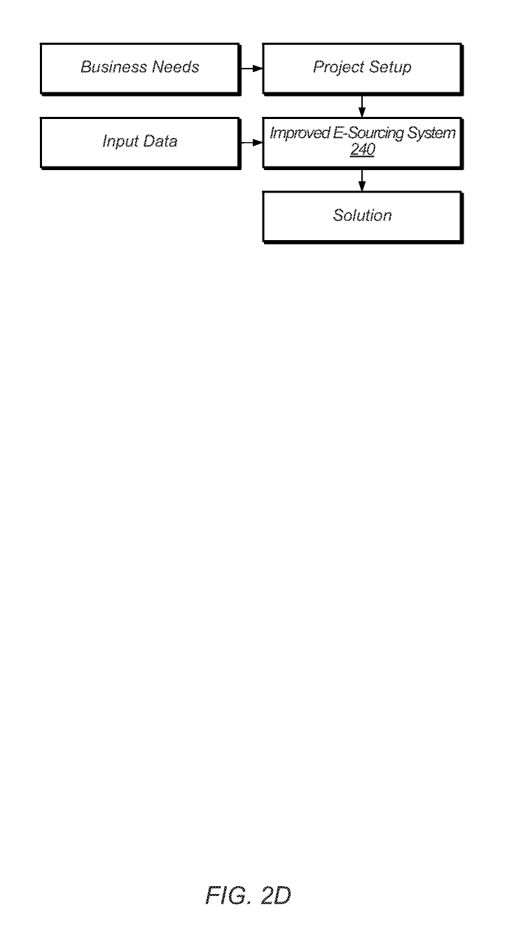

In contrast to the approach of FIG. 1 above, FIG. 2A illustrates one embodiment of a single customizable system. In the approach of FIG. 2, a single customizable system 208 is provided that services a number of tender needs. For example, based on specifications 202, bids 204, and/or transportation and duties data 206, the system 208 supports management of raw materials, conversion, transport and duties, and networks of artificial bids in a single project/tender. Further details concerning this embodiment and others are provided below.

FIGS. 2B-2D provides another illustration on how embodiments improve on prior art. In FIG. 2B, a traditional e-sourcing method is illustrated. In this case, the business needs 210 of the buying organization are reflected in a project setup 212. Such a setup typically contains schedules, bidding rules, etc. The project setup together with input data 214 (items, bids, etc.) are managed by the e-sourcing system 216, which produces some result/solution 218. While this is often the principal method, there are many cases when it cannot be applied due to limitations in current e-sourcing systems. In such cases, an e-sourcing system is combined with costly and time-consuming manual work. Two such prior art cases are illustrated in FIG. 2C. The left side 220 of FIG. 2C shows a method where an existing e-sourcing system is modified by one or more programmers in the form of additional software development 222 in order to implement a specific desired process. The resulting custom tailored e-sourcing system 224 will handle a single specific tender, or a number of similar tenders that conform to the custom programming, but is a time-consuming and expensive approach. The right side 230 of FIG. 2C illustrates another approach where the limitation in an existing e-sourcing system is overcome by modifying the input data 234 and re-defining the (interpretation of the) business needs 232 in order to fit the system. Finally, FIG. 2D illustrates a contemplated embodiment for managing advanced tenders. Here, the system 240 itself allows the user to define an advanced tender as content in an e-sourcing system. In this way, there is no need for re-programming and manual modifications. The technical details on how this is achieved will be evident in the following.

In order to balance volume in the different parts of the supply chain, rules describing relations between the allocations are required. In systems such as the one illustrated in FIG. 1, such rules have to either be created as part of the process of generating the data (simulated bids) or be hard-coded in the simulated tender.

In the following discussion, various features and components of a customizable e-sourcing system are described. Generally speaking, the features and components are referred to in the context of software. However, those skilled in the art will understand that the features and components may comprise hardware, software, or any suitable combination of the two. The particular descriptions are not intended to be limiting, but are rather intended to be exemplary. Various alternatives are possible and are contemplated. Various terms used in the discussion are provided below with a brief, non-limiting, description. Further, although various embodiments are presented as e-sourcing systems, the embodiments described herein may be used in many other applications. Embodiments may also be contained in or associated with products such as mobile apps etc.

In descriptions of embodiments, input and output of data is mentioned. The input or output method mentioned, such as “upload”, should not be seen as limiting, and any type of communication method, manual, electronic, or other, is considered.

There can also be various methods for handling security of accounts and of individual commands, such as specific hardware tools for identification, password protection, mobile apps, etc.

Object Classes:

In various embodiments, the customizable system described herein comprises software that contains representations of a number of object classes. Selected examples of such object classes are lots, lot types, bidders, bids, fact objects, formulas, rules, documents, and allocations. In various embodiments, the object classes can be hierarchical, so that for example lots can be grouped into lot types, fact tables can be arranged in hierarchies etc.

Project:

Examples of projects include a “tender”, “event”, “auction”, “exchange”, “resource planning project”, or otherwise. In various embodiments, there may be references between projects and projects may be organized into groups and/or hierarchies. Some projects may serve as master projects for others, for example providing data and definitions to other projects. An e-sourcing system can also have data and content that is independent of any particular project.

Manager:

In various embodiments, the term “manager” refers to a person, account, or organization who is creating, running, or is otherwise part of the managing, controlling, or monitoring of a project. The “manager” role can also have hierarchies, such as system administrator, market administrator, buyer, bid taker, project manager, etc. Various managers may or may not have access to all features.

Bidder:

In various embodiments, a bidder refers to a person, account, or organization responding to requests (e.g., from a manager or otherwise). The request may be a request for information, request for quote, request for price, questionnaires, surveys, etc.

User:

In various embodiments the term “user” can represent different types of users, including managers and bidders.

Field:

In various embodiments, a field represents a property of an object. A field can be associated with one or more object classes such as lots (lot field), bid (bid field), bidder and lot (lot supplement), bidder (RFI question), fact table (fact field/column), etc. In various embodiments, depending on how a field is associated, it may be edited by different roles. For example, a lot field may be edited by a buyer/manager, whereas a bid field may be edited by a bidder. If a field is defined for an object class, the scope of the field may be a subset of that class. In some embodiments, the scope for one field may be controlled by another field (e.g., field X only applies on objects where field Y is 1).

Field Definition:

In various embodiments, a field definition can be pre-defined or created by a user and the definition defines the details of a field, such as field name, field formula name, data type, formatting, formula expression, default values, visibility, access restriction, etc.

Field Types:

In various embodiments, a field can be of different types. Examples of such types include numeric, Boolean, text, multiple choice, numeric formula, text formula, Boolean formula, multiple choice formula, file, reference link, or otherwise.

Field Modes and Values:

In various embodiments a field can have different visibility modes, it may for example be hidden for all or a selected set of bidders. A field can have default values that may be defined by reference to other fields. A field can have pre-defined or user-defined properties such as max and min limits, number of decimals, length restrictions. A multiple choice field can have a blank option. In a multiple choice field, individual choices may be applicable on individual lots, this may be controlled by references to other fields. Each choice can be associated with a numerical value (that can be referred to in formulas, expressions, reports, rules, etc.). For multiple choice fields, the options and corresponding values can be created automatically from values in fact sheet columns. A multiple choice field can allow selection of one or more options.

Field values can be used to group objects. For example, a Bid Field can be declared to distinguish Offerings, meaning that two bids on the same item from the same bidder can be standing bids (i.e. not regarded as old outdated bids) as long as they have different values in the distinguishing field. A Bid field can also be used to declare Bid Types, a Bid Type is defined by pre-defined values of Distinguish Offering fields. If, for example, there is a Bid Field “Color” set to Distinguish Offerings, a bidder can submit bids for Color “Blue” and “Red” on the same item. If the same field is part of defining a Bid Type, there can be a named Bid Type “Blue” where “Color” is pre-defined as “Blue”. There can be another Bid Type “Free” where the bidder can choose any color, including Blue. Similar constructions can be made for other types of fields.

Fact Objects:

In various embodiments, a fact object is a generic type of object.

Fact Tables:

In various embodiments, a fact table is a collection of fact objects. A fact table may be associated with a particular project, or a group of projects, a system deployment, or some other level. In various embodiments, a fact table may be dynamically created by a user without any need for database programming etc. The dynamic user-defined creation of fact tables allows for representation of data of different types. For example, there can be fact tables for data such as exchange rates, historic transactions, paid invoices, plant locations, taxation, custom fees, delivery times, supplier scores, raw material needs, forecast volumes, etc. the ability for a user to create his own tables, and to create different tables in different tenders run on the same sourcing platform, will enable custom configuration of tenders without a need for a database expert or programmer to be involved. One embodiment comprising a database representation that allows user-defined fact tables is presented below in association with Table OBJ1 below.

TABLE OBJ 1
Objects from two different fact sheets.

| Object type | Object id |
|---|---|
| Fact table “ManualAlloc” | 1001 |
| Fact table “ManualAlloc” | 1002 |
| Fact table “TRANS” | 1003 |

One example of a fact table with five objects and four fields is shown in table TRANS 1 below. As illustrated below, the State field does not necessarily apply to all objects.

TABLE TRANS 1

| Country | State | City | #Transactions |
|---|---|---|---|
| USA | Texas | Austin | 10235 |
| USA | Texas | Houston | 9894 |
| Sweden | | Stockholm | 452 |
| Sweden | | Arboga | 56 |
| Sweden | | Karlstad | 781 |

Fact Table Cleaning and Verification Tools:

A fact table can have tools for data cleaning and condition checking (e.g., checking for errors, or other conditions). One type of check is to check for the uniqueness of rows based on one or more selected columns (e.g., one, multiple, or all). As an example, in the table TRANS 2 below the fields Country, State and City are used to distinguish between rows, and a duplicate USA-Texas-Houston is detected. In the example below, the duplicates are indicated by underlying the entries. However, other embodiments may utilize any of a variety of visual and/or audible indications such as highlighting, bold text, voice assistant description of duplicates, or any other desired indication. Alternatively, a separate table may be dynamically generated that includes a list of the duplicates. Such indications may be programmable/configurable by a user/manager. There can be mechanisms for managing detected duplicates, such as removing duplicates, aggregating duplicates, etc.

TABLE TRANS 2

| Country* | State* | City* | #Transactions |
|---|---|---|---|
| USA | Texas | Austin | 10235 |
| USA | Texas | Houston | 9894 |
| Sweden | | Stockholm | 452 |
| Sweden | | Arboga | 56 |
| Sweden | | Karlstad | 781 |
| USA | Texas | Houston | 9531 |

Another type of condition check is based on formulas that may be predefined, or may be defined by a user. For example, the below formula provides both an assertion and otherwise clause. If the assertion clause resolves to false, the otherwise clause is performed. If the assertion clause resolves to true, the otherwise clause is not performed. In this particular example, the formula says that unless the country is Sweden or a state is defined, a message is provided indicating the state is missing.

assert (country==“Sweden” OR notEmpty(state)) otherwise (“State is missing for”+city+“:”+country)

Lots:

In various embodiments, a lot may represent a product, service, or group of products. Additionally, there may be different established terms (such as route, line item, item, article, etc.) in different application areas for what is referred to as a lot. Sets of lots can be pre-defined or defined by a user (e.g., a manager).

A lot field, bid field or lot supplement field can be associated with one or more lot types, or with all lot types. A field can also be associated with lots on an individual basis or group basis. A fact field can be associated with one or more fact tables. A fact field can also be associated with fact rows/fact objects on individual levels. A field can also be associated with one or more object classes, such as bidders and lots, bidders and fact tables, several fact tables etc.

Values:

Given objects and field definitions, there can be stored values. A value may be associated with an object, or a set of objects, and a field.

A set of objects and values, such as objects/rows in a fact table or lots and lot fields, can be created by an automated wizard (e.g., online, etc.), or by providing (submitting, uploading, sending, etc.) a document. The document may be a specially prepared form, or it may be a free form document that is interpreted when received.

Functions:

In various embodiments, the system supports a syntax for defining functions with or without parameters. For example, in various embodiments the system is configured to support the use of functions as such, in particular in formula fields in a sourcing system. The syntax may vary in different embodiments.

Formulas:

In various embodiments, a formula may be used to calculate values and can refer to other values. Formulas and Functions can refer to or contain each other and they can be recursive. In various embodiments, a formula may return values of different types, such as numeric, Boolean, text, multiple-choice, file reference, field reference, object reference, a list of multiple objects, or another formula.

A formula can contain local functions, numerical, string, and logical operations, aggregation and lookup. A formula may also relate to different object classes. For example, a formula in a bid field can refer to values in a fact table, and the formula can aggregate values over all or a selected subset of rows in one or more fact tables, over all or selected subsets of other bids, or combinations of these. A formula in a fact field can aggregate bid values, etc.

Formula Field:

In a formula field, the calculated value can be stored as the field value, or it can be calculated when asked for. The system can have a formula parser that parses a user-defined or pre-defined formula and is used by a formula evaluator.

Below is an example of a formula field that calculates an area. The field refers to fields “isSpecialContainer” (Boolean), “containerLength” (number), and “defaultArea” (number). The formula field includes a function “area” and a logical expression using the function:

```
Function
area(length, width): return length * width
End Function
Formula
if (isSpecialContainer) then
    return area (containerLength, 9.3)
else
    return defaultArea
End Formula
```

Formula Referencing:

A field can have a specific formula name (predefined or user/manager defined) that can be used in formulas. A formula can also refer directly to a field via its name, or via a name-expression that returns a field name or formula name. The name-expression can be calculated when the formula is calculated. The name reference can also be context-dependent or otherwise dependent on the present scope. For example, the field “Waste” can have one meaning in the context of lot type “Paper” and another meaning in the context of lot type “Print”. Various mechanisms such as polymorphism or otherwise may be used to support such features.

Cost Formula:

In various embodiments, there may be a specific formula that defines the cost of a bid or an item, the “Cost Formula”. This formula may be different for different groups of lots, and there can be rules that alter or replace the formula, so different costs may be used in different scenarios. For example, the context within which the Cost Formula is used may determine which of a plurality of formulas is used. The context can be set explicitly by a rule such as “Use bid field Y as the cost for all bids by bidder X in country Z”. As another example, the cost formula can be context dependent similar to the example of “Waste” above. The cost formula can denote the cost for the entire volume, or a unit cost/price.

Aggregation:

An aggregation is an operation that combines values from a number of objects. The aggregation may comprise a particular aggregation method, an expression to be aggregated, and a selection criterion telling over what set of objects to aggregate. Aggregation can result in a single value or a collection of different aggregated values, aggregated simultaneously.

Aggregation Method:

The aggregation method can be any numeric, text or general data function, such as max, min, sum, average, median, concatenate, variance, standard deviation, etc.

Aggregation Expressions:

The aggregation expression can be a formula or function.

Aggregation Selection:

The aggregation selection can be based on any logical filtering and matching of fields and object properties. The selection can also be restricted dynamically in the aggregation, such as only aggregating once per unique combination of values.

Lookup:

A lookup is an operation to find an entity such as a value. The lookup can comprise a lookup method (such as all values, max value, min value, any matching value, and verified unique value), an expression to be found, and a look-up selection. Lookup functions can optionally be defined to return a default value if no value(s) match the lookup criteria. Lookup functions can be defined to return the nth result in a set of unique combination of values matching the lookup criteria. This can for example be used to automatically populate a fact table with data gathered/combined from one or several other fact tables.

Examples of Aggregation and Lookup:

the table below, TRANSLOG 1, is a simplified sample transaction log as it may be available (e.g., output from an enterprise resource planning (ERP) system).

TABLE TRANSLOG 1

| | | | Price per | Arrival |
|---|---|---|---|---|
| Lot | Bidder | Volume | Unit | Date |
| Gothenburg | Ygge | 2 | $100 | 08/01 |
| Gothenburg | Ygge | 1 | $120 | 08/02 |
| Stockholm | Holmberg | 3 | $23 | 08/02 |
| Gothenburg | Ygge | 1 | $120 | 08/03 |
| Stockholm | Andersson | 3 | $23 | 08/03 |

Using data from TRANSLOG 1, we give some examples of aggregation and look-up formulas and results:

| Formula | Result |
|---|---|
| aggregate(sum, Volume, | 4 |
| Lot = “Gothenburg”) | [the volumes of the rows having |
| | the field Lot equal to |
| | Gothenburg(2, 1, and 1) have |
| | been summed] |
| aggregate(sum, [Volume, | [4, 440] |
| Volume × Price per Unit], Lot = | [total volume, and sum of |
| “Gothenburg”) | volumes × price per unit = |
| | 200 + 120 + 120] |
| lookup(any, Bidder, | Holmberg or Andersson |
| Lot = “Stockholm”) | [find Bidders rows having the field |
| | Lot equal to Stockholm] |
| lookup(all, Bidder, | {Holmberg; Andersson} |
| Lot = “Stockholm”) | |
| aggregate(sum, Volume, | Gothenburg: 4 |
| Lot = ThisLot) | Stockholm: 6 |
| | [A lot formula that gives the sum |
| | of the Volume for the same value |
| | of Lot as the current one] |

As previously noted, prior art sourcing systems are custom designed to provide particular functions. While such systems may provide many useful functions, it may be the case that a user of the system would like to have different functions available, an dto create functions as needed. For example, a buyer may want a cost break down between manufacturing and handling for multiple products. In the prior art, the buyer may configure the system to receive bids that have (for example) two fields (manufacturing and handling) and then specify that the total price is the sum. However, when there are many products, this approach can be burdensome. For example, if there are 1000 products divided into 50 groups, and handling costs are the same for products in a given product group, requiring a handling costs for every bid is cumbersome. In some prior art systems it is possible to fill bid values in hierarchies. For this example, handling cost could be filled in once per product group and then auto-filled as default at the product level. However, this approach has many shortcomings. For example, if a bidder wants to update a handling cost, he cannot do that without submitting bids for all affected products. As another example, since there will be no explicit bids on handling, feedback on handling can only be provided at product level.

Tables 4 and 5 below provide an example of an embodiment involving separate bids for manufacturing and handling.

TABLE 4
Bids for manufacturing

| Product Group | Product | Manufacturing cost |
|---|---|---|
| (Buyer defined) | (Buyer defined) | (Bidder input) |
| Text | Text | Numeric (monetary) |
| A | P001 | $100 |
| A | P002 | $110 |
| B | P003 | $103 |

Where the first field is defined as the “productGroup” field, the second field is defined as the “product” field, and the third field is defined as the “price” field.

TABLE 5
Bids for handling

| Product Group | Handling cost |
|---|---|
| (Buyer defined) | (Bidder input) |
| Text | Numeric (monetary) |
| A | $8.75 |
| B | $7.23 |

Where the first field is defined as the “productGroup” field, the second field is defined as the “price” field.

In order to combine these bids into one bid for evaluation, we create a new table by adding a new field to the manufacturing bid table that contains the following formula:

price+bidaggregate(aggregate.single, price, bidder==this(bidder) && productGroup==this(productGroup) && bidType=“Handling”)

The above formula can be interpreted as: Sum the price of the bid with a value aggregated (found) from other bids. The value to be read resides in field price. For the value read, it must hold that the bidder of the selected bid matches the bidder of this bid, that the productGroup of the selected bid matches the productGroup of this bid, and that the bidType of the selected bid must be “Handling”.

In various embodiment, there may be short forms for the above, such as:

price+find(price, match(bidder) AND match(productGroup) AND bidType=“Handling”)

TABLE 6
Bids for manufacturing, including dynamically created
field for the total manufacturing plus handling cost

| | | | Total cost for |
|---|---|---|---|
| | | | manufacturing and |
| Product Group | Product | Manufacturing cost | handling |
| A | P001 | $100 | $100 + $8.75 = $108.75 |
| A | P002 | $110 | $110 + $8.75 = $118.75 |
| B | P003 | $103 | $103 + $7.23 = $110.23 |

As seen from the above, the third table including a total cost for manufacturing and handling can be dynamically created through the use of the user defined formulas that can be created as described herein.

As another example, a formula to calculate, for each bid B, the distance in percent from B's price to the lowest price from all bids where the value of field “country” is equal to B's value of “country”, may be as follows:

(this(price)−aggregate(aggregate.min, price, country==this(country)))/this(price)*100

As another example, a formula to calculate, for each bid B from each supplier S, the distance in percent from B's price to the average price for all bids from S where the value of field “country” is equal B's value of “country”:

(this(price)−aggregate(aggregate.average, price, bidder==this(bidder) && country==this(country)))/this(price)*100

This can then be varied in many ways, exemplified by computing a distance to lowest transit time:

(this(transitTime)−aggregate(aggregate.min, transitTime, bidder==this(bidder) && country==this(country)))/this(transitTime)*100

In the above example the evaluation of bid fields was exemplified, but the functions above (such as min, max and find) may be defined to read other types of fields. For example, they can also be used for computing item fields or fields describing more general data.

Aggregation and lookup to, for example, combine data from more than one bid can also in some cases be an efficient alternative to the creation of simulated bids in prior-art systems, cf. FIG. 1.

Optimized Formula Evaluations:

When values are changed or added, there may be a need to re-evaluate formulas. This re-evaluation can be performed in such a way that it minimizes computation (or various “calculation”) time while guaranteeing consistency. This can contain a structural analysis of dependencies between objects, formulas, and values. There can also be an option to temporarily deviate from complete consistency if desired.

Formula Tuning/Optimization:

There can also be a tool for analyzing execution times for different formulas, and for giving hints and help on how to optimize formulas.

Formula Evaluation:

The re-evaluation of formulas can be triggered manually or by events, such as a user defined event, or an event that can change the calculation results. This triggering and/or calculation can also be temporarily (or permanently) halted.

Relationship Tools:

There can be a tool for viewing dependencies between any types of objects, such as fields, formulas, object classes, rules, report, etc. There can be one or more features detecting cyclic definitions. Detection of relations and/or cyclic definitions can be used to issue error and warning messages. For example, a user trying to remove an object (field/rule etc.) that is used by some other object can get an error message.

Example of Formula Evaluation, Formula Tuning, and Relationship Tools:

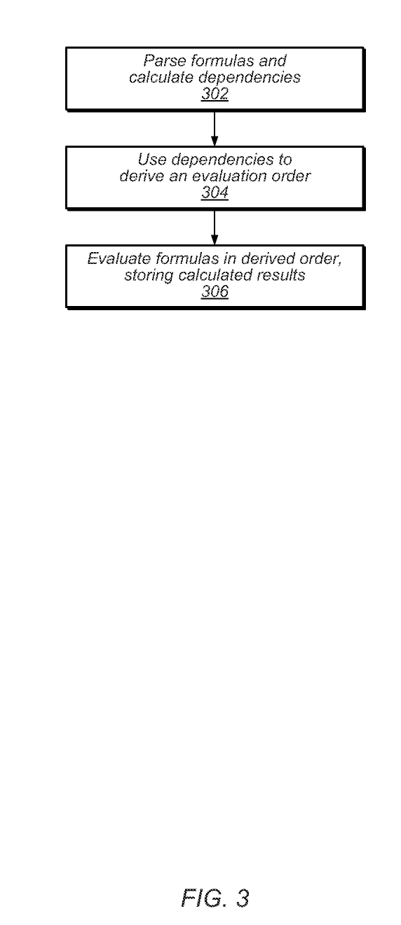

FIG. 3 illustrates one embodiment of a method to evaluate formulas that ensures the evaluation is consistent. The method works by analyzing the relationships between formulas. As shown in the embodiment of FIG. 3, a formula is parsed 302 to calculate dependencies. The calculated dependencies are then used to derive an order in which to evaluate the elements of the formula 304. Finally, the formula is evaluated based on the derived order and calculated results are stored 306.

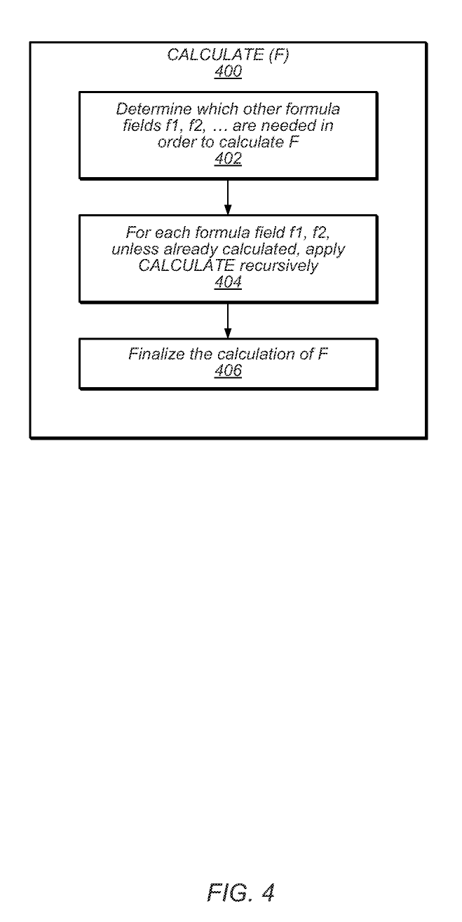

An alternative embodiment of an evaluation method 400 is illustrated in FIG. 4. In this example, a recursive method is used and formula values are evaluated as they are needed. This can be done in a dynamic programming style, so that once a formula is calculated, the calculated values can be re-used. As shown, a determination is first made as to which formula fields are needed in order to calculate the formula F 402. For each formula field (f1, f2, etc.) identified, unless it has already been calculated perform the calculation recursively 404. Finally, complete the calculation of F 406.

Formula evaluation can be made in many different ways, the use of such methods are possible and contemplated. Furthermore, when evaluating formulas, different embodiments can use different methods for loading necessary data from a database. For example, which data needed can be identified before the evaluation. In another embodiment, the data needed is loaded in a just-in-time manner at evaluation time, in this way avoiding loading of some data that is actually not needed. For example, if a formula has an if-then-else construction, and the else-part turns out to never be active, the data needed only in this part can be omitted.

In a similar way the evaluation of a formula may in some embodiments be performed only when the value is requested.

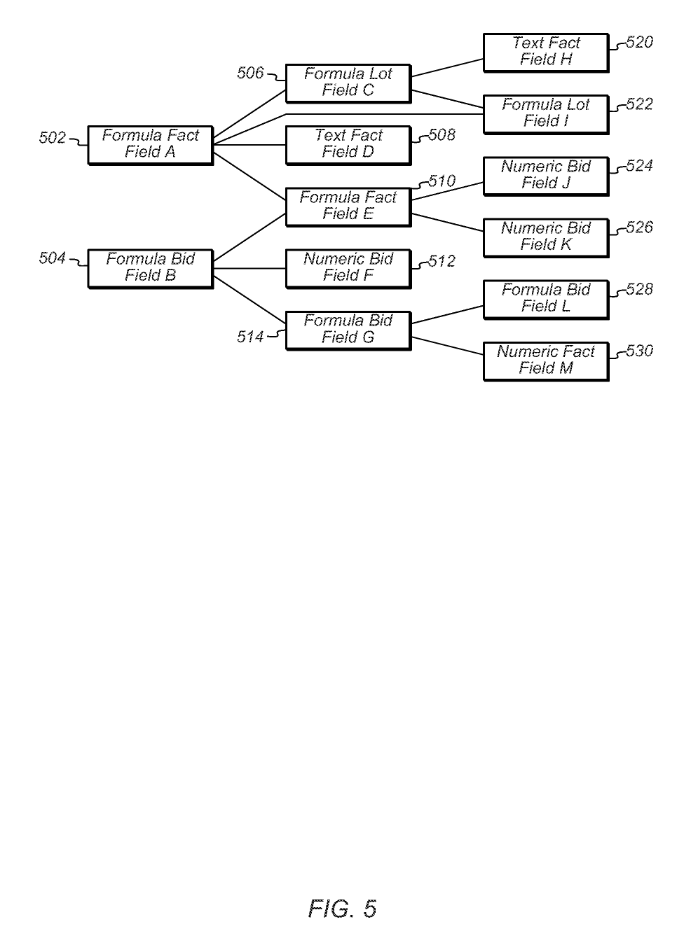

In various embodiments, an analysis of relations between formulas can also be displayed (e.g., to a user, manager, etc.) as shown in FIG. 5. In this figure, dependencies are shown so that those elements with more dependencies are shown to the left. For example, Field A 502 is shown to be dependent on Fields C 506, D 508, E 510, and I 522. Field C 506 is shown to depend on fields H 520 and I 522. Field E depends on Fields J 524 and K 526. Field B depends on Fields E 510, F 512, and G 514. Finally, Field G 514 depends on Fields L 528 and M 530. How dependencies are shown may also be configurable. For example, only a subset of dependencies may be shown, such as only to a certain depth, only for a single formula, and so on.

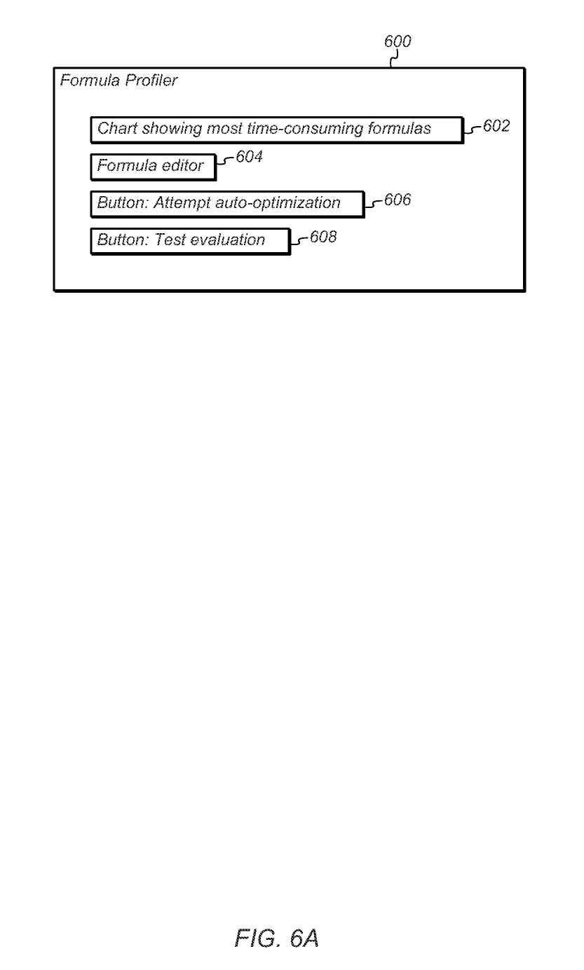

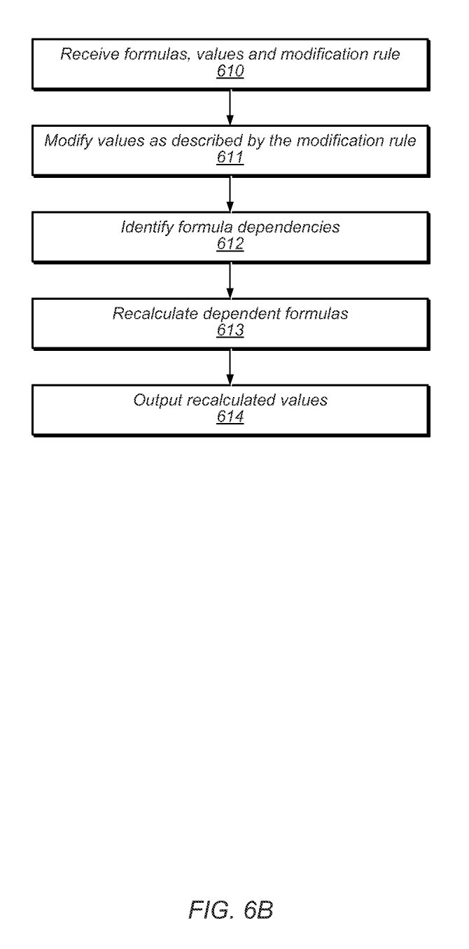

In addition to the above, a formula tuning tool may be used. FIG. 6 illustrates one embodiment of such a tool 600. In the embodiment shown, the tool is referred to as a Formula Profiler and includes various components (e.g., software and/or hardware based components). For example, the tool may be configured to provide a chart showing how much time is consumed by various formulas (602), either in terms of real time, computation time, or otherwise. In some embodiments, the user may select a particular set for viewing—such as those formulas that consume the most time (either presently or historically). The information about which formulas are most time-consuming can be based on statistics collected as the formulas are being evaluated, or on some structural analysis. The tool 600 may comprise a formula editor (604) that is usable to create and/or edit formulas. Further, in various embodiments the tool 600 may include an option that enables it to attempt to automatically optimize (606) a formula based on various criteria. For example, max and/or min optimizations for systems of equations (e.g., linear equations) may be attempted. Such attempts may utilize trial and error approaches, may be configured to make such attempts for a given amount of time, or a given number of times, to within a given margin of error, and so on. Finally, the tool 600 may be configured to perform test evaluations (608) of formulas being considered and provide feedback to a user.

Implicit Definition:

In various embodiments, there can be a way to connect or associate data via references. For example, if a fact table contains the columns “Lot” and “Volume” this sheet may be interpreted as defining the content of an implicitly declared lot field “Volume”. For example, Table TRANSLOG 1 above may directly imply that the Lot Field “Volume” is 4 for lot “Gothenburg”. Alternatively, if a fact sheet contains the columns “currency” and “exchange rate”, and there is a bid field “currency”, the “exchange rate” may be handled as an implicitly defined bid field. An implicit definition is not necessarily dependent on matching field names.

Example of Implicit Definition:

Assume we have used a report based on table TRANSLOG 1 above to create table TRANSLOG 2 shown below. As shown in the example, common lot bidder combinations have been identified and entries created for each. Each of the entries further provides a total volume (sum of the corresponding volumes) and price average.

TABLE TRANSLOG 2

| Lot | Bidders | Volume (Sum) | Price Average |
|---|---|---|---|
| Gothenburg | Ygge | 4 | $110 |
| Stockholm | Andersson, Holmberg | 6 | $23 |

If we wish to use the data in table TRANSLOG 2 above to define information about historic data, we can use a definition as in table HISTDEF below. With these definitions in place, we can refer indirectly to the values in TRANSLOG 2 by referring to implicitly defined lot fields “Historic volume” and “Incumbent suppliers”. For example, using table HISTDEF, we may refer to the “historic volume” of the “Gothenburg” lot. Indirect reference to TRANSLOG 2 then provides the volume sum, or “4” as the corresponding value. In this manner, new definitions may be created that implicitly refer to data in other table. Such definitions may be used in formulas, queries, or otherwise to provide desired information.

TABLE HISTDEF

| Lot field | Defining Table | Lot name match | Values |
|---|---|---|---|
| Historic volume | TRANSLOG 2 | Lot | Volume Sum |
| Incumbent suppliers | TRANSLOG 2 | Lot | Bidders |

Filter:

In various embodiments, one or more filters can be used to select a set of objects, such as bidders, bids, lots, fact objects, fields, rules, etc. The user/manager can configure the filter as textual expressions or via an interactive interface where fields, values, etc., can be available for selection. A filter may be configured as a part of a rule, a report, or as a separate entity. A filter may have composed and complex options, refer to any type of field and filter, and represent a hierarchy of logical expressions.

Filters can also be based on actions in the bidding process, such as whether or not a bidder has logged in, confirmed information or terms etc.

Filter Examples:

(i) All suppliers that occur in the fact sheet “Approved Suppliers” or are incumbent on at least one lane in France.
(ii) Bids with equipment type A by any bidder having at least one bid passing filter X.
(iii) Facts where the value of field X is greater than any value of bid formula Y.
(iv) Bidders that have logged in but not placed any bids.

Scenarios:

In various embodiments, a scenario comprises a set of rules. Different parts of rules can be reused between scenarios in different embodiments, ranging from having the rule defined once and available in all scenarios, to completely independent definitions of rules between scenarios.

Configurable Terminology:

The various terms, such as “lot”, “bidder”, “bid”, “cost”, “savings”, etc., are not necessarily fixed. In various embodiments, there may be support for re-naming and using different terms.

Incumbency:

Incumbency (i.e., current suppliers) can be defined at different levels in the system, and can be based on predefined or user-defined fields and properties of objects. Using this method, a supplier can for example be defined as incumbent on a lot if it is the historic supplier on this specific lot, or is the historic supplier on some lot having the same value for a specific field or property (country=“France” etc.). Different incumbency definitions can be used in different rules and scenarios.

Examples of Incumbency:

Assume we have the transaction log of TRANSLOG 3 below (e.g., as it may be output from an ERP system).

TABLE TRANSLOG 3

| | | | | Price per | Arrival |
|---|---|---|---|---|---|
| City | Material | Carrier | Volume | Unit | Date |
| Gothenburg | Wood | Ygge | 2 | $100 | 08/01 |
| Gothenburg | Wood | Ygge | 1 | $120 | 08/02 |
| Stockholm | Steel | Holmberg | 3 | $23 | 08/02 |
| Gothenburg | Wood | Ygge | 1 | $120 | 08/03 |
| Stockholm | Wood | Andersson | 3 | $23 | 08/03 |

Assuming that a Lot is distinguishable by City and Material we have the following incumbents by Lot,

| City | Material | Incumbent |
|---|---|---|
| Gothenburg | Wood | Ygge |
| Stockholm | Steel | Holmberg |
| Stockholm | Wood | Andersson |

the following incumbents by City,

| City | Incumbent |
|---|---|
| Gothenburg | Ygge |
| Stockholm | Holmberg; Andersson |

and the following incumbents by Material

| Material | Incumbent |
|---|---|
| Wood | Ygge; Andersson |
| Steel | Holmberg |

There can be multiple incumbents per lot, and incumbent volumes and prices can be obtained based on these notions of incumbency.

Creating Objects:

Apart from the content provided by users/managers, objects can be created automatically by the system. For example, objects may be created by combining other objects. This can be expressed via rules, formulas, functions, and/or reports, etc. Creation of Objects can also be defined in scenarios, for example as object creation rules, and the creation can be different per scenario. For example, bids or allocation variables may be created by combining data from fact sheets and lots, or combinations of bids. The resulting objects can be stored in the same way as other objects, and used in the same way. They can also be stored in a special format. For example: there can be a scenario rule specifying how to create extra bids (“sub-bids”) used to describe potential paths in a supply chain. These bids may exist only in memory, for example during solve time, or they may be stored in a database or in a data structure that does not need to support traditional database operations (e.g., a Binary Large OBject (BLOB) type structure or otherwise).

Creating Artificial Bids:

Creating artificial bids (“sub-bids”) is a special case of creating objects. A Sub-Bid Rule contains a description of how to create new bids or allocation variables by duplicating, splitting, or combining objects (e.g., bids or other objects), or to create by combinations of duplicating, splitting and combining. The description may refer to objects from which to copy values or reference data. This can be controlled by filtering or listings of references in predefined or manager defined fields. The copying can be from any types of objects, such as bids, lots, or fact tables. Formula fields can be applied to sub-bids and evaluated at or after creation. Such sub-bid creation can be applied in different ways in different scenarios.

An artificial bid may contain a reference to one or more other bids, in various embodiments referred to as parent bids. Formulas in a sub-bid may use field values from parent bids. For example, a bid may contain three different prices—price1, price2, and price3—representing three different volume bands. The bid may then be split into three bids, one for each volume band. The three bids respectively having values 1, 2, and 3 assigned to the field volumeBand. As a simple illustrating example, the sub-bids may then contain a formula for price:

switch(volumeBand)

case 1: price1

case 2: price2

case 3: price 3

In the example above, the creation of sub-bids is used in combination with the ability to evaluate user-defined formulas, referencing values in the newly created bids as well as values in the original bids. Creation of sub-bids can take other rules into account. In various embodiments, a user can refer to other rules when specifying the creation of sub-bids. For each such rule, the sub-bid creating component can analyze which bids are affected by the rule and let this analysis guide which sub-bids to create and/or which data to copy into the sub-bids. In the paper example above, a user may for example refer to a rule defining a relation between paper and printing and specify that sub-bids for delivery of a certain paper should only be created for delivery locations at which the paper can be needed.

Object Modification:

In various embodiments, there can be rules that modify the contents of an object, such as a lot, a bidder, a bid, or a fact row, and these modifications may be different in different scenarios.

### Example

A rule can alter values that affect the cost formulas, in this way causing a re-evaluation of these formulas and changing the costs in a scenario.

A method of object modification is exemplified in FIG. 6B. Formulas, values and modification rule are received, 610. The values can be representing different fields associated with various objects, such as a value for a numeric field “Transit time” of a specific bid. The values may have been entered by a bidder or buyer, or be derived by the system using formulas and other calculations. Then values are modified by the modification rule, 611. An example of a modification rule can be “increase fuel charges by 5%”. Next, formula dependencies are identified, 612, to establish which formulas need a recalculation as consequence of the modification in 611. Then the required formulas identified in 612 are calculated, 613, and the recalculated values are output, 614. Various variants and possible and contemplated. For example, identification of dependencies, 612, can be interlinked with formula calculation, 613. This can be to avoid calculating values that are not actually needed, cf. FIG. 4.

Removing Objects:

Object can be removed in different ways. In various embodiments objects can be removed permanently. There can also be support for other types of removal. For example, there may be support to undo different types of remove operations. If undo of the removal of a lot is to be supported, then it may be required that bids placed on that lot can be restored. The same object can also have different degrees of removal for different purposes. For example, a bidder can be considered removed in the sense that it is removed from the set of bidders receiving message(s) from a tender and being able to access the tender, but its bid may still be considered as part of analysis.

Allocation Rules:

Rules can be predefined or defined by a user (e.g., the manager). A rule may contain, but is not limited to, one or more of the following:

(i) A quantifying expression. This can be an arbitrary expression, such as number of winners or allocation times a field, etc.
(ii) A limit. The limit can be an expression of the form “at most 5” or “at least 27”. The limit can also be multiplied with fields or properties to achieve expressions such as “at most 80% of declared capacity”.
(iii) A split. A rule can be split, or duplicated, using fields and properties. This can be used to, for example, apply a rule to every bidder, or every value of a field. Splitting can be done on multiple properties, such as “per bidder, country and month”.
(iv) Definitions of how to cope with empty limits or selections of objects.
(v) Definitions of if and how to permit violation of the rule. Violation can be allowed at different penalties, and/or if certain conditions are met (for example, certain bids are unallocated).
(vi) A filter and/or selection of objects. Sets the scope of the rule.

Other types of rules are possible and contemplated. For example, there can be rule hierarchies where one rule combines a number of rules and sets priorities between them. A combining rule can also set limits on the total deviation of the limits of the included rules, the number of included rules that are allowed to be violated etc. There can also be a rule creation language where a user can define expressions over variables, the variables referring to individual bids, field values, bidders etc.

The same rule may be used in one or more scenarios with different degrees of modification. The system can support a range of options from minimal rule revision, such as setting a limit in a predefined rule, to allow combining the above using all types of fields, properties and objects.

Furthermore, even within a rule, a quantifying expression and split can vary between different sets of objects, such as lot types. This can be used to construct a rule defining balances in nodes of a supply chain. In various embodiments, a balance point (or node) represents a location or property that is related to, or otherwise affected by, more than one bid or input in the system. For example, assume we wish to match incoming sea freight and outgoing land freight at ports, identified by port names. In bids for the type “sea freight”, the port name may be contained in a field called “Location Harbour”. In bids for the type “land freight”, the origination point may be contained in a field called “Origin Point”. If we use “Location Harbour” as a “splitter” for sea freight and “Origin Point” for land freight, then port names may be the balance points. In this sense, a splitter refers to a point at which we desire to manage incoming and outgoing resources. As such, resources arriving at a given port may be compared to resources departing the port. Based on this rule, it is ensured that the port is being properly and efficiently utilized. For example, if resources arriving at a given port are less than the resources departing the same port, the rule is violated. Such violations are not allowed unless the rule has a soft limit, the violation is allowed as part of a hierarchical rule construction, etc.

As another example: “For every matching value of field ‘Delivery Town’ of Lot Type ‘Paper Delivery’ and field ‘Printing City’ of Lot Type ‘Print’, the allocated quantity of field ‘Paper Delivery in Tonnes’ of Lot Type ‘Paper Delivery’ minus the allocated quantity of field ‘Paper Requirement in Tonnes’ of Lot Type ‘Print’ must be larger than or equal to zero”. This type of balancing can be combined with other rule features, such as management of rule violations. Balances can also be of different types. For example, there can be a rule stating that supply must be at least demand, that supply must be equal to demand, or that any allocation in demand must trigger supply allocation. The latter can, for example, be used for allocating qualification resources: as soon as there is any allocation for a certain unqualified machine, the proper qualification resource must be allocated.

We will now describe an embodiment of an e-sourcing system supporting user-defined supply chains, production planning, and similar. Such a system can be a computer-implemented method of conducting e-sourcing comprising:

(a) receiving user-defined balance definitions specifying how to link allocation of different bids;
(b) building an optimization model representing said balance definitions as one or more constraints;
(c) generating an allocation based on said optimization model; and
(d) outputting said allocation.

In more detail, an embodiment of such an e-sourcing system can comprise:

a) receiving data via a computing device, said data comprising a first user-defined balance definition applied to a first set of bids and a second user-defined balance definition applied to a second set of bids, wherein each of said first and second user-defined balance definition comprises (i) a specification of a quantifying expression, and (ii) a specification of a split;
b) building an optimization model based on said data, said optimization model representing said first and second user-defined balance definition as one or more constraints enforcing that an allocation of a bid in said first set of bids implies at least one of

(i) an allocation of a bid in said second set of bids, and

(ii) a penalty applied to the objective function of said optimization model;

c) generating an allocation based on said optimization model; and
d) outputting said allocation to a machine readable media.

Below, embodiments of the steps above will be described in more detail.

In step a), the user-defined balance definition can be provided by the user in a number of ways, one such way is via a rule editor. The rule editor can be tailored for balance rules. The rule editor can allow the user to specify one or more quantifying expression(s) based on pre-defined or user-defined attributes, such as item attributes or bid attributes. The rule editor can also allow the user to define one or more split(s) based on pre-defined or user-defined attributes. The rule editor can also allow the user to define one or more selection(s) of bids.

In other embodiments, data containing the user-defined definitions can be provided by other means, such as via an uploaded document, or electronically from an outside system.

The first set of bids can represent demand in a supply chain and said second set of bids can represent supply in said supply chain. Furthermore, in one embodiment said first split can divide said first set of bids into sub-sets of which a first sub-set of bids and the split values for said first sub-set is matching the split values of a second sub-set of bids obtained by applying said second split to said second set of bids.

In one embodiment, the split values for all bids of said first sub-set and said second sub-set are the same. In another embodiment, the relation between split values can be more elaborate. For example, a field used as split can contain dates, and there can be a requirement that in order for a matching demand-supply allocation to be valid, the allocated supply bid must have an order value less than or equal to the ordering value of the demand bid. In another case, the fields can be text fields, and there can be a requirement that the split value for one bid is contained in the corresponding split value of another bid.

Furthermore, in one embodiment the user-defined specification can contain at least one additional quantifying expression and split applied to said first set of bids or (ii) at least one additional quantifying expression and split applied to said set second set of bids.

In another embodiment, said first quantifying expression and said second quantifying expressions are vectors.

In Step b), an optimization model is built. This can be done automatically by a constraint builder that interprets the user-specified balance rule(s) (and other rules) and translates them into a mathematical formulation or executable code. Depending on the user-specified rule, the optimization model can be built so that said allocation of a bid in said first set of bids can be associated with a first item, and said allocation of a bid in said second set of bids can be associated with a different second item. Furthermore, an allocation in said second set of bids can affect the allocation in said first set of bids as a function of said first and second quantifying expressions and splits. Furthermore, said first quantifying expression can be evaluated to a coefficient per bid of said first sub-set of bids and said second quantifying expression can be evaluated to a coefficient per bid of said second sub-set of bids; and said allocation calculation is subject to a constraint with terms based on each bid's coefficient and allocation.

In one embodiment, a constraint used to model a balance rule can be one of less than, less than or equal to, greater than, greater than or equal to, and equal to. In other embodiments, other types of constraints can be used.

In Step c), the optimization model is used to calculate an allocation. In one embodiment this is done by Mixed Integer Programming, or by some other Mathematical Programming approach. Examples of software products configured to perform performing Mixed Integer Programming are CPLEX, XPRESS, and Gurobi. In other embodiments, the allocation is calculated by other means, such as an algorithm specifically tailored for the problem at hand. In a case when the problem is infeasible, there may be a mechanism to handle the infeasibility.

In Step d), allocation is output to machine readable media. Such media can, for example, include a computer's memory, an SQL database or some other type of database or external storage device.

This type of balancing can be combined with other rule features, such as management of rule violations.

Solver:

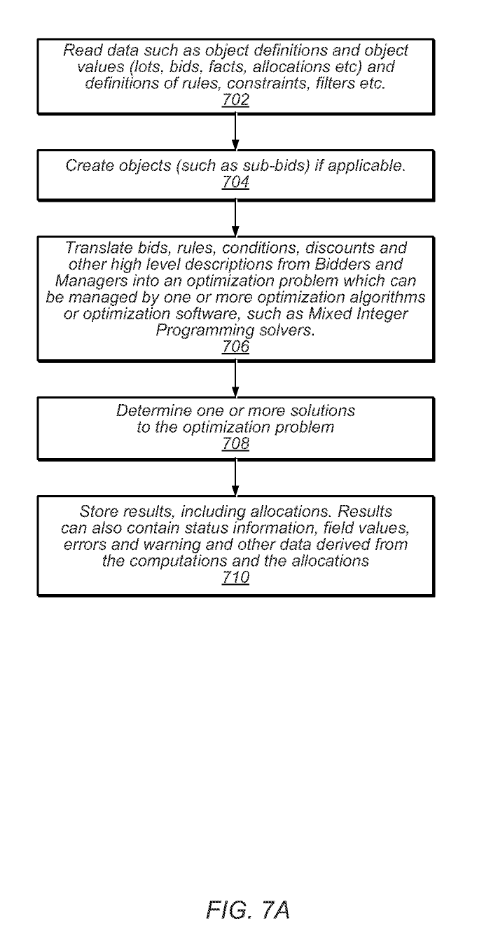

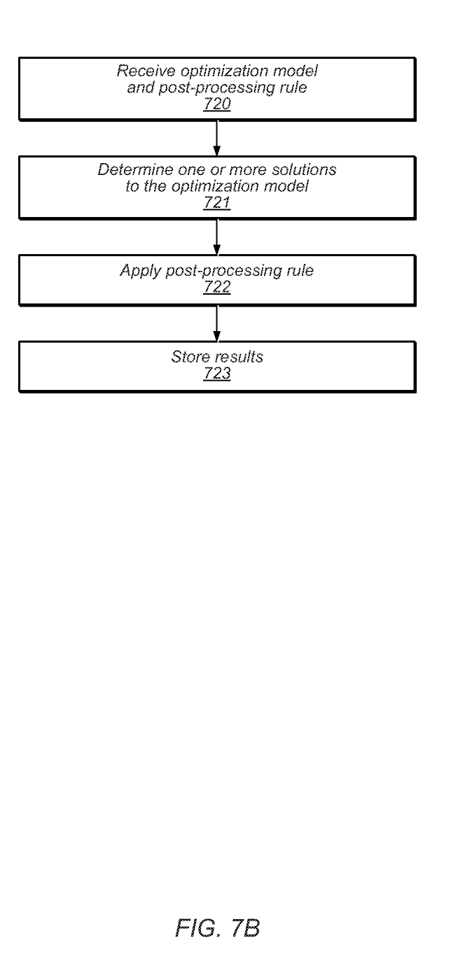

In various embodiments, the system comprises a solver which may be used to solve scenarios and perform optimizations to produce data output and reports. One embodiment of a method corresponding to a solver is illustrated in FIG. 7A. Data such as object definitions and object values (lots, bids, facts, allocations etc.) and definitions of rules, constraints, filters etc., is read 702. If applicable, objects (e.g., sub-bids) may be created 704. Using the information, the solver may then translate bids, rules, conditions, discounts and other high level descriptions from Bidders and Managers into an optimization problem which can be managed by one or more optimization algorithms or optimization software 706. For example, a mixed integer programming (i.e., a linear program in which one or more variables can be constrained to be integers) solver may be utilized. Subsequently, one or more solutions to the optimization problem may be determined 708. Finally, the results may be stored, including allocations 710. The stored information may also include status information, field values, errors and warnings and other data derived from, or associated with, the computations and the allocations. In various embodiments, a solver may also include other features, such as managing infeasibility, reporting and storing partial results, and analyzing the effect (in terms of cost, objective function, number of winners, infeasibility, solution time, etc) of applying specific rules.

Allocation:

Allocations can be computed by the solver based on scenarios. Allocations can also be created by other means, such as manual decisions. An allocation typically denotes a quantity associated with a specific bid and a specific scenario, but may be defined at different levels, such as quantity per bidder.

Scenario Reference:

Scenarios can be referred to in rules. Example: A rule can state: “Penalize all bids winning in Scenario X or Y by 0.5%”, or “Keep at least 70% of the allocations in France from Scenario X”.

We will now describe an embodiment of an e-sourcing system supporting user-defined supply chains, production planning, and similar. Such a system can contain a computer-implemented method of conducting e-sourcing comprising:

a) receiving a specification of a rule, said rule referring to a first allocation;

b) constructing an optimization model based on said rule and said first allocation;

c) calculating a second allocation based on said optimization model; and

d) outputting at least part of said second allocation.

In more detail, an embodiment of such method can comprise:
a) Receiving a specification of a rule. This specification can be one or more forms of restrictions and modifications for directing the allocation of bids. Said rule referring to a first allocation. This allocation can be the result of solving a scenario.
b) Constructing an optimization model based on the rule that refers to first allocation. The model can be in a form suitable for a solver, such as a linear programming solver, a mixed-integer programming solver, or a non-linear programming solver.
c) Using one or more solvers to calculate a second allocation based on the optimization problem.
d) Outputting at least part of the second allocation. The allocation can be communicated to another part of the e-sourcing system or be stored directly in a computer readable media.

Step a). The rule in the first scenario contains a reference to the allocation. In one embodiment such a reference refers to an allocation via a scenario that the allocation is associated with. There are many ways to refer to an allocation and the specific approach described should not be seen as limiting.

This rule can be of many different types, such as, but not limited to:

(i) keeping the first allocation in the second allocation,
(ii) limiting the second allocation to being at most/at least/higher than/lower than the allocation in the first scenario,
(iii) favoring or penalizing bids based on the allocation in the first scenario, and
(iv) rejecting bids based on the allocation in the first scenario.

The rule can be limited to a certain scope, for example only keep the first allocation in a certain country.

The first allocation may also be accessed as a field. Then standard means can be used for specifying rules.

Such rules can be of many different forms, such as, but not limited to:
(i) Keep allocations for all bids the same as in Scenario [ . . . ].
(ii) Keep allocations for all allocated bids the same as in Scenario [ . . . ].
(iii) Keep allocations at most the same as in Scenario [ . . . ].
(iv) Keep allocations at least the same as in Scenario [ . . . ].
(v) Favor bids allocated in at least one of Scenarios [ . . . ].
(vi) Penalize bids allocated in at least one of Scenarios [ . . . ].
(vii) Favor bidders allocated in at least one of Scenarios [ . . . ].
(viii) Penalize bidders allocated in at least one of Scenarios [ . . . ].
(ix) Keep only bidders allocated in at least one of Scenarios [ . . . ].
(x) Keep only bidders not allocated in any of Scenarios [ . . . ].
(xi) Keep only bidders among the N most allocated in at least one of Scenarios [ . . . ].
(xii) Keep only bidders among the N most allocated in at least one of Scenarios [ . . . ]. (xiii) Allocation is measured in [selected unit].
(xiii) Keep only bidders among the N most allocated (USD) in at least one of Scenarios [ . . . ].
(xiv) Keep only bidders among the N most allocated historic value (USD) in at least one of Scenarios [ . . . ].
(xv) Keep only bidders allocated at least X in at least one of Scenarios [ . . . ].
(xvi) Keep only bidders allocated at least X in at least one of Scenarios [ . . . ]. Allocation is measured in [selected unit].
(xvii) Keep only bidders allocated payment at least X USD in at least one of Scenarios [ . . . ].
(xviii) Keep only bidders allocated historic value at least X USD in at least one of Scenarios [ . . . ].

Formulations to favor and/or penalize can be expressed as a percentage or as a monetary amount, or otherwise, and can be multiplied by different fields.

The scope of the reference may or may not be the same as the scope it is applied to. For example, scoping examples include “Favor the bids in Texas by 26% for all bidders allocated anything in Texas in Scenario X”, and “Favor the bids in Oklahoma by 26% for all bidders allocated anything in Texas in Scenario X”.

The rules can be repeated over for example different fields, for example: “For every ‘Country’ and ‘Product Group’ keep only bidders allocated at least 10 tons in Scenario [ ]”.

In Step b), an optimization model is built. This can be done automatically by a constraint builder that interprets the user-specified balance rule(s) (and other rules) and translates them into a mathematical formulation or executable code. Depending on the user-specified rule, the optimization model can be built so that said allocation of a bid in the first set of bids can be associated with a first item, and the allocation of a bid in the second set of bids can be associated with a different second item. Furthermore, an allocation in the second set of bids can affect the allocation in the first set of bids as a function of the first and second quantifying expressions and splits. Furthermore, the first quantifying expression can be evaluated to a coefficient per bid of the first sub-set of bids and the second quantifying expression can be evaluated to a coefficient per bid of the second sub-set of bids; and the allocation calculation is subject to a constraint with terms based on each bid's coefficient and allocation.

In one embodiment, a constraint used to model a scenario reference rule can be one of less than, less than or equal to, greater than, greater than or equal to, and equal to. In other embodiments, other types of constraints can be used.

In Step c), the optimization problem is used to calculate an allocation. In one embodiment this is done by Mixed Integer Programming, or by some other Mathematical Programming technology. In other embodiments, the allocation is calculated by other means, such as an algorithm specifically tailored for the problem at hand. In a case when the problem is infeasible, there may be a mechanism to handle the infeasibility.

In Step d), allocation can be output to machine readable media. Such media can for example be a computer's memory, an SQL database or some other type of database or external storage device.

Post-Processing:

There can be rules for doing various rounding, removing artifacts etc., after the solver has delivered a solution. Example: “Redistribute all allocations from each bid receiving less than 1% allocation on a lot”.

In various embodiments, post-processing can be done after the solving of an optimization problem. The post-processing can be based on solving new optimization problems or be based on less computationally complex methods, such as rounding. These can be applied to, for example, remove small allocations resulting from numerical inaccuracies when solving optimization problems. Granularity for the operations can be user defined and be based on fields, for example “Remove all allocations smaller than 1 truck per country”. There can be different policies for how to manage changes in allocations. For example, allocations removed in a post-processing rule may or may not be redistributed among other suppliers, and there may be different policies for how to distribute such volumes among the other suppliers. There can also be verification rules/formulas which do not influence the solving process, but check validity and/or the consistency of bids and/or allocations.

A solve and post-processing method is exemplified in FIG. 7B. An optimization model and one or more post-processing rules are received 720. Then, the solver determines one or more solutions 721. Next, one or more post-processing rules are applied 722. Finally, the result is stored, 723.

Reports:

The system may be configured to generate one or more pre-defined and/or user configured reports. These reports can further be created and modified using a report editor. In various embodiments, a report may contain dimensions and facts. A fact may contain a user defined field or a pre-defined application specific value type and an aggregation method. The aggregation method can be standard mathematical, statistical, textual, or logical aggregations. The aggregation method can also be more application specific.

Report Facts:

Report facts can be predefined sourcing related facts, such as “savings”, “incumbent volume”, or “number of winners”. A report fact can also be based on any predefined or user-defined field, or be a general mathematical or textual fact. A fact can also be a process fact, such as time for latest visit to project overview page, time of download/submission of documents etc. The facts to include in a report can be selected by the manager when defining the report. Report facts can be formulas, referring to other calculated facts or dimension values. For example, if a report shows savings per region for 5 scenarios, one of them being a reference scenario, there can be a formula within the report that for each region and scenario it calculates the savings difference to the reference.

Report Dimensions, Split and Join:

A user or manager can use the tool to split a report in any of a variety of ways, such as row, column, section, paragraph, page, slide, sheet, or document. Additionally, several reports may be combined. For example, two reports may be placed beside each other on the same output page/sheet. Alternatively, reports may be combined using Cartesian products, various “join” operations, appending them, placing them in the same documents, and so on. In various embodiments, a report fact or dimension can be based on any field or property.

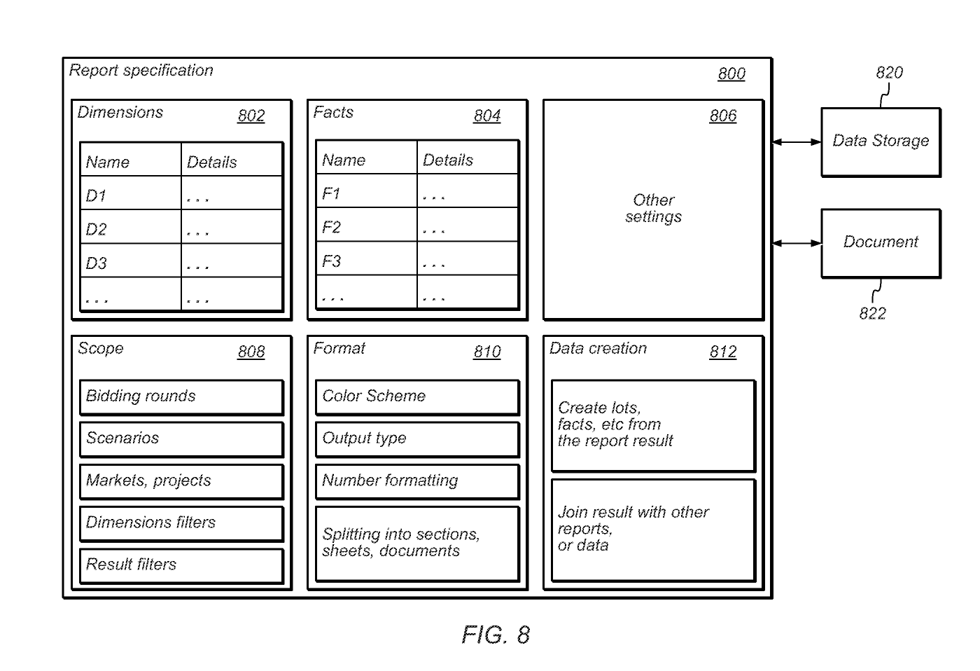

One example of a report definition or specification 800 is show in FIG. 8. This figure illustrates just a sample of selected functionalities. As shown in the example, various dimensions 802, facts 804, scope 808, format 810, data creation 812, and other settings 806 are specified. The specification 800 may be read from and stored to data storage 820. The specification may form at least a portion of a document 822 that is accessible, and may be editable, by a user or manager. For example, filtering can be done on individual dimension values (e.g., as indicated by Dimensions filters in 808) and fact values 804, and different facts can have different input filters. As an example, a fact for reporting allocated costs can have an input filter to only count incumbent allocations, and a result filter to only report costs above $1000.

Report Display Formats:

A customizable report may generate results in formats other than a table. Additionally, there can be tools for viewing reports in different ways. For example, there may be a tool that allows displaying a report as a clickable chart with interactive drill-down, or there can be visualization of information presented on a map.

An e-sourcing system can comprise a number of reports. Such a system can comprise:

a data storage configured to store data; and

a processing system, wherein the processing system is configured to:

receive a specification of a report;
read data from computer readable media;
calculate report results, and
output the report.

In e-sourcing, a report can be used to report on data stored in one or more projects containing fields. In this case, the system can be configured to

receive specifications of fields;
receive data containing values of fields;
store this data in computer readable media;
receive a specification of a report;
read data from computer readable media, calculating report results;
output the report.

Reports can be predefined or user-defined, fields can be user-defined or predefined, or combinations of these.

In an e-sourcing platform, a reporting module can be configured to handle items, bids, facts, as well as allocation and other results of solving an optimization problem. The report generator can then be configured to handle data of different types, such as items, bids, fields, facts, allocation, and to mix them in the same report, following the following steps:

(a) receiving specifications of fields;
(b) receiving data containing bids and values of fields
(c) storing this data in computer readable media;
(d) constructing an optimization model based on one or more rules;
(e) solving said optimization problem, storing a result in computer readable media;
(f) receiving a specification of a report;
(g) reading data from computer readable media, calculating report results;
(h) outputting the report.

The rule can be predefined or user-defined. The system can support executing the steps above in different order, repeating parts of the steps, omitting or adding steps.

In Step (a), the specifications can comprise a specification of a first and a second field. A field can be related to bids.

In Step (b) the system can receive, via a computing device, data from a bidder, said data comprising a bid containing a value of said first field.

In Step (c) the system can store data in computer readable media.

In Step (d) the system can construct an optimization model based on a rule referring to the first field. The optimization model can be expressed as a scenario, and it can be configured to generate an allocation.

In Step (e), the optimization problem can be solved and the result can be stored in computer readable media.

In Step (f), the specification of a report can comprise

a specification of a calculation of aggregate values over sets of bids, said calculation depending on said first field and said result;
a specification of how to split said calculation between sets of bids based on said second field, said split implying the creating of rows or columns in a report.

The report specification can refer to sourcing-specific object types, such as lots, bids, or bidders; it can also be of more general type such as fact rows. The dimensions and facts can be any field, or pre-defined. The report definition may contain a reference to an allocation, this allocation can be resulting from solving an optimization problem. The report can be created using a report editor. Dimensions and facts can also be sourcing specific attributes, such as “Historic volume”, “Savings”, “Allocation”, “Allocation %”, etc. Report facts can be formulas, referring to other calculated fact or dimension values. Such formulas can be user-defined or predefined. For example, if a report shows savings per region for 5 scenarios, one of them being a reference scenario, there can be a formula within the report that for each region and scenario calculates the savings difference to the reference.

The report may comprise one or more aggregation methods. An aggregation method can be associated with one or more facts. There can be facts where no aggregation method is selected, instead the aggregation is pre-defined. The aggregation method can be mathematical, statistical, textual, or logical aggregations. The aggregation method can also be more application specific and/or be an aggregation over an aggregation, for example “the sum of lowest value per lot” or “highest difference in any lot”. Allocation may be taken into account in the aggregation to, for example, express “lowest value of bid field for any allocated bid”, or “the allocated sum of a field”.

The report can contains fact and/or dimensions from different tables, such as Items, Bids, Allocations, Facts, and Bidders.

Facts can be divided into different sections, such as a section for Lot Facts comprising facts that only depend on Lots, Bid Facts that depend of bids, Scenario Facts that depend on scenarios, and Allocation Facts that depend on allocations.

The report can comprise one or more filter specification. A filter specification can be a filter specifying which objects (items, bids, fact rows, etc.) to include in the report calculation; it can also specify what type of results to include or exclude. Excluding a result can imply that if the result to be excluded is for an object X, object X will be completely excluded from the report.

A fact can be a formula that is calculated based on dimension values or other facts. A fact or a dimension can be set as hidden; a report formula can be allowed to use hidden values.

In Step (g), the report generator reads from computer readable media values of said first and second fields and at least part of the optimization result, creating said report based on a set of bids. The report generator can divide the set of bids into subsets by their value of the second field, and a calculation is applied to each subset. This calculation can be depending on the type of object, the type of fact, and an aggregation method. The calculation can also involve objects outside of the objects for which the value is calculated. If, for example, the fact to be calculated is “Allocation % of Tendered Volume” and the lot field “country” is used as dimension, the report generator can combine information from items, bids, and allocation in a calculation like the following.

Allocation % of Tendered Volume in Country X=sum (allocation per bid in country X)/sum (tendered volume per lot in country X).

As another example, if we have dimensions “Bidder” and bid field “Equipment Type” and the fact is:

“Average price”, the calculation can be done without using allocation.

In Step (h) the report generator output a report.

There can be a graphic viewer to display a view of said report on a computing device. The graphic viewer may comprise a chart and/or a table. The graphic view can allow the user to make dynamic modifications. The user can have the option to refresh a report; a refresh can also be triggered automatically in response to a change in data or specifications.

The output of a report can be to a database table, or to a document, or an on-line view. The format of the report can be based on display format specifications being part of the report specification.

The report specification can contain instructions to split a report in several ways, such as row, column, section, paragraph, page, slide, sheet, or document. Several reports may be combined. For example, two reports may be placed beside each other on the same sheet. Or reports may be combined using Cartesian products, various “join” operations, appending them, placing them in the same documents, etc.

A customizable report can be creating results in other formats than a table, or there can be tools for viewing a report in different ways. For example, there can be a tool that allows displaying a report as a clickable chart with interactive drill-down, or there can be visualization on a map. An example of a report definition is show in FIG. 8. This figure illustrates just a sample of functionalities. For example, filtering can be done on individual dimension values and fact values, and different facts can have different input filters.

Tracing a Supply Chain or Network:

In addition, a report may contain filters and aggregation methods that define how to trace data through a supply chain or network, as defined in a scenario. Specific filters and aggregations or combinations of them can form predefined or manager defined report facts. The report generator can traverse through the balance points defined by balance rules until the appropriate paths have been analyzed for reporting. In various embodiments, a balance point is a matching set of values from a first and second balance definition in a balance rule.

To illustrate a rule about the paper and printing example discussed above, the below table, REPORT 1, can be produced as a report by a system as described herein. Taking the first row as a specific example: the table shows that “Football Poster 0012” to be delivered to “Sweden” has a tendered volume of 5,000 copies. The allocated printer was “Johnson & Sons”, and there were 3 candidate printers to choose from. Furthermore, traced through the balancing rule, the allocated paper delivery suppliers were “Prime Paper” and “West Corp”, and for this printed matter there were 2 candidate paper delivery suppliers. The costs per copy and the overall cost were also displayed. Furthermore, from the second row we see that “Ultimate Comics Periodical” cannot be allocated as the report reveals that there is no potential paper supply.

TABLE
REPORT 1

| | | Facts | | | | | | | |
|---|---|---|---|---|---|---|---|---|---|
| | | | | | | Number | | | |
| | | | | | | of | | | |
| | | | | Number | Allocated | Potential | | | |
| Dimensions | | | | of | Paper | Paper | Paper | Print | |
| Printed | Delivery | Tendered | Allocated | Potential | Delivery | Delivery | Cost per | Cost per | Total |
| Matter | Country | Volume | Printers | Printers | Suppliers | Suppliers | Copy | Copy | Cost |
| Football | Sweden | 5 000 | Johnson & | 3 | Prime | 2 | 0.2 | 0.15 | 1 750 |
| Poster | | | Sons | | Paper; | | | | |
| 0012 | | | | | West Corp | | | | |
| Ultimate | Sweden | 10 000 | | 1 | | | | | |
| Comics | | | | | | | | | |
| Periodical | | | | | | | | | |
| Football | Norway | 4 000 | Amundsen | 4 | Prime | 3 | 0.21 | 0.16 | 1480 |
| Poster | | | Print | | Paper | | | | |
| 0012 | | | | | | | | | |

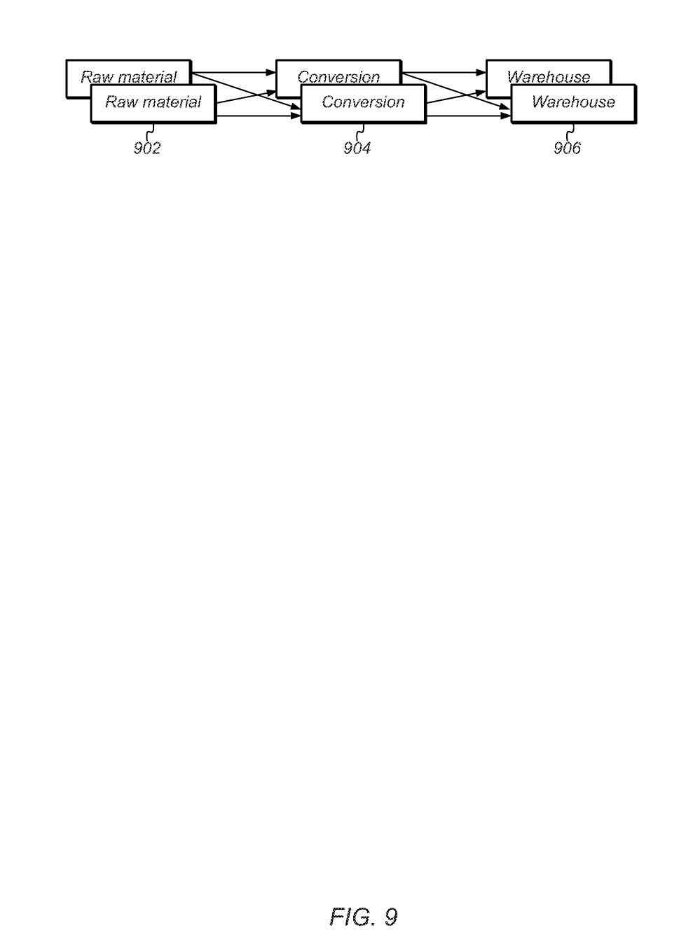

Consider a supply chain, as shown in FIG. 9, where raw material is converted into products that are to be delivered to warehouses. As shown, there may be many suppliers 902 for raw material and for conversion 904. In addition, there are also transportation costs. Associated with such a supply chain is information/data stored in a database or other location. For example, various tables may be used to store related information as shown below.

As an example, TABLE T1 below provides product specifications. This table describes which raw material(s) goes into what product, and how much per item. For example, one row in the table may be used for each applicable product/raw material combination.

TABLE T1
Product Specifications

| Product | Raw Material | Need per item (g) |
|---|---|---|
| Product A | Raw Material A | NN |
| . . . | | |

Table T2 below provides an example related to product demands. This table tells how much of each final product is to be delivered at each warehouse. In this example, one row per product and warehouse is used.

TABLE T2
Product Demands

| Warehouse country | Warehouse | Product | Volume |
|---|---|---|---|
| Country A | Warehouse Alpha | Product X | NN |
| . . . | | | |

Table T3 below provides an example of data related to conversion bids. For each supplier/conversion plant, there is a conversion cost per item. One row per conversion plant and product is illustrated.

TABLE T3
Conversion Bids

| Conversion plant | product | Price per item |
|---|---|---|
| Plant Beta | Product Y | $N |
| . . . | | |

Table T4 below provides an example of data related to raw material bids. One row per raw material supplier and product.

TABLE T4
Raw Material Bids

| Raw material supplier | Raw material | Price per ton |
|---|---|---|
| Supplier Gamma | Raw Material Z | $N |
| . . . | | |

Table T5 below provides an example, of transport costs. In this example, a cost per ton for both raw material and final products is provided. One row per potential origin-destination pair.

TABLE T5
Transport Costs

| Origin | Destination | Cost per ton |
|---|---|---|
| Location X | Location Y | $N |
| . . . | | |

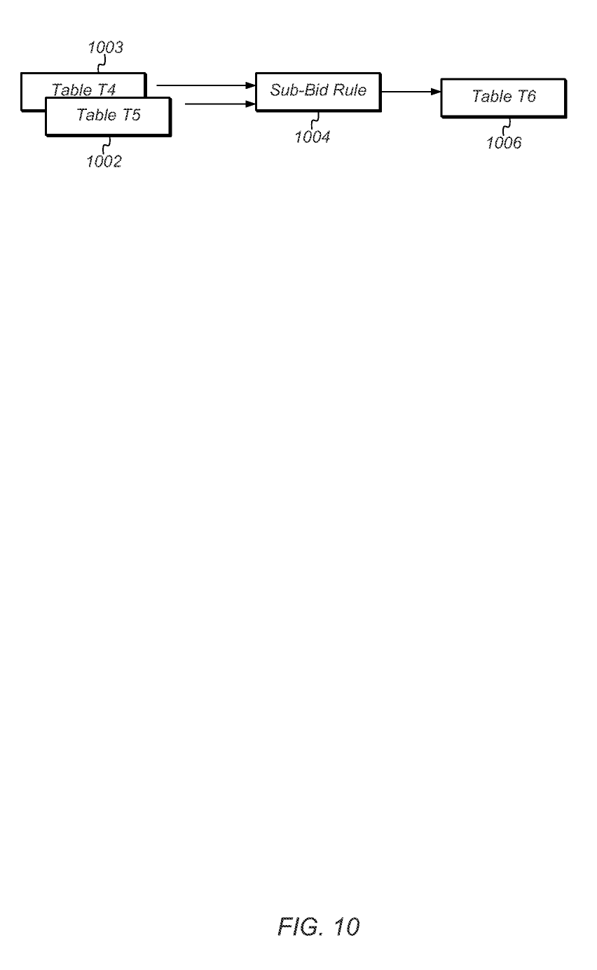

FIG. 10 illustrates, one embodiment of object creation. In the example shown, a sub-bid rule (1004) is created based on a combination of data from T4 (Material Bids; 1003) and T5 (Transport Costs; 1002). In various tenders/projects, sub-bids are created that represent a potential delivery for each applicable combination of raw material supplier and converter, including transport of raw material. The sub-bid rule is illustrated in FIG. 10 and the resulting sub-bids are shown in Table T6 below. In this example, the table shows raw material sub-bids with one row for each potential combination of raw material supplier, raw material and receiving converter.

TABLE T6
Raw Material Sub-Bids

| Raw material | | Price | | Transport |
|---|---|---|---|---|
| supplier | Raw material | per ton | To Converter | cost per ton |
| Supplier A | Material B | $N | Converter C | $N |

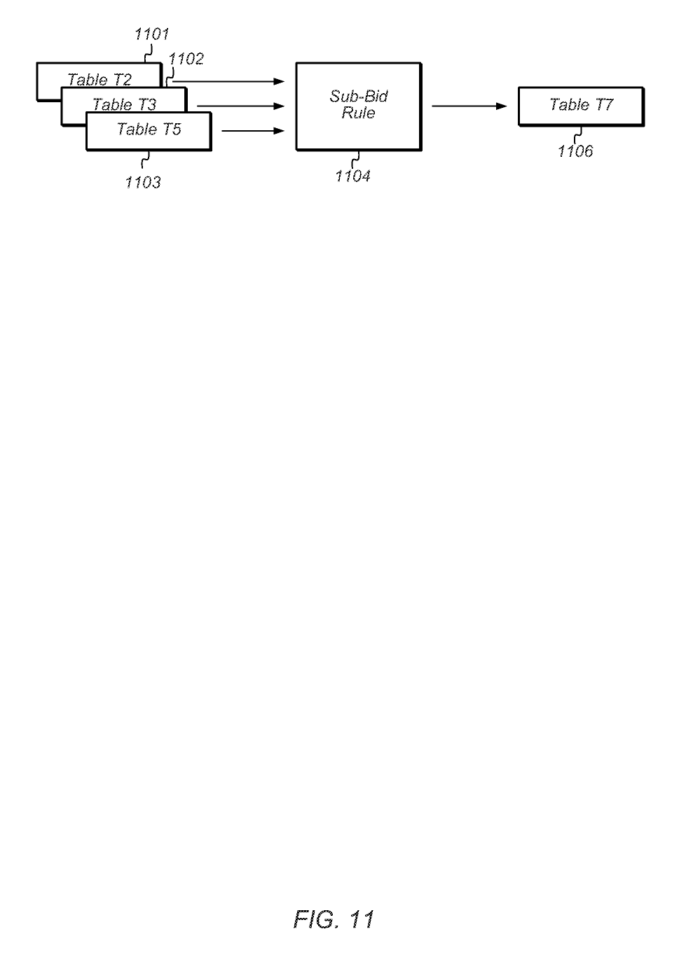

In addition to the above, by combining data from tables T2 (Product Demands), T3 (Conversion Bids) and T5 (Transport Costs) we may create sub-bids representing the potential conversions for combinations of Converter, Product, and Warehouse, including conversion cost and transport of final products. FIG. 11 illustrates one embodiment in which a sub-bid rule is used and the resulting sub-bids in TABLE T7 below. As shown in FIG. 11, combining information from tables T2 (1101), T3 (1102), and T5 (1103), and using a sub-bid rule (1104), table T7 (1106; conversion sub-bids) below may be created.

TABLE T7
Conversion Sub-Bids

| Warehouse | | | | | Conversion cost | Transport cost |
|---|---|---|---|---|---|---|
| country | Warehouse | Product | Volume | Converter | per item | per ton |
| Country F | Warehouse M | Product D | XX | Converter C | $N | $N |

Finally, to create proper balance in the supply chain, we use Tables T1 (Product Specifications), T6 (Sub-Bids) and T7 (Conversion Sub-Bids) to create a rule where the balance points are converter and product.

TABLE T8
Balance Rule

| Part | Balance Factor | Balance Point | Matching |
|---|---|---|---|
| Demand | T7.Volume × | T7.Converter | T7.Product = |
| | T1.Need per item | | T1.Product |
| Supply | Max Capacity | T6.To Converter | T6.Raw Material = |
| | | | T1.Raw Material |

Table T8 shows an example of a balance rule definition. This definition will generate a constraint for each converter location and required raw material, as defined in the Balance Point and Matching column. For each of these combinations, the constraint states that the volume of the product times the raw material needed for the product is supplied by an allocation up to the maximum capacity of the raw material supplier. There may be many variants of the design (e.g., in a user-interface) to achieve such a split. There may also be variants of how the splits are defined and read from different fields. Time can also be a parameter in a model and hereby also be a part of balance rules, requiring for example that a raw material is available at latest when production is to be started (possibly subject to storing capacity etc.).

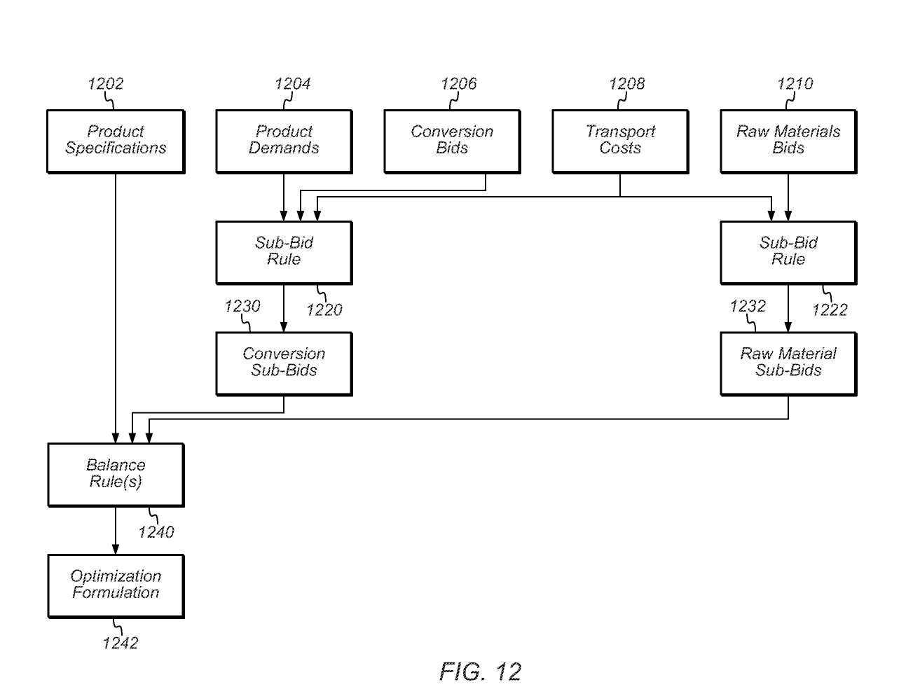

FIG. 12 illustrates one embodiment of the flow of data and processes described above. FIG. 12 depicts product specifications 1202, product demands 1204, conversion bids 1206, transport costs 1208, raw materials bids 1210, sub-bid rules 1220 and 1222, conversion sub-bids 1230, raw material sub-bids 1232, a balance rule(s) 1240, and optimization formulation 1242. In various embodiments, each of these may correspond to various components of software and/or hardware (e.g., for obtaining data, storing data, processing data, and so on). In some embodiments, various software and/or hardware components may be configured to perform multiple functions illustrated in FIG. 12. Numerous such embodiments are possible and are contemplated.

One example of a report that may be created is shown in TABLE T9. This example illustrates a custom designed report of a supply chain. In this example, Allocation results are presented for only one scenario, but the same report may contain the results of multiple scenarios.

TABLE T9
Report

| | | Facts | | | | | | | | | | |
|---|---|---|---|---|---|---|---|---|---|---|---|---|
| | | | | | | | Names | | | | | |
| | | | | | Number | | of | | | | | |
| | | | | | of | Allocated | Potential | Raw | | | | |
| | | | | Names of | different | Raw | Raw | Material | Conversion | Transport | Transport | |
| Dimensions | | Tendered | Allocated | Potential | raw | Material | Material | cost per | cost per | cost to | cost from | Total |
| Product | Converter | Volume | volume | Converters | materials | Suppliers | Suppliers | item | item | Converted | Converted | Cost |
| . . . | . . . | . . . | . . . | . . . | . . . | . . . | . . . | . . . | . . . | . . . | . . . | . . . |

Input Formats:

In a complex tender like the example above, it may be preferable to have custom designed bid forms that are different for different categories, or even for individual suppliers. For example, the system can have user-defined input formats, where bid form templates are custom designed and contain markings where input fields, and input tables, or part of input tables, are placed. In the example above, different parts of the conversion bids can, for example, be placed in two different pages (or sheets) in the bid form so that for each product, conversion costs are placed in one table and material waste in another (material waste not included in Table T3).

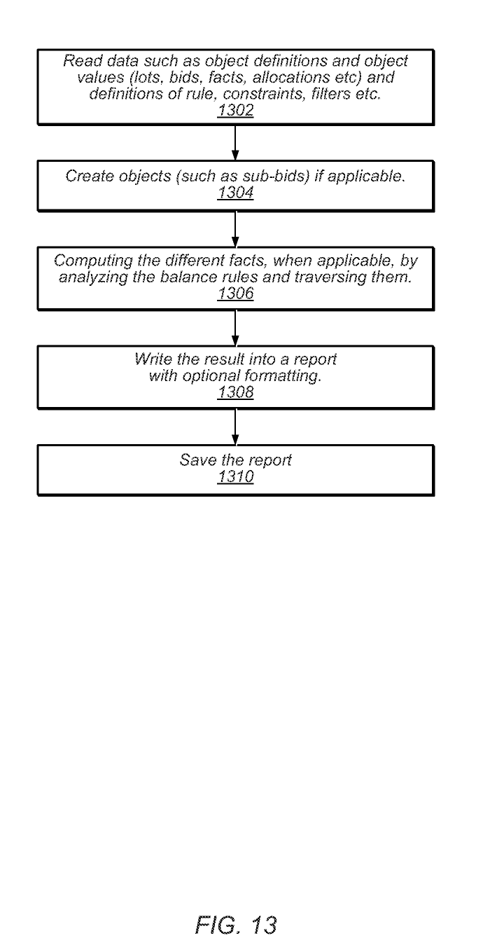

One embodiment of a process for producing a report from specifications and allocations (results) is shown in FIG. 13. In the example, data such as object definitions and values, rules, constraints, filters and so on, are read or otherwise obtained (1302). Subsequently, objects such as sub-bids may be created (1304) as part of building a representation of the analyzed optimization model. Then, various facts may be determined from the allocations and, when applicable, by analyzing the balance rules and traversing them (1306). Report results are determined and a report may be generated (1308) which may also be saved (1310).

An e-sourcing system can provide support for reporting values through a supply chain. Such a system can comprise:

receiving an optimization model representing at least one balance;
creating a report where the value reported in association with one bid or item is based on the allocation of another bid or item, traced via the definition of one or more balances. More specifically,
(a) receiving a user-defined specification of an optimization model in which the allocation of a first bid is related to the allocation of a second bid via a rule, where

(i) said rule defines relations between a first set of bids and a second set of bids, and

(ii) said first bid is part of said first set and said second bid is part of said second set;

(b) receiving a user-defined specification of a report, said specification of a report referring to said specification of an optimization model;
(c) analyzing said optimization model, said analyzing including tracing the relation between said first and second bid via said rule,
(d) based on said analysis and said user-defined specification of a report, reporting a value as related to said first bid, said value being dependent of said first bid's relation to said second bid via said rule; and
(e) outputting said report.

A value reported for the first bid can be based on a value associated with the second bid. A value reported for the first bid can be based on the allocation of the second bid. The cost reported for a bid in the first set can include part of the cost calculated for a bid in the second set. It can also include the entire cost calculated for a bid in the second set. How large part of the cost that is transferred to the first bid can depend on the volumes allocated to at least one third bid.

The allocation of the second bid can be resulting from solving an optimization problem. The first bid can be outside the second set of bids. The first bid can be part of the second set of bids.

In step (c) and (d), the report generator will then traverse through the balance rules until a specific path has been analyzed for reporting.

A report can contain filters and aggregation methods that define how to trace data through a supply chain or network, defined in a scenario. Specific filters and aggregations or combinations of them can form predefined or manager defined report facts. The report generator can traverse through the balance points defined by balance rules until the appropriate paths have been analyzed for reporting.

To exemplify with the rule about paper and printing above, the below table can be produced as a report by the system described herein. Taking the first row as a specific example: the table shows that “Football Poster 0012” to be delivered to “Sweden” has a tendered volume of 5,000 copies. The allocated printer was “Johnson & Sons”, and there were 3 candidate printers to choose from. Furthermore, traced through the balancing rule, the allocated paper delivery suppliers were “Prime Paper” and “West Corp”, and for this printed matter there were 2 candidate paper delivery suppliers. The costs per copy and the overall cost was also displayed. Furthermore, from the second row we see that “Ultimate Comics Periodical” can never be allocated as the report reveals that there is no potential paper supply.

| | | Facts | | | | | | | |
|---|---|---|---|---|---|---|---|---|---|
| | | | | | | Number | | | |
| | | | | | | of | | | |
| | | | | Number | Allocated | Potential | | | |
| Dimensions | | | | of | Paper | Paper | Paper | | |
| Printed | Delivery | Tendered | Allocated | Potential | Delivery | Delivery | Cost per | Print Cost | Total |
| Matter | Country | Volume | Printers | Printers | Suppliers | Suppliers | Copy | per Copy | Cost |
| Football | Sweden | 5 000 | Johnson & | 3 | Prime | 2 | 0.2 | 0.15 | 1 750 |
| Poster | | | Sons | | Paper; | | | | |
| 0012 | | | | | West Corp | | | | |
| Ultimate | Sweden | 10 000 | | 1 | | | | | |
| Comics | | | | | | | | | |
| Periodical | | | | | | | | | |
| Football | Norway | 4 000 | Amundsen | 4 | Prime | 3 | 0.21 | 0.16 | 1480 |
| Poster | | | Print | | Paper | | | | |
| 0012 | | | | | | | | | |

Displaying Reports to Bidders:

As mentioned above, a custom designed report may be split by bidder and distributed so that each bidder may receive its own part. Alternatively, reports can be distributed as they are or split in other ways. Which part of a report that is shown to which bidder may be set by a manager.

Multi-Project Reports:

A report may be defined to report on several projects, even if the different projects have partially different fields. Fields of different projects can be matched from field name or some other mapping. The field may not need to be defined for every project, but can be applied whenever possible.

### Example

Below is an example of a multi-project report, REPORT 2, for projects P1, P2, and P3. The report has subtotals per Country and State. Note that the subtotal does not need to be just a plain summation, if the fact is Coverage %, the totals can contain a correct calculation for the combined scope. A simple summation, or some other calculation, can be an option, and in the same report there can be a mixture between different ways to aggregate subtotals. In the example, the manager has chosen to format the cells as percent and currency cells, color the Cost column yellow (depicted using diagonal shading), and use a special formatting. The manager has also selected a formatting rule stating that allocation less than 100% should be marked in red (depicted using vertical shading). As can be seen in the table, bidder C did not have any bids in project P2.

When creating the report, the fields “Country” and “State” can be identified by name and type, even if they are defined in different tenders. They can also be declared fields existing in multiple projects.

TABLE REPORT 2

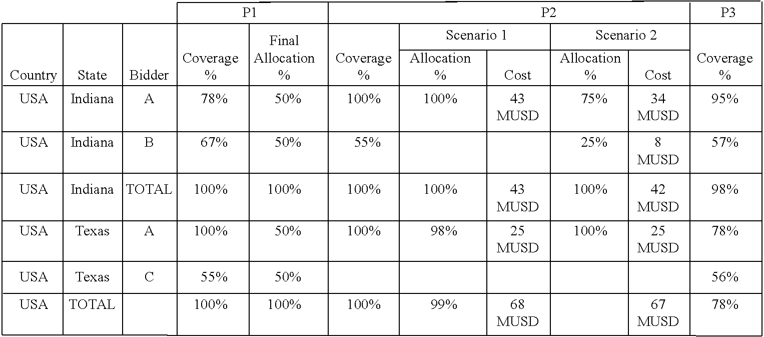

Generating New Fields or Objects from Reports:

Report results may in turn be used to generate new fields or objects (bidders, lots, bids, fact tables).

Example, Creating Lots from a Report

A fact table may contain a transaction log like the following table, TRANS 3:

TABLE TRANS 3

| From City | To City | Month | Volume |
|---|---|---|---|
| Boston | Boston | June | 34 |
| Boston | Seattle | July | 45 |
| Boston | Seattle | July | 23 |
| Seattle | New York | July | 12 |

Based on this fact table, we may create a report that has “From City” and “To City” as dimensions and “Volume” as fact. We get the following:

| From City | To City | Volume |
|---|---|---|
| Boston | Boston | 34 |
| Boston | Seattle | 68 |
| Seattle | New York | 12 |

The manager can now trigger lot creation from the report (without the need to upload or download any document) where the lots contain the fields “From City”, “To City”, and “Volume”. Alternatively, we can let the lot field “Volume” be a formula that aggregates values from table TRANS 3.

In various embodiments, a computer-implemented method of conducting e-sourcing where lots/items can be created from reports, where the method comprises:

(a) receiving a specification of a report, which can be user-defined or pre-defined;
(b) generating the report;
(c) storing the report to computer readable media;
(d) reading the report from computer readable media, interpreting the report as defining item data;
(e) generating data for an item based on the interpretation; and
(f) storing the data to computer readable media.

Step (b) can generate the report in compliance with a given format suitable for defining item data, and step (d) can read said report from computer readable media, interpreting the report as defining item data according to said format.

Step (e) can include generating a new item. Step (e) can include generating item data for updating an existing item. In Step (d) the interpretation can be based on a pre-defined or a user-defined specification for how to interpret a report. This specification can comprise a mapping between a part of the report content and an item field. In Step (e) data or items can be removed as a consequence of the generating.

After data is created, it can be used for e-sourcing, for example through the following steps:

(g) receiving a bid associated with the item;
(h) calculating an allocation based on the bid; and
(i) storing the allocation to computer readable media.

Example, Manual Allocation with a Report

The sample fact table shown below, MANALLOC, contains the fields “Lot”, “Bidder”, and “ManualAlloc”.

TABLE MANALLOC

| | | |
|---|---|---|
| Lot | Bidder | ManualAlloc |

In a scenario, there may be a rule that states “For every bidder and lot, allocate ManualAlloc, if any”. We start with the fact table being empty and run our scenario. We then create a report like the following:

TABLE
ALLOCATION REPORT

| Lot | Volume | Bidder | Equipment | Price | Allocation | ManualAlloc |
|---|---|---|---|---|---|---|
| Item 1 | 125 | A | Light | $100 | | |
| Item 1 | 125 | B | Heavy | $120 | | |
| Item 1 | 125 | C | Light | $95 | 125 | |
| Item 2 | 154 | A | Heavy | $100 | 154 | |
| Item 2 | 154 | C | Heavy | $134 | | |

The manager can now edit the table by entering some numbers in the column MannualAlloc. This can be done directly online or via a downloaded document.

| Lot | Volume | Bidder | Equipment | Price | Allocation | ManualAlloc |
|---|---|---|---|---|---|---|
| Item 1 | 125 | A | Light | $100 | | |
| Item 1 | 125 | B | Heavy | $120 | | 100 |
| Item 1 | 125 | C | Light | $95 | 125 | |
| Item 2 | 154 | A | Heavy | $100 | 154 | 87 |
| Item 2 | 154 | C | Heavy | $134 | | |

Now, the manager submits/updates this report, specifying that it should update the fact table MANALLOC. The fact table will now look like this.

TABLE MANALLOC
(updated)

| Lot | Bidder | ManualAlloc |
|---|---|---|
| Item 1 | B | 100 |
| Item 2 | A | 87 |

Based on the manager updates and after the scenario is (re)solved, the report may look like this:

| Lot | Volume | Bidder | Equipment | Price | Allocation | ManualAlloc |
|---|---|---|---|---|---|---|
| Item 1 | 125 | A | Light | $100 | | |
| Item 1 | 125 | B | Heavy | $120 | 100 | 100 |
| Item 1 | 125 | C | Light | $95 | 25 | |
| Item 2 | 154 | A | Heavy | $100 | 87 | 87 |
| Item 2 | 154 | C | Heavy | $134 | 67 | |

The manager can now continue to change the ManualAlloc column and update the MANALLOC table as desired.

A system allowing flexible manual control of allocation may be configured to perform a computer-implemented method of conducting e-sourcing comprising:

(a) receiving a user-defined specification of a report;
(b) generating a first version of the report and storing the report to a computer readable media;
(c) outputting the first version to a user;
(d) receiving a second version of the report modified by the user;
(e) interpreting the second version, storing data based on the second version, the data containing information about desired properties of an allocation;
(f) calculating an allocation based on the data; and
(g) outputting the allocation.

The report stored in Step b) can be retrieved by a user, edited, and then provided to the system in step c). This can be done by the user downloading a report document, editing the document, and then uploading it. In another embodiment, this can be done by the user editing an on-line view of the report.

The report specification can contain an instruction to base a dimension of said report on a user-defined field. The report specification can contain an instruction to base a fact of said report on a user-defined field.

In step e), the calculation can comprise adding a constraint to an optimization model.

The constraint can be an equality constraint, less than, less than or equal to, greater than, greater than or equal to, or not equal to. Other constraints, such as conditional constraints, are also possible. The constraints can also have violation penalties.

In step b), the report can be based on the result of solving an optimization problem.

In Step c), the content of the received report can be stored in some other format, such as a fact table.

### Example

### Using Object Creation, Balance Rules, a Solver, and Reports to Design a Supply-Chain Tender

In the description below, all tables, fields, formulas, rules, and reports may be entirely defined as content in the sourcing system. This is contrast to prior art systems where the system does not support this level of complexity. Instead, customized enhancements need to be programmed/tailored applications have to be developed.

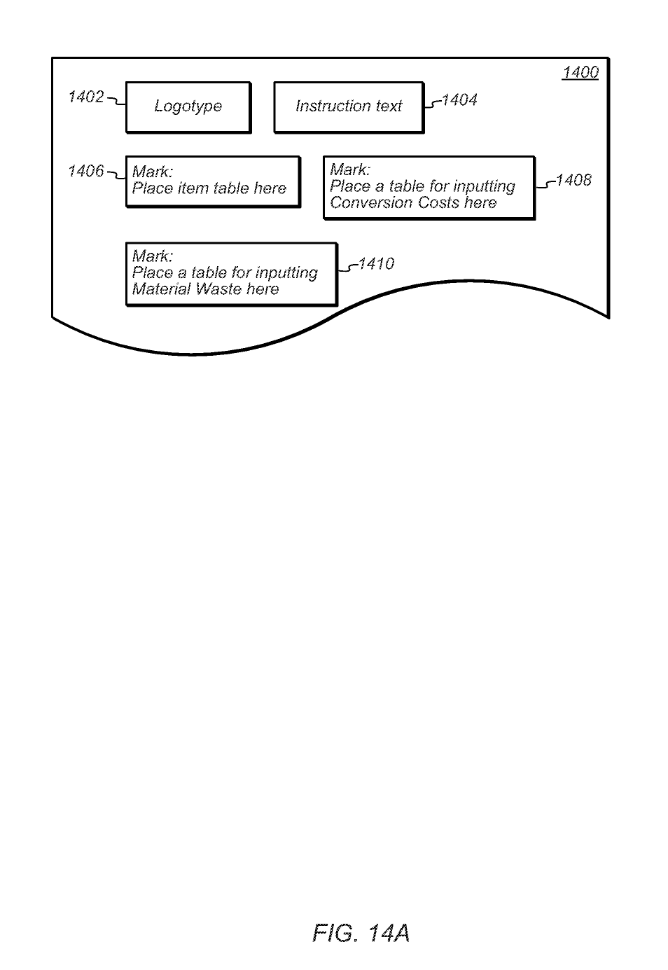

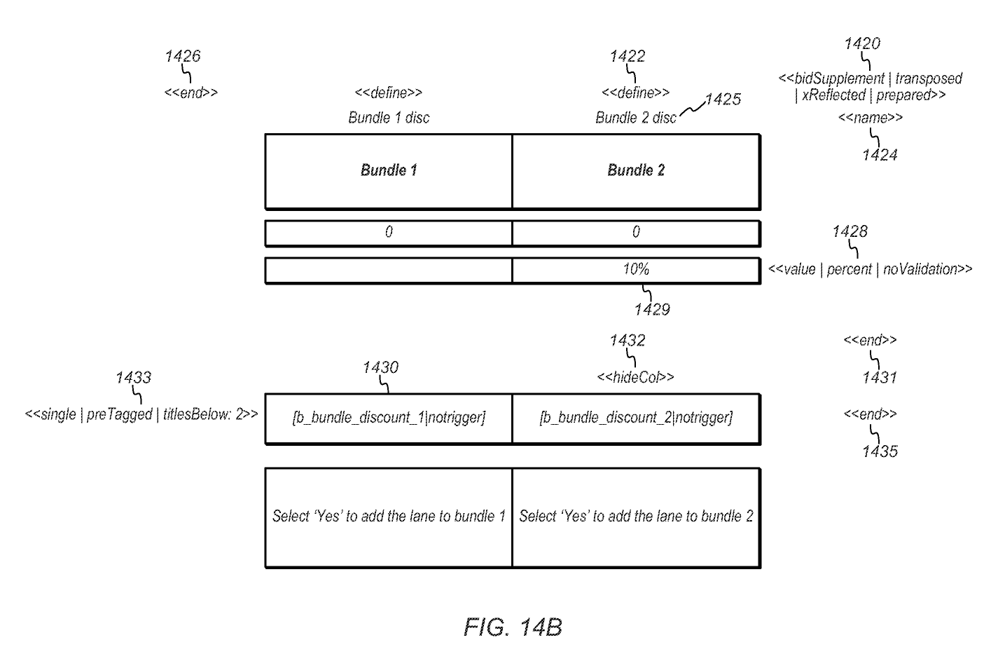

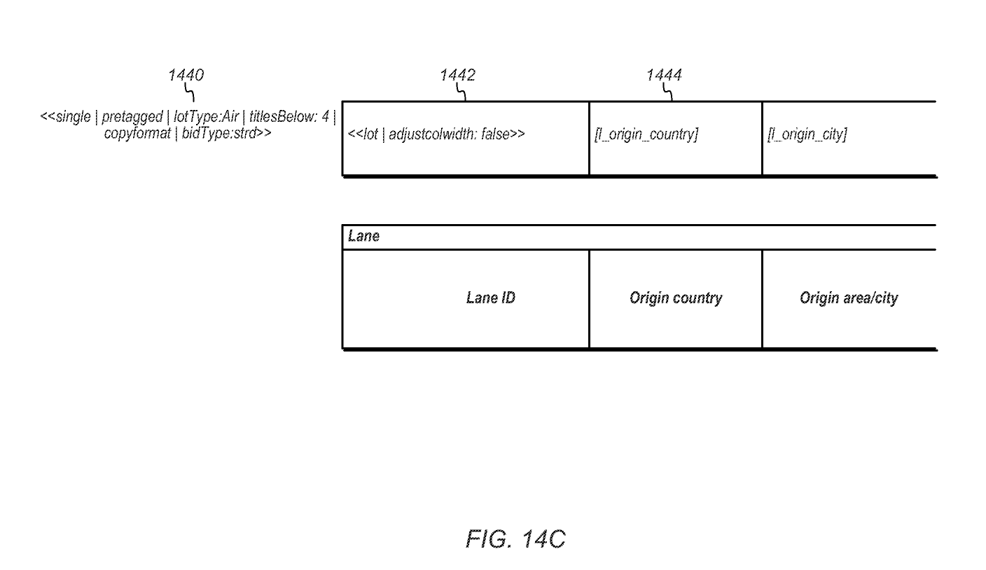

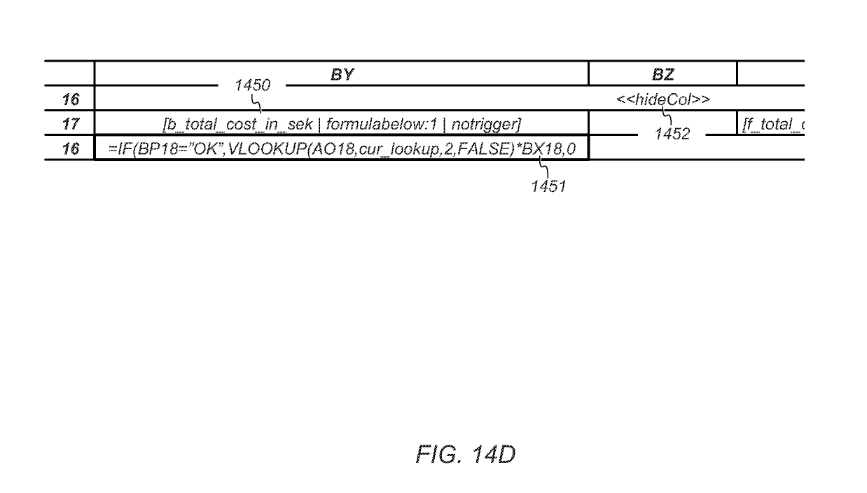

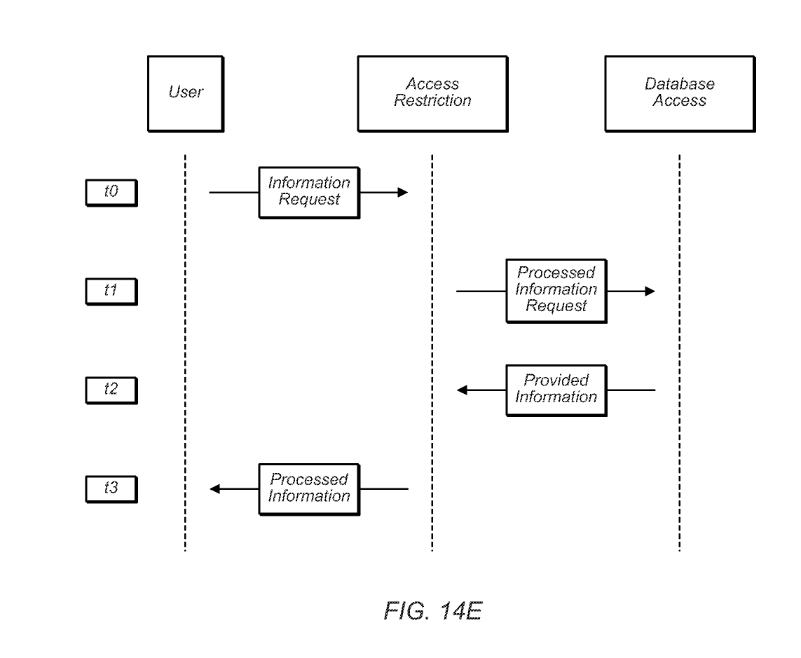

A simple example of a form template 1400 is shown in FIG. 14. In the example shown, the template includes various form fields such as Logotype 1402, instruction text 1404, and data/table insertion points 1406, 1408, and 1410. As may be appreciated, numerous varied types of template forms are possible and are contemplated.

FIGS. 14B, 14C, and 14D contains some examples of a tagging language. A tagging or markup language can be constructed in many ways, and many possible variations on the same theme are possible and contemplated.

FIG. 14B shows example tags of a bid form in which bids for items/lots can be associated with different bundles and how bundle discounts can be expressed. Tags are made visible for illustration.

The Tag <<bidSupplement| transposed| xReflected| prepared>>1420 can mean the following: biddSupplement indicates a type of field, “transposed” is a table formatting command, telling an interpreter where the value input value for a field is to be found in relation to the field name. “xReflected” indicates that the table is read from right-to-left, and “prepared” indicates that the set of fields, and their positions, is given explicitly in the form instead of being created by the form generator.

The tag <<define>>1422, <<name>>1424, and <<value|percent| noValidation>>1428 are interpreted together defining a matrix of input values. The intersection between the column of the <<define>> tag 1422 and the row of <<name>> tag 1424 defines a name 1425 of a field. The intersection of the <<define>> tag 1422 and the <<value . . . >> tag 1428 defines the cell 1429 where a value of the field 1425 is to be placed. The tag 1428 is extended by “percent” indicating a format for the displayed values, and “noValidation” indicating that a verification step is skipped for these values.

The two tags <<end>>1426 and 1431 indicates endpoints for the matrix.

The tag <<single|preTagged|titlesBelow: 2>>1433 indicates the start of a new table, “single” indicates a table of bids, “preTagged” indicates that a selection of bid fields is done by naming the fields in the columns, but the rows are created dynamically, dependent on which items are to be included when the form is created. Command “titlesBelow: 2” defines that column header information is to be found on the following 2 rows and that on the third row, from the tag row, the Form Generator will start creating items and bid input fields. Tag [b_bundle_discount_{—}1|noTrigger] 1430 defines in which column the bid field “b_bundle_discount_{—}1” should be placed, “noTrigger” indicates that a input value for this bid field alone will not create a bid when the bid form is uploaded into the platform.

The <<hideCol>> tag 1432 indicates that the Form Generator should hide the same column when generating a form, but still keep it in the form for use of the form Interpreter. The <<end>> tag 1435 indicates the end point of the table from left to right. There is no<<end>> tag below this table, since the height will depend on the number of items included, which can vary from time to time.

Further examples are shown in FIG. 14C.

Tag <<single|preTagged|lotType:Air|titelsBelow:4|copyFormat|bidType: strd>>1440 is a start tag for a dynamically populated bid table. Command “lotType:Air” specifies that the table should only be populated with lots from a particular lot type, and “bidType:strd” indicates that only bids for a Bid Type called “strd” should be included. The commands “single”, “preTagged”, and “titlesBelow” are described above. Command “copyFormat” implies that the formatting for values should ignore the format of the template cells and instead use the format associated with each field definition.

Tag <<lot . . . >>1442 indicates a column where the Form Creator should place names of included lots/items. Command “adjustColWidth:false” indicates that the Form Generator should keep columns widths as in the template, ignoring the width of the content.

Tag [1_origin_country] 1444 marks the column for a particular field, defined by its formula name.

Another example is illustrated in FIG. 14D.

Tag [b_total_cost_in_sek|formulaBelow:1|noTrigger] 1450 indicates the following. Variable “b_total_cost_in_sek” is the formula name of a bid field. Command “formulaBelow:1” indicates that the input value is a spreadsheet formula 1451 defined one row below the tag itself. This formula will be copied to every populated row in the specified column. Command “noTrigger” indicates that a non-empty formula value will not by itself imply an attempt to submit a bid. Tag <<“hideCol”>>1452 is explained above.

Asynchronous Architecture.

In various embodiments, the system can be configured to perform tasks asynchronously. It can also be configured as a set of asynchronous processes acting as workers, related to one or more data storage units, and one or more processes acting as job managers. New worker units (e.g., processes) may be added (spawned or generated if software or added/allocated if hardware) dynamically, and each worker can be configured to perform several tasks asynchronously. In various embodiments, a worker unit may be a hardware entity, a virtual hardware entity, a software process, or any other means to divide and perform computation tasks. A number of synchronous processes may share a common database and one process may access data generated by another process.

Different tasks that may be performed by a worker unit include, but are not limited to:

(i) Receiving input from a user. Typical examples include: a bidder providing bids, a bidder providing non-bid data, a local stakeholder providing forecast data, a project manager providing bids on behalf of a bidder, a buyer updating item data, and so on.
(ii) Calculating feedback for bidders.
(iii) Calculating and generating reports.
(iv) Performing data transformations, such as creating artificial bids from other data, calculating user-specified formulas.
(v) Solving one or more optimization problems.
(vi) Generating electronic documents.
(vii) Displaying data, such as reports, overviews, and feedback to users. Data may have been generated by other processes.

In various embodiments, the set of worker units can be changed dynamically to meet demand. One embodiment of such dynamic allocation of worker units is to allocate resources dynamically from cloud computing suppliers (such as, but not limited to, Amazon EC2, Microsoft Azure, and IBM SmartCloud). Another is to use some form of local hardware cluster. If the same system is used for a number of simultaneous exchanges, the hardware resources may be shifted between exchanges as usage fluctuates. The allocation of worker units can be handled manually or automatically by the system. In various embodiments, activation of new workers (e.g., the installation of software, etc.) can be done automatically by the system.

Bidder Feedback.

Bidder feedback can be customized in many ways, and a manager can choose any type of information to be used as feedback. Additionally, feedback can be given in different time-frames, where some feedback can be quickly computed and can be timely provided to bidders, whereas other types of feedback may require the solving of a complex optimization problem which may take a significant amount of time to solve. Feedback based on such computations generally cannot be provided as quickly or frequently as feedback which is faster to compute.

Feedback can be of different forms, such as, but not limited to:

Verification feedback, which is feedback on the correctness or errors of submitted information. Verification feedback may explicitly point the bidder to the faulty input, and/or provided error lists in a particular format. If bidding is done via a spreadsheet, a new spreadsheet which includes marked errors can be produced by the sourcing system. This type of feedback can typically be provided in a quick manner.

Bid statistics feedback, which is feedback which can be computed directly on submitted bids without the need for computing an allocation. Such feedback includes distance to lowest submitted bids on the same lot, different bid ranks, and feedback on coverage. This type of feedback is typically relatively quickly provided after bid submission.

Allocation-based feedback, which is feedback typically representing an allocation that would be the outcome of a tender if no further bids were to be submitted, though there are many variants which will be apparent to anyone skilled in the art. For example, the optimizer may gradually find better and better allocations and provide feedback before a provably optimal allocation is found. As this feedback is based on solving a possibly complex optimization problem, it typically cannot be provided as quickly as the two types of feedback described above.

In some embodiments these types of feedback can be used in combination, and asynchronously, to provide timely and useful information in combination with less frequently updated feedback that may be more informative. Furthermore, the usage of several workers may enable parallel computation of optimization problems. For example, this enables starting new solver instances as new bids arrive while other instances continue to refine solutions not based on all bids received at the current point in time.

The following example illustrates one possible embodiment of a time line in a bidding process with feedback.

TABLE TIME LINE 1

| Time | Event |
|---|---|
| T01 | Receive specification of formula F |
| T02 | Initiate calculation of F |
| T03 | Calculation initiated in T02 done, store values of F |
| T04 | Receive a signal that triggers re-calculation of F |
| T05 | Initiate calculation of F |
| T06 | Receive a request from a bidder, requiring a value based on F |
| T07 | Provide Feedback based on the value stored at time T03 |
| T08 | Calculation initiated in T05 done, store new values of F |

In the example above, specification of a formula, F, is received at time T01. At time T02 a calculation based on F is initiated, and the calculation completed at time T03. A signal is then received at time T04 that causes re-calculation of F. Such a signal may be generated in response to a change in one of the parameters/values originally used in the computation of F. Input is then received at time T06 (a request from a bidder in this case) that requires feedback based on a result of computation of F. Responsive to the request, feedback based on the value computed and stored at time T03 is provided at time T07. Subsequently, the computation initiated at time T05 is completed and a corresponding value stored at time T08. As can be seen in this example, while F was being recomputed, feedback was provided to the bidder based on the previously computed value. In this manner, feedback is provided to the bidder more quickly than would otherwise be the case if the second computation had to first be completed. Some degree of inconsistency is accepted as it is known that the value is likely to change.

As a second example, table TIME LINE 2 below illustrates feedback and allocation calculations.

TABLE TIME LINE 2

| Time | Event |
|---|---|
| T01 | New bids arrive, are processed, and stored as valid |
| T02 | Feedback on bids and associated data is communicated to the |
| | bidders |
| T03 | An optimization process, OP1, is started. |
| T04 | OP1 finds and stores a new allocation solution. |
| T05 | Feedback based on allocations found in T04 is provided to |
| | bidders. |
| T06 | OP1 finds and stores a new solution. |
| T07 | Feedback based on allocations found in T06 is provided to |
| | bidders. |
| T08 | New bids arrive and are processed and stored as valid. |
| T09 | OP1 finds and stores a new solution. |
| T10 | Feedback based on allocations found in T09 is provided to |
| | bidders. |
| T11 | Feedback on bids and associated data is communicated to the |
| | bidders |
| T12 | New bids arrive and are processed and stored as valid |
| T13 | An optimization process, OP2, is started, using bids arrived to |
| | and including T12. |
| T14 | OP2 finds and stores a new solution. |
| T15 | New bids arrive, are processed and stored as invalid, (e.g., you |
| | may want to store an invalid bid for future reference) |
| T16 | OP1 finds and stores a new solution. |
| T17 | OP2 finds and stores a new solution. |
| T18 | Optimization process OP1 is terminated. |
| T19 | Feedback on the invalid bids in T15 is communicated to the bidder |
| | submitted them. |
| T20 | The buyer provides tailored feedback to the bidders based on bids, |
| | allocations, or combinations of these. |
| T21 | Feedback based on allocations found in T17 is provided to |
| | bidders. |
| T22 | The buyer adds a rule to his most preferred scenario. |
| T23 | An optimization process, OP3, is started using bids arrived to |
| | and including T12 and the additional rule of T22. |
| T24 | Optimization process OP2 is aborted. |
| T25 | OP3 finds and stores a new solution. |
| T26 | Feedback based on allocations found in T25 is provided to |
| | bidders. |
| T27 | The forecast data changes |
| T28 | Feedback on bids and associated data is communicated to the |
| | bidders |
| T29 | OP3 is terminated. |
| T30 | A new optimization process, OP4, is started. |

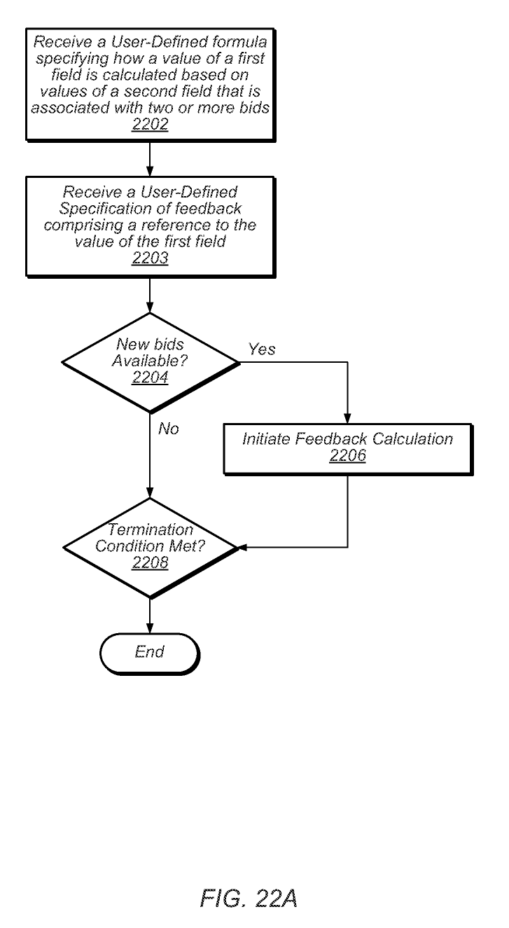

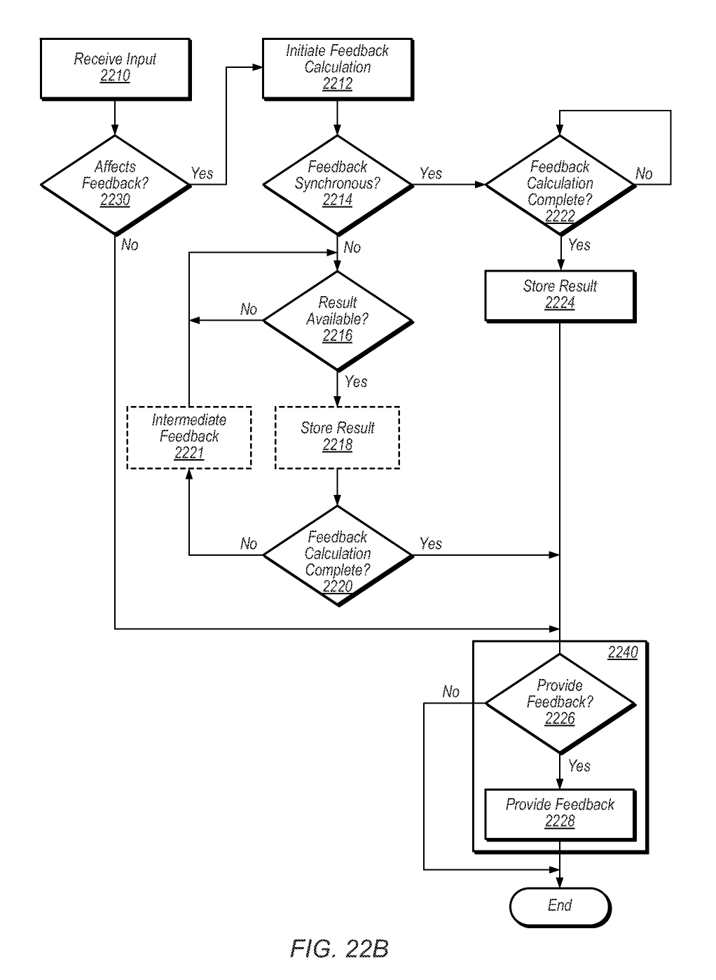

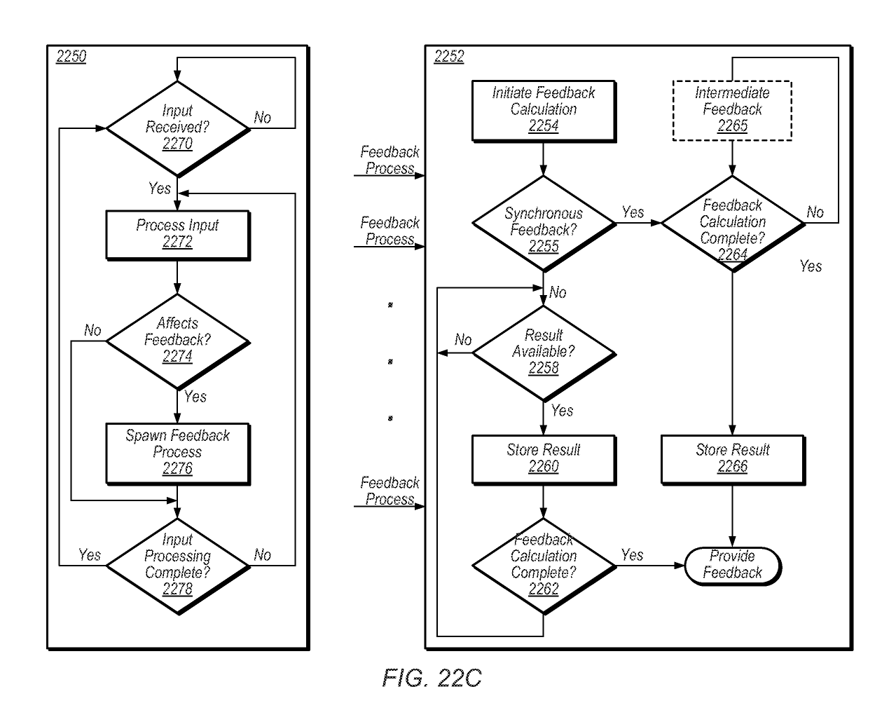

The decoupling of data input and feedback processes is exemplified in FIG. 22C (discussed below). This may result in inconsistencies in the bidding system as exemplified in the time-lines of Table TIMELINE 1 and Table TIMELINE 2. For example, from the time-line in Table 2, at time T03, an optimization process OP1 is started. Then at T08 new bids arrive. At T10 feedback is provided based on this optimization started at T03, presumably not taking the bids arriving in T08 into account. In this case the buyer accepts to provide feedback on allocations which do not take all available bids into account.

As another example from Table TIMELINE 2, at time T22, the buyer adds a rule to his most preferred scenario. Then at T24 optimization process OP2 is aborted. While the reason for this cannot be seen from Table TIMELINE 2, an explanation could be that the buyer does not accept providing feedback on an allocation which is inconsistent with the rules of the most preferred scenario, and that it is concluded a poor use of resources to let OP2 continue as it does not necessarily provide feasible solutions. The principles for handling time-consuming calculations, exemplified by solving optimizations problems above, can be applied also for other types of time-consuming calculations/operations such as formula evaluation, database operations etc.

In various embodiments, the system may have mechanisms to define what type(s) of inconsistencies are permissible while still providing feedback. For example, a buyer may have the choice to select whether or not inconsistencies of different types are acceptable. Such selections may include, but are not limited to, whether or not feedback can be provided if (i) a new bid has arrived (e.g., from another bidder), (ii) a bid has been replaced/modified, (iii) a bid has been withdrawn/removed, (iv) feedback calculation is not complete, and (v) allocation rules have been modified.

In various embodiments, such selections can also be combined with notions of time and other relevant factors. It may, for example, be desired to only disclose feedback which does not take new arrived bid information into account for bids that were received within the previous 10 seconds. Such selections may be set for a tender, for groups of feedback types/groups, on single feedback items, or otherwise.

One advantage of the methods and mechanisms described herein is that complex relations between input bids can be managed in a flexible way and configured by a user in a flexible and dynamic way.

Logs, Notification Centers:

In various embodiments a sourcing system contains functions for logging different events and to provide different forms of notification centers. Logs may be storing events at different levels of details. Logs may be kept for certain amounts of time, and different type of events can be stored for different amount of time. For example, very detailed logs on all navigation, receiving and submission of data a user has done may be stored for a shorter amount of time than a log of keeping summary data on bid submission. There may be filter functionality for retrieving different data in logs, further exemplified below.

A notification center may provide a user about selected passed and upcoming events. Such information can span over several projects, contain information on closing of phases, bid submissions, etc.

Management Tasks:

Management tasks are tasks that are to be performed by the managers/buyers of the project. Management tasks can be predefined as well as user-defined. Various embodiments support Management tasks in the e-sourcing system. This may include standard project management features, as those supported in standard software such as Microsoft Project, as well as special purpose features. Management tasks can include “Make an outlier check before January 8”, or “Upload all transaction logs”.

Frequently Asked Questions:

In various embodiments an e-sourcing system can contain features to support management of frequently asked questions. That is, the ability to answer questions in a one-to-many process.

Messaging:

Messaging is supported in various embodiment. A messaging system can support point-to-point communication and multi-cast communication. Messages can be displayed as part of the sourcing system and/or be transferred via e-mail or other means of message transfer. The e-sourcing system may be able to receive e-mails or other means of message transfer and process these messages based on receiver address or other properties of the message. For example, each tender in an e-sourcing can have its own e-mail address.

Messages can be sent selectively using different types of Filters. This can be used to for example “Send a reminder e-mail to all bidders that have logged in, but not yet placed a bid”.

Messages can contain special instructions to be processed by the system to enable individual adaptation of multi-cast messages. For example, various embodiments may send a message like:

### “Dear $FirstName$ $SecondName$,

You are invited to participate in Company Z's sourcing of transport. Please login at companyz.tradeext.com using user name $UserName$ and password $Password$.

### Regards

### Mr Zlatan

### Company Z”

can be processed to:

### “Dear Henrik Larsson,

You are invited to participate in Company Z's sourcing of transport. Please login at companyz.tradeext.com using user name henrik7634 and password hg53gfh61.

### Regards

### Mr Zlatan

### Company Z”

Cloning:

In some embodiments, a project may be cloned entirely or in part. A clone may be performed by the system, or it may be produced as a document or archive that can be manually downloaded, and uploaded in another deployment. Additionally, individual parts may be downloaded as specification documents that can be uploaded into other projects. For example, there may be support for cloning of some or all report definitions from one project to another. A downloaded clone document or archive may be in a form which can be manually processed, allowing for checking and editing certain properties of the clone. A system may also contain a number of templates in the form of project clones or in other forms.

Access Restrictions:

In some embodiments, there may be customized restrictions for certain users. For example, a bidder that can only supply lots of type Raw Material in France may be restricted to only see these lots.

Access restriction can be set directly in a GUI or be based on formulas and any other type of fields. Access restrictions can also be specified with an uploaded document. This enables the user to define access restrictions in a flexible way. Some examples of access restrictions that can be expressed using such formulas are:

(i) Only allow incumbents to see historic volume.
(ii) Only display lowest price for an item to all bidders when the lowest bid for the item is below field “Reveal price”.
(iii) Only allow bidders with proper ISO certification to view items in group “Hazardous goods”.
(iv) Only display shortest offered transit time on a lane to bidders that have placed a bid for the lane and have given a price below or equal to the value in field “Transit reveal price” and a have given a transit time below or equal to 4 days.
(v) Only display items in group “Paper” to bidders in group “Paper Bidders”.

A process including access restriction is exemplified in FIG. 14E. At time t0 an information request is sent from a user to the system. As an example, assume the request is to get information about all lanes currently open for bidding. The request is then processed by the access restriction component. The original request may then be changed. For example, with the example request above to retrieve information about all lanes open for bidding, it may be that the access restriction component changes the request to only request the lanes the user has access to. But in various cases it may be that the request is for still for all lanes. This is further described below. At time t1 the processed request is sent from the access restriction component to the database. The database provides the requested information and provides a reply back to the access restriction component at t2.

The access restriction component processes the information from the database. For the case that the request sent at t1 already contained limitations on the request for lanes, all information retrieved from the database may be transferred to the user at time t3. But for the case that the request at t1 did not contain any limitation of lanes, the information is filtered by the access restriction component. The decision of whether to restrict the request sent at t1 or to filter the information from the database can be dependent on many factors, such as the architecture of the database, ratios between total number of lanes and number of lanes accessible to the user, etc.

System Structure.

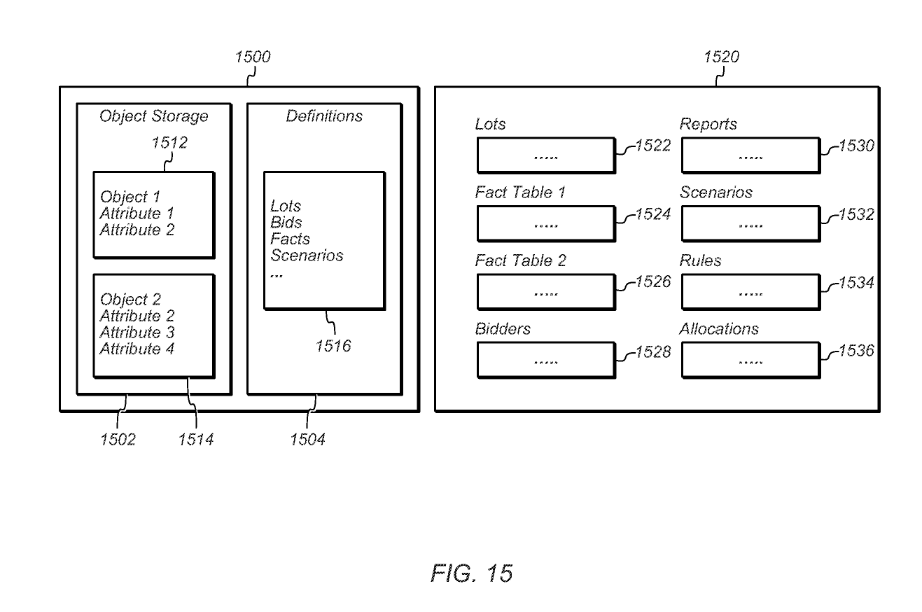

In some embodiments, the system can have an internal structure comprising an object storage and object definitions. An object can have attributes that defines its context. For example, objects of different fact tables can be stored in the same table in the system. An illustration of this concept is given in FIG. 15. The left part (1500) of the figure illustrates the actual system structure, while the right part (1520) illustrates the logical structure as seen by a user/manager. As shown in the example, Object Storage 1502 is shown to include Object 1 1512 and Object 2 1514, each include attributes. Additionally, Definitions 1504 are shown providing information 1516 such as Lots, Bids, Facts, and Scenarios. The logical depiction 1520 shows Lots 1522, Fact Table 1 1524, Fact Table 2 1526, Bidders 1528, Reports 1530, Scenarios 1532, Rules 1534, and Allocations 1536. As may be appreciated, other and/or different content may be included.

If a manager defines a new type of object, such as a new fact table, this can be done without adding a new table in the actual system. Rather, new objects are created with suitable attribute values. An example of two objects with different attributes, corresponding to two different fact tables, MANALLOC and TRANS 3 above, is given in Table OBJ1 shown (again) below. The object values can also be stored together, which is illustrated in Table OBJ2.

TABLE OBJ 1
Objects from two different fact sheets.

| Object type | Object id |
|---|---|
| Fact table “ManualAlloc” | 1001 |
| Fact table “ManualAlloc” | 1002 |
| Fact table “TRANS” | 1003 |

TABLE OBJ 2
Values from two different fact sheets.

| Object id | Parameter | Value |
|---|---|---|
| 1001 | Volume | 125 |
| 1001 | Equipment | Light |
| 1003 | Month | June |

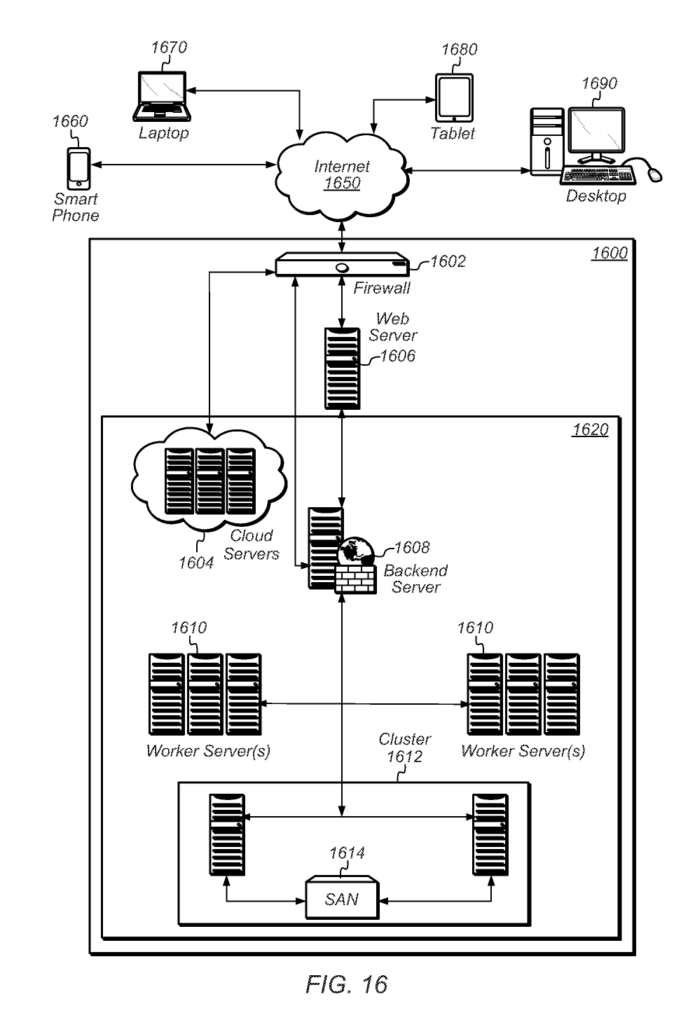

Turning now to FIG. 16, one embodiment of a sourcing system 1600 coupled to client computing devices via the Internet 1650 is shown. In the example shown, client computing devices coupled to the sourcing system 1600 include a desktop computer 1690, tablet computing device 1680, laptop computer 1670, and smart phone 1660. As may be appreciated, other computing devices may also be used to connect to the sourcing system 1600, such as computing devices integrated into transportation systems (e.g., automobiles, airplanes, trains, etc.), wearable computing devices, and so on. In various embodiments, computing devices may be configured to respond to voice commands to communicate with the sourcing system (e.g., a voice recognition personal assistant). Numerous such devices are possible and are contemplated.

As shown in FIG. 16, the sourcing system 1600 may be connected to the Internet 1650 via a connection including a firewall 1602. In an embodiment such as that shown in FIG. 16, bidders, buyers, and other users interact with the sourcing system 1600 using devices such as those shown (1660, 1670, 1680, 1690). System 1600 manages the user data, performs calculations, makes allocations, generates reports, and so on as discussed above. Web pages for bidders, buyers, and other users can be produced in a web-server 1606 for use by computing devices. In the example shown, a server 1608 (backend server) is configured to receive data and signals from the web-server 1606 and store data to a database. In this example, a server cluster 1612 (e.g., SQL based or otherwise) with storage area network 1614 is shown that may store the database. In addition, the backend server 1608 may be configured to perform various types of processing and may also be configured to initiate jobs on other computers (or otherwise convey data to other computers which then utilize the data). For example, additional (worker) servers 1610 may be utilized for processing tasks and/or storing data. Still further, cloud based servers 1604 may be utilized for processing tasks and/or storing data. Further, the backend server 1608 may also be configured to manage scheduling of different tasks, such as closing the system for bidding in a specific project. The worker servers 1610 can perform computationally intensive tasks, such as solving optimization problems or performing different forms of infeasibility analysis, or any other desired tasks.

In various embodiments, the system can be modified while remaining operational. For example, hardware and/or software modifications may be made without the need to bring the system 1600 offline. For example, in an embodiment leasing hardware from a cloud server provider, additional hardware/computing resources may be leased and added in order to increase capacity or capability in some way. The server cluster (or other forms of database hardware) generally manages the longer term storage of data. In the example shown, one or more elements within block 1600 may referred to as a processing system. In some embodiments, the backend server 1608 generally performs processing tasks. In other embodiments, worker servers 1610 may be used for performing one or more tasks. Further, in some embodiments, cloud based servers 1604 may be used for performing processing tasks. Still further, in various embodiments, processing of tasks may be distributed among two or more devices in the system 1600.

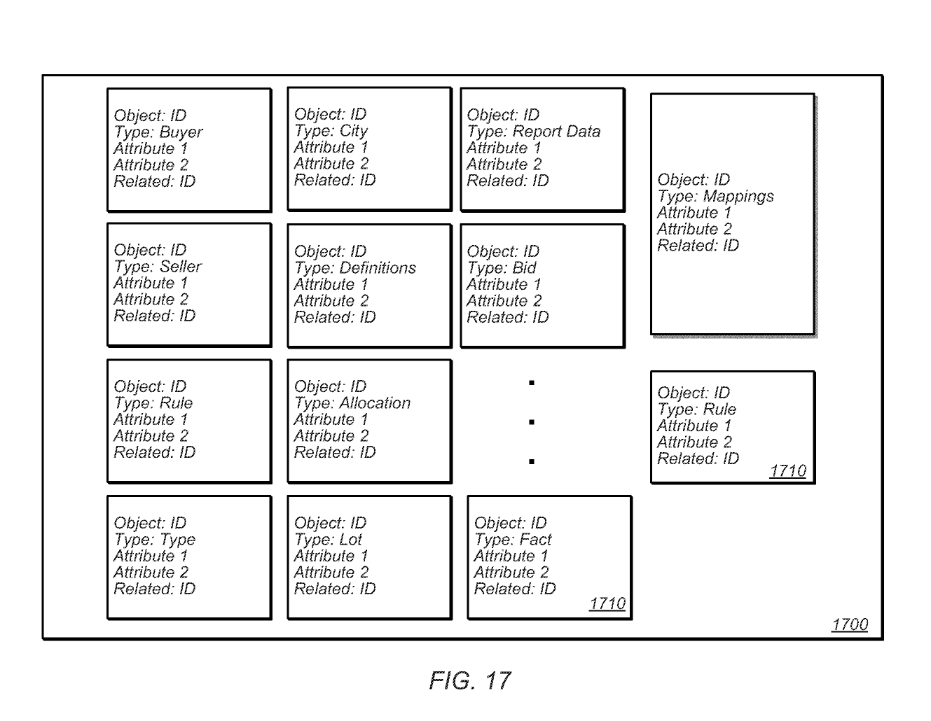

Turning now to FIG. 17, one embodiment of data stored in a database is shown. As shown, database 1700 may comprise objects 1710. In various embodiments, objects that are stored in the database may be explicitly identified with an identifier (ID) or implicitly identified based on a relationship to one or more other objects or a location of the object. In various embodiments, some objects are both explicitly and implicitly identifiable. As discussed above, some objects may be stored as a BLOB, or otherwise.

Generally speaking, objects are of varying types and may be configured to store different types of data or serve different purposes. For example, FIG. 17 shows (for ease of illustration) that there a variety of types of objects—Buyer, Seller, Lot, Rule, and so on. Each of these objects may be configured to store data according to its type. As an example, the objects shown in FIG. 17 depict attribute fields. These fields may store any type of data associated with the object. Additionally, the format of the objects represented is exemplary only. Those skilled in the art will appreciate that such data objects may take many different forms.

For example, an object of type Buyer may include details concerning a particular buyer. Such an object may also include references (e.g., via the Related field, etc.) to other objects that identify a history of transactions related to the buyer, rules the buyer has defined, preferences, and so on. Other types of objects, such as the Mappings object type, may serve to identify various types of relationships between objects in the database. Generally speaking, transactions or queries targeted to the database may include one or more identifiers (IDs) and or one or more data items that may be used to search the database as discussed below.

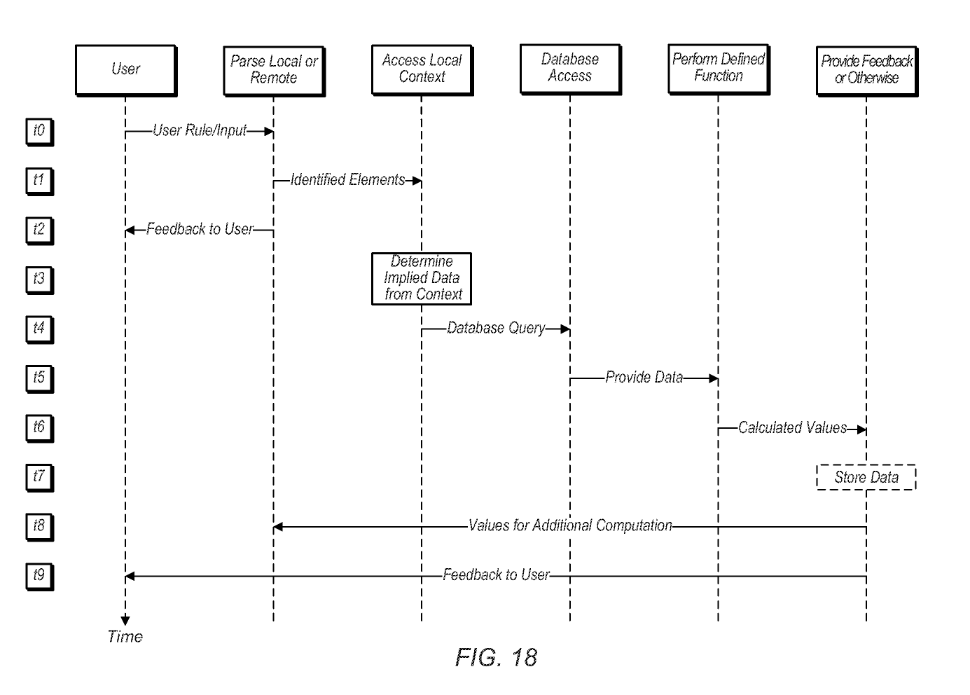

Turning now to FIG. 18, one embodiment of how a user might interact with the database is shown. In the example provided, a sequence diagram illustrates possible transactions that may occur over time (t0-t9) responsive to user input. User input may be provided via a graphical user interface, free format text, voice input, or otherwise. As shown, at time t0 User Rule/Input is received from a user. This input is parsed locally at the client's device or remotely according to a given embodiment. In some embodiments, the client's local device performs some initial parsing of the input when is then formatted for conveyance to one or more remote locations for further processing. Responsive to parsing the input, various functions and/or data elements may be identified (t1). It is noted that error checking may be performed on the input data to ensure it complies with a given format or is otherwise valid. If an error or problem is detected, a message may be provided to the user (t2).

In various embodiments, the identified elements may have values that are determined based on a current state or context. For example, the user may be in the process of a particular bidding scenario which is identified by the context. Such a context may be stored locally and/or remotely depending on the embodiment. If certain values depend on, or otherwise require access to, the current context, then such values may be obtained from this context (t3). If such values are not required, then this step may be skipped.

In various embodiments, the user input includes one or more functions that require access to the system database. For example, the system may be configured to display the distance between each bid (or some of the bids) and the corresponding lowest bid. In order to determine the lowest bid, a database query may be generated by a server and conveyed for access to the database (t4). Responsive to receiving the query, the requested data may be returned (t5). On receipt of the returned data, the server (or a different entity) may then calculate a distance between the user's current bid and the value returned by the database. The calculated value may then be conveyed to the user (t9), optionally stored (t7), and provided for use in further computations (t8). In various embodiments, each of the blocks noted at the top of FIG. 18 (i.e., User, Parse Local or Remote, Access Local Context, etc.) may generally have an associated component that performs the actions. Such components may comprise any combination of hardware and/or software as desired. Further, in some embodiments, multiple actions may be performed by a single component. Additionally, other actions and components may be included that are not shown in the example of FIG. 18. These and other embodiments are possible and are contemplated.

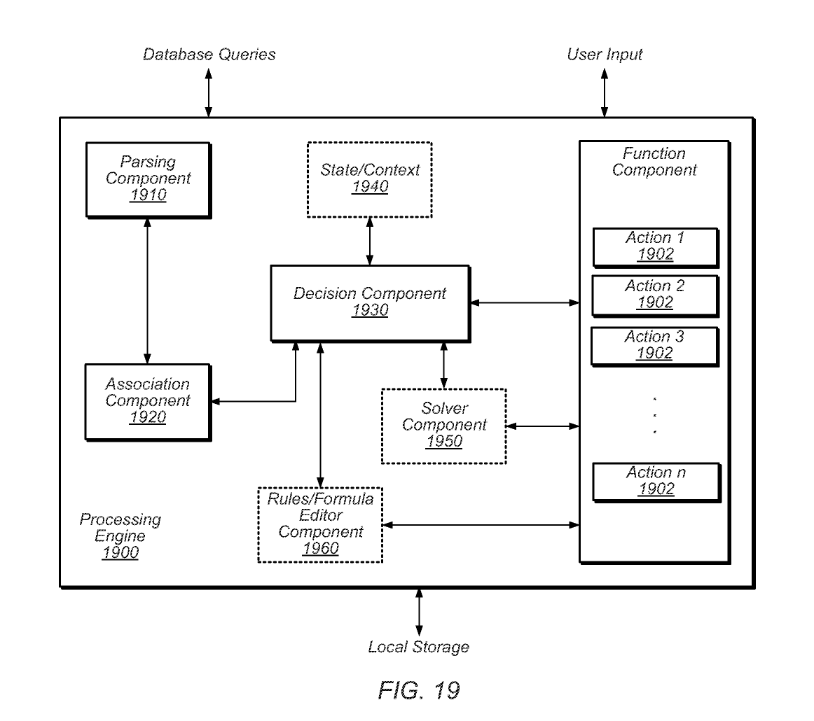

FIG. 19 illustrates one embodiment of a processing engine 1900. In the example shown, the processing engine is shown to include a number of components. It is noted that the communication links between the various components are exemplary only. In various embodiments, any component may be configured to communicate with any other component. However, in various embodiments, not all of these components may reside in the processing engine 1900, per so. Rather, various components may reside elsewhere. For example, one or more components may be distributed among two or more of the devices depicted in FIG. 16. In this example, the various components described are shown together for ease of discussion.

In the embodiment shown, the processing engine 1900 includes a parsing component 1910, an association component 1920, a decision component 1930, and one or more action components 1902. Included among the action components 1902 may be components to perform various functions such as determining a maximum or minimum value in a set of values, determining a distance between two values, determining average values, comparing values in other ways, and so on. In addition, such actions may include performing combinations of functions. For example, formulas or rules may be user-defined that manipulate data using multiple steps. Also illustrated is a state/context component 1940. The state/context component 1940 may generally be configured to store information regarding user interactions, pending transactions, and other data related to a state of the system. For example, in various embodiments the state of a current user action may implicitly define values associated with following user input (i.e., one or more values are defined by or depend in some way on the context). Additionally, the state/context may store intermediate values and other values for use in ongoing transactions. In some embodiments, the processing engine 1900 may be configured to access local storage devise and/or remote storage devices (e.g., databases). It should be understood that the above-described components may be implemented as different modules within a single process, as an integrated whole, or as any combination thereof. They may also be further subdivided into more components. If implemented as multiple modules, they may be instantiated as separate threads within a single executing program, as separate programs that communicate with one another or are placed together in a single thread of an executing program, in a multithreaded system, and otherwise. All such embodiments are possible and are contemplated.

Generally speaking, processing engine 1900 is configured to detect user input (e.g., input via a web page, upload/download, or otherwise). In various embodiments, such input may correspond to rules and/or formulas defined by a user. Response to detecting such data, the parsing component 1910 is configured to parse the received data and identify various data elements included therein. In response to parsing of the data elements, the parsing component 1910 may convey data corresponding to the detected user input to the association component 1920. Association component 1920 may be configured to associate the data elements with other data. In addition, association component 1920 may be configured to determine the semantics of the received user input. Subsequent to determining the semantics associated with the user input, the association component 1920 may convey corresponding data to decision component 1930. Decision component 1930 may then initiate some action based on the received data and the current state/context. For example, in response to detecting that the user input include a “max” keyword, the decision component may be configured to utilize an action 1902 that corresponds to determining a maximum value amongst a number of values.

In various scenarios, it may be necessary to obtain referenced data that is not part of the current state/context and does not presently reside in the processing engine 1900. In such a case, for example, a query may be generated to identify and/or obtain the needed data. The query may then be conveyed to a database. Responsive to receiving the requested data, functions and/or actions identified by the user input are performed. For example, in various embodiments a solver component 1950 may be configured to perform various calculations. For example, solver component 1950 may be configured to solve systems of equations (e.g., linear equations), optimization problems, and perform other types of computations. As already noted above, solver component 1950 may reside elsewhere and in fact there may be multiple instances of one or more of the components shown in the system. Upon completing any necessary calculations, results may be provided to the user, stored in a local storage device, conveyed for storage in the database, used in further calculations, or otherwise according to the needs of the current task.

Also shown in FIG. 19 is a rules/formula editor component 1960. The rules/formula editor component 1960 is configured to enable users to define their own rules, formulas, actions, and otherwise for use in the system. In this manner, users can create functionality within the system that would otherwise require custom programming. For ease of discussion, the term “formula” will generally be used in the following discussion. In various embodiments, a graphical user interface is provided that allows users to dynamically build formulas to produce or otherwise generate desired results. For example, drop down lists or checkboxes can be provided to allow users to select functions for inclusion in the formula. A list of available fields may also be provided to facilitate ease of formula creation.

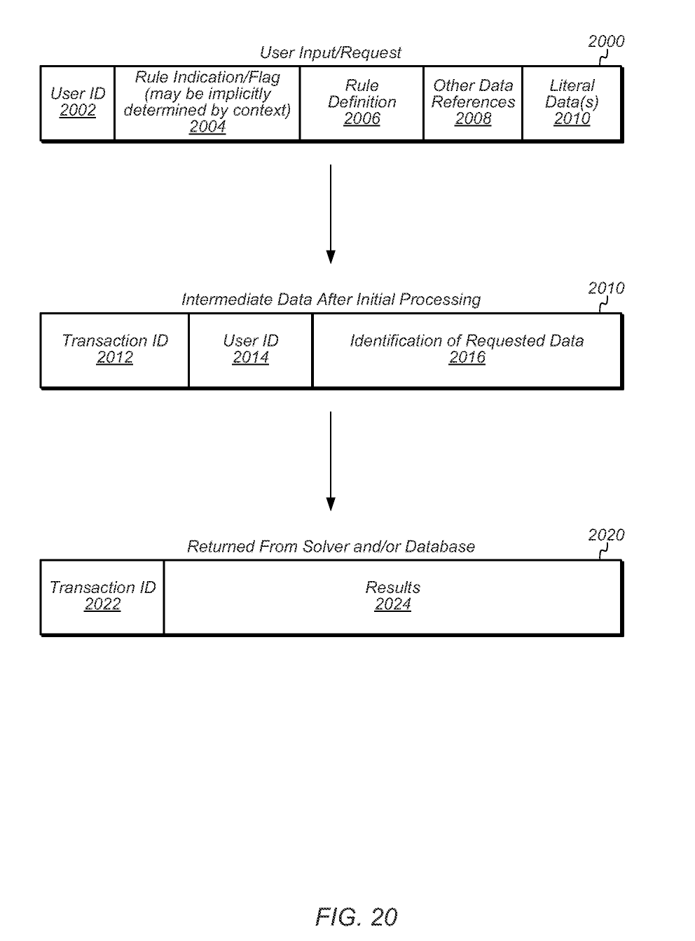

FIG. 20 depicts one embodiment of user input as described in FIG. 18. It is noted the embodiment shown is merely one of many possible formats that may be utilized for data. Other embodiments are possible and are contemplated. As illustrated, user input 2000 may be received. In various embodiments, the user input may be generated based on direct user input (i.e., entering values), functions and operators selected from a graphical user interface, or any combination of the two. User input 2000 is shown to include a number of fields which are exemplary only. In some embodiments, some fields may be implicit and may not be explicitly included in the input. For example, an ID of the user 2002 and indication of rule input 2004 may not generally be explicitly included, but may be implicitly determined based on the current user and/or otherwise determined based on the current context. In this example, the input includes a rule definition 2006. In addition to this, the user input may include or otherwise reference other data (2008) and/or data values that have been explicitly input (literal data 2010). The references to other data may include functions that request data values meeting various criteria. For example, a function that requests identification of a current lowest bid may be considered a reference to other data.

Responsive to receiving the user input 2000, some initial processing of the user input is performed to determine its content, included requests, and so on. In various embodiments, the received and processed user input may be associated with a particular transaction identifier (ID) 2012 in order to identify and otherwise keep track of the request. Such a transaction ID may also be associated with the user via the user's ID. While the user ID is shown as part of the data 2010, in various embodiments a separate table may be maintained for pending transactions that associate a given transaction ID with users as needed. In various embodiments, initial processing of the user input will determine that certain calculations need to be performed and/or data may need to be obtained from the database. In such a case, transaction data 2010 may be generated and conveyed to one or more components that are configured to perform calculations (e.g., a solver component) and/or access the database. An identification of the requested actions may be included as part (2016) of the transaction. Responsive to performing any needed calculations or accessing the database, corresponding results 2020 may then be returned. In various embodiments, such results 2020 may generally include the corresponding transaction ID 2022 and the results of the calculation(s) or database access 2024.

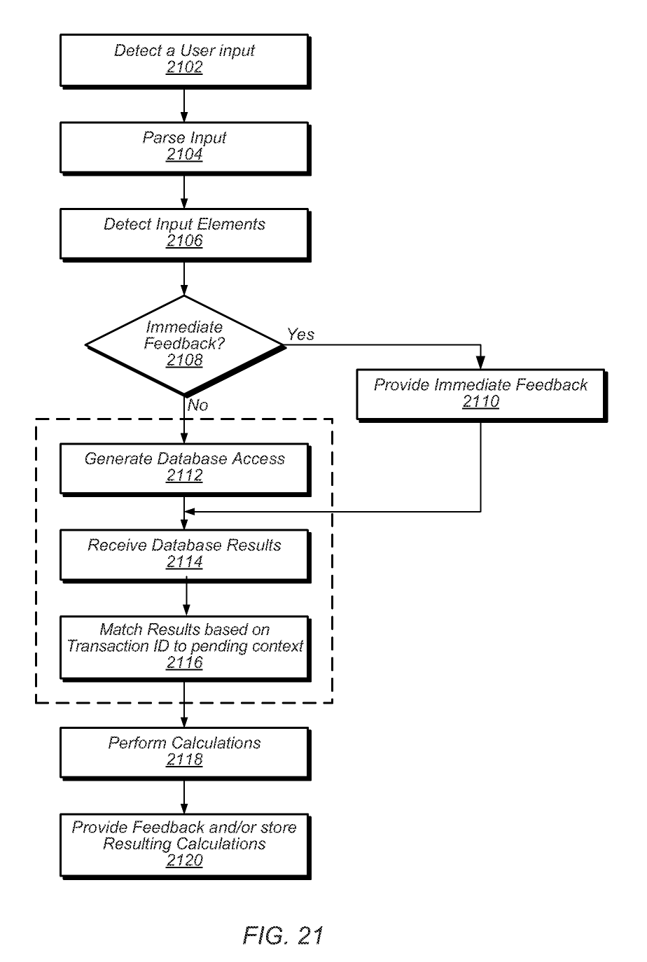

FIG. 21 illustrates one embodiment of a method for dynamic user input and requests. In the example shown, user input 2102 is detected. The input is then parsed and/or otherwise processed 2104. Responsive to processing the user input, various operators, functions, literal data elements, and/or requests for data 2106 may be detected. If immediate feedback is requested or required 2108 (e.g., due to an error, assert statement results, etc.), then such feedback may be provided 2110. Otherwise, if an access of the database is required, then one or more database queries 2112 may be generated and the database accessed. Results of the database query may then be received 2114 and identifies as being associated with a given pending transaction 2116. In the event that calculations are required, then such calculations may be performed 2118 such as by a solver component. Finally, the results of processing the initial user input are provided to the user (as needed), utilized in further calculations, and so on, depending on the nature of the requests 2120.

As an example, the e-sourcing system may be configured to receive a user-defined formula specifying how a value of a first field is calculated based on values of a second field associated with a set of one or more bids. To calculate a bid value based on values from other bids, a number of functions can be used. These can be find, min, max, average, median, standard deviation, spread, rank, bidder rank, etc. Each function can receive a definition about what field to compute the function on, and a matching criteria. The user can further specify feedback based on the first field if desired (e.g., to display the value). Additionally, the formula may also contain conditions on when to display feedback, such as “only display the lowest price when the lowest price has passed a certain target value” or “only display the distance to the best price per city for bidders with a top 5 rank in the country,” etc. It is also noted that the display of feedback can be updated in response to arrival of new bids or other events. For example, FIG. 22A illustrates one embodiment of a user defining what type of feedback the bidders will receive. In 2202 a user defines a formula specifying how to calculate the value of a first field. In one embodiment, the user-defined specification indicates the value of the first field is to be calculated based on a value(s) of a second field that is associated with other data (e.g., the other data may be derived from one or more bids of other bidders). In addition, the user defines and provides a specification of how feedback concerning the first field is to be provided 2203. For example, the user may specify that if new bids are available 2204, they are to initiate new feedback calculations. Based on the new bids, feedback calculation may be initiated 2206. When a termination condition is met 2208, the process completes.

Turning now to FIG. 22B, one embodiment of a method for processing received input is illustrated. In the example, input 2210 is received from a user. Such input may be bid data from a bidder, a question, other data or questions from non-bidders, and so on. Responsive to receiving the input, a determination 2230 is made as to whether the input affects feedback that might be provided in response to the input. If it is determined that feedback is not affected by the input, then the process may continue to optional block 2240 where feedback based on previously stored data may be provided, or the process may simply end.

If it is determined that the input does affect feedback that may be provided, then feedback calculation may be initiated 2212. Subsequently, a determination 2214 is made as to whether the feedback that may be provided corresponds to synchronous feedback or asynchronous feedback. Generally speaking, synchronous feedback may correspond to feedback that is provided based at least in part on input received from the user. In this sense, the output of feedback follows computation of feedback taking into account the received input. Asynchronous feedback may correspond to feedback that does not depend upon the currently received input. If the feedback corresponds to synchronous feedback, then calculation based on the received input may be completed 2222 before proceeding. After completion, a result of the computation is stored 2224 and optional block 2240 may be performed. Optional block 2240 includes a determination as to whether feedback is to be provided 2226 and if so, provision of feedback based on the stored result 2228. If feedback is not to be provided, the process may simply end.

If it is determined at block 2214 that the feedback does not correspond to synchronous feedback (i.e., the feedback corresponds to asynchronous feedback), then a determination may be made as to whether a result is currently available for use in providing feedback. In various embodiments, calculations may have been previously performed and corresponding results stored. In some embodiments, if such a prior result is not available and a current calculation is in progress, then when completed 2216 a corresponding result may be stored 2218. If there is no calculation in progress and a prior result is available 2216, then block 2218 may be skipped and a determination made as to whether feedback calculation is complete 2220. If completed, then the process may proceed to optional block 2240 or end. If the feedback calculation is not completed 2220, then the process may return to block 2216 to check for available results. There can be intermediate feedback 2221 given before the feedback calculation is complete.

Storing and Replacing Data:

For the purpose of being able to show feedback at the same time as the feedback information is being recalculated, there can be mechanisms for maintaining proper feedback data. Such mechanisms can be to ensure that the previous feedback data, such as allocation data, is removed in the same transaction as the new data is added, or a transaction very close in time. It can also be done by storing more than one version of the data, and letting the feedback module utilize the latest stored version.

Triggering Actions:

There can be automatic triggering of feedback calculation. Automatic triggering can be system defined or user defined. For example, a new allocation calculation, formula calculation, or other operation(s)/calculation(s) can be initiated when a bidding round is over or when a new bid arrives. There can be added scheduling constraints, for example a constraint ensuring that no allocation calculation is initiated within a certain time period after a previous calculation was initiated, or no new calculation is initiated as long as a calculation is ongoing, or a queued calculation is aborted if a new one is initiated, or an ongoing calculation is aborted if a new one is initiated. The aborting of one calculation can depend on properties such as the last time a successful calculation was completed and/or how long time a calculation is expected to take.

Activity Rules and Bidding Rules:

There can be activity rules for bidders. Such activity rules can be system defined or user-defined, and the activity rules can be coupled to feedback and allocation. For example, there can be a rule stating that a bidder has a deadline for providing a bid that depends on the last time he placed his last bid and the last time he had a leading price or leading allocation. Activity rules can be combined with bidding rules, such as minimum bid increment. Example: there is an activity rule stating that the bidder is only allowed to bid as long as he during the last hour had at least one of (i) a new unconstrained (or “single”) bid that improved the lowest price of an item or (ii) a winning allocation. An automatic implementation of this can be done by storing, for each bid, the time it was submitted, was a leading price, or an allocated bid. There can also be automatically triggered actions that removes constrained bids (such as package bids or discounted bids) if they have not been allocated a certain time. Such a removal would have the effect of avoiding that a bidder that has been blocked form bidding a certain time would be re-allowed by the fact that some other bidder's activity makes the bidder a winner. A tender can be organized in rounds or phases, and at a certain moment, different bidders or users can be placed in different phases. There are numerous considered possibilities along the same lines.

Turning now to FIG. 22C, one embodiment of a method is shown that illustrates how input may be received and feedback provided independently. In the example shown, block 2250 generally corresponds to a method in which input is received, processed, and one or more feedback processes may be spawned/triggered. Block 2252 illustrates a method corresponding to spawned feedback processes.

In block 2250, if input is received 2270, processing of the input is initiated 2272. In various embodiments, the received input may include one or more values that may be processed. A determination 2274 is made as to whether the received input affects feedback that might be provided to the user that provided or input, or to other users of the system. If feedback is not affected by the received input, then the method proceeds to block 2278 where a determination is made as to whether the input processing is complete. If complete, the method may return to block 2270. If the processing is not complete, then input processing 2272 may continue. In the case where the received input does affect feedback 2274, a feedback process may be spawned or triggered. In various embodiments, the spawned feedback process may continue independent of the method 2250. In the example shown, block 2252 is shown as corresponding to, or being triggered by, spawned feedback processes (Feedback Process). In various embodiments, numerous such processes may be spawned and execute concurrently. Feedback 2252 can for example be triggered by a user request for feedback.

As shown in the embodiment, block 2252 begins with initiation of feedback calculation 2254. In various embodiments, the feedback depends at least in part on the received input. In various embodiments, the feedback may or may not depend on prior feedback calculations. Subsequent to initiation, a determination is made as to whether the feedback corresponds to synchronous feedback 2255. Similar to the discussion above in relation to FIG. 22B, synchronous feedback may correspond to feedback based on a result of the input received from the user. If the feedback corresponds to synchronous feedback, and the feedback calculation is complete 2262, then the corresponding result may be stored 2260 and feedback provided (if provision of feedback is requested or otherwise required). Otherwise, if the calculation is not complete 2262, then the calculation may continue until completed.

If the feedback does not corresponds to synchronous feedback, then a determination may be made as to whether a result(s) is available. If so, then the result may be stored. In this manner, the operation of blocks 2258, 2260, and 2262 may generally correspond to that of blocks 2216, 2218, and 2220 in FIG. 22B.

In addition to the above, feedback of a bidding system is sometimes inadequate. Some examples of feedback include: Prices of the lowest bids on items, distances to lowest bids on items (i.e., the different between a current bid and a lowest bid), rankings of the items based on various criteria, allocation on the items, and so on. As an example, the following feedback provides a distance (difference) between a current bid and the lowest bid on the same item.

Standard feedback

| | | | Distance to lowest bid |
|---|---|---|---|
| Item | Country | Price | on the same item |
| A123 | Canada | $100 | 13% |

Such types of feedback are insufficient in many practical cases, where feedback has to be tailored to suit the current situation. For example, consider a number of items purchased globally (i.e. in many countries). Further assume that the buyer has concluded that the best feedback to a bidder would be to report, for each bid price, its distance to the lowest bid price of the bid's country, and that he would also like to report the bid price's distance to the average bid price of all the bidder's own bids of the bid's country. An example of such feedback might be as follows:

Possible Example of Desired Feedback

| | | | Distance to | Distance to | Distance to your |
|---|---|---|---|---|---|
| | | | lowest | lowest bid on | average bid on |
| | | | bid on the | any item in the | any item in the |
| Item | Country | Price | same item | same country | same country |
| A123 | Canada | $100 | 13% | 21% | 4% |

In prior art systems, a wish for the type of feedback discussed above requires new custom programming of the e-sourcing system. This is problematic not only from the perspective that this will take time and money to implement, but also that such specific functions often are useless for other cases, and hence introduce undesired complexity of the e-sourcing system.

However, utilizing the methods and mechanisms described herein, users of the system can generate desired data dynamically, without the need for custom programming to provide such data. For example, users can generate artificial bids for purposes of, for example, separating the way bids are input and how allocations are performed. For example, assume that bids and configured to cover several weight-bands. This can for example be one price for sending 0-100 kg, another price for sending 100-200 kg etc. Now we like to split those bids into one bid per weight-band in order to allow allocating different weight-bands to different bidders.

In another embodiment, values for one bid may be calculated from values of other bids. This can for example allow bidders to enter values for certain cost components as separate bids in contrast to repeating those components for all bids in which they are relevant. In other embodiments, a value for one bid may be calculated from values of other bids to create formulas which are useful for feedback. This can for example be to compute a bid's distance to the lowest bid from any other bidder in the same country.

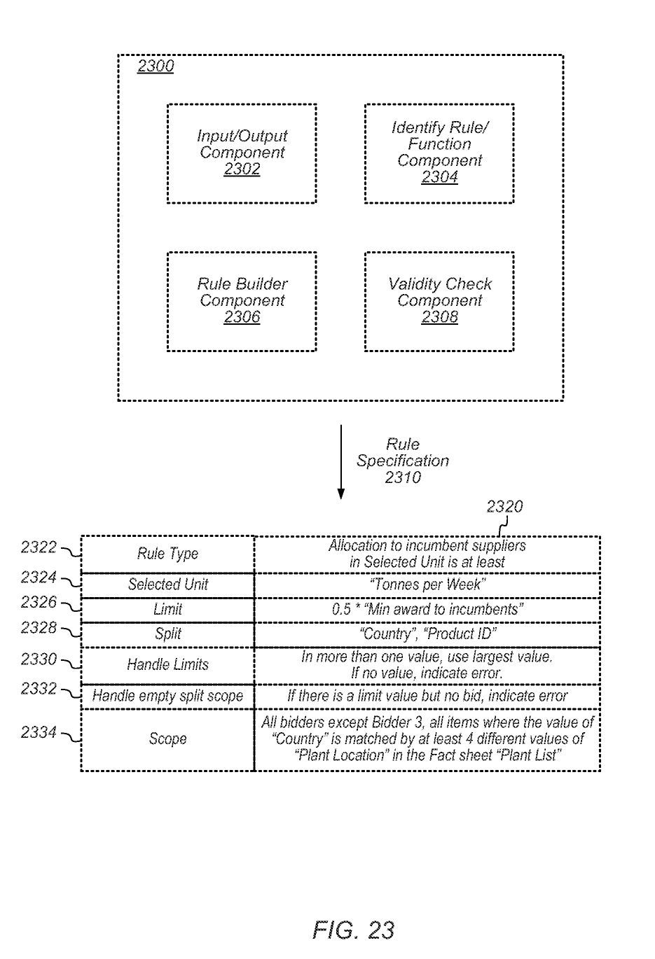

Turning now to FIG. 23, one embodiment of a rules/formula editor component (rules component) (for example corresponding to component 1960 of FIG. 19) is shown. In order for a user to define, edit, or modify a rule, the system is configured to support a range of options from minimal rule revision, such as setting a limit in a predefined rule, to allow combining numerous functions freely using all types of fields, properties and objects.

The specification of a user-defined rule can be created and edited using a rule editor such as that shown in FIG. 23. Once the user take action to save the specification, a request is sent to a web-server which may be managed by a back-end server as discussed above. A representation of the rule is then stored (e.g., by server cluster 1612 of FIG. 16) such that it can be retrieved and used as desired without having to recreate the rule.

As shown in the sample embodiment, the rules component 2300 includes an Input/Output component 2302, identification component 2304, rule builder component 2306, and validity check component 2308. The lower portion of FIG. 23 illustrates a rule specification that is created by the rule component 2300.

In the embodiment of FIG. 23, the user has selected a Rule Type 2322 from a selection of pre-defined and user-defined rule types. Such a selection could be made from a drop down list or otherwise as desired. The user has also selected an allocation unit 2324 based on a user-defined field. The rule's limit 2326 is a product of a numeric value and a selected user-defined field. Together, the Rule Type, Selected Unit, and Limit define the Quantifying Expression.

In addition, the user has also selected two user-defined fields as splits 2328, a specification for limits 2330, and a specification for how to handle splits that give empty scopes 2332. Finally, the user has used user-defined fields to define the rule's scope 2334. In this example, the scope relies on a bidder selection and a selection of countries, the second selection involves a property of a fact table. In various embodiments, a table similar to that of 2320 may be displayed as a rule is specified/built. In addition, the table may highlight certain fields where errors or problems are detected. Numerous such embodiments are possible and are contemplated. On completion of the specification of the rule, it may be accepted/confirmed by the user, given a particular name if desired, and saved for future reference.

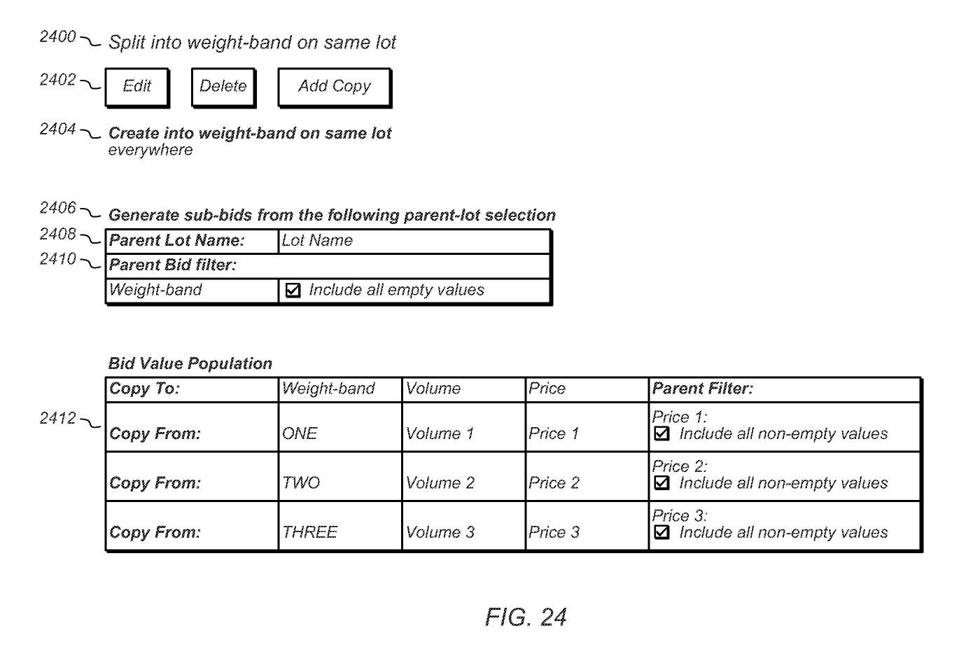

Turning to FIG. 24, one embodiment of an editor for creating artificial bids is shown. In the example, a configuration is shown to split a bid (a parent bid) into three artificial bids (or sub-bids), one for each weight-band. The rule can have a name 2400, and a button section 2402 for editing, deleting, or copying the rule. There can be a section 2404 for defining the scope of the rule, such a scope can be a filter and “everywhere” can implies that there is no particular filter. There can also be a section 2406 for defining which bids are parent bids. There can be a reference 2408 to one or more fields containing one or more names of parent lots. There can also be a filter 2410 limiting the scope of potential parent bids. There can be one or more copy-from and copy-to parts 2412. As seen in the figure, “Split into weight band” is specified “For every original bid.” Sub-bids are to be created for the lots “Everywhere”. The lower portion of the FIG. 2412 identifies three sub-bids to be created. A first sub-bid corresponding to weight band “ONE”, a second corresponding to weight band “TWO”, and a third corresponding to weight band “THREE”. The sub-bids are to correspond to both the “Volume” and “Price” for the corresponding weight band. Utilizing this rule, new sub-bids may be generated such as follows:

TABLE Sub-Bids 1

| Lot | Bidder | Weight Band | Price |
|---|---|---|---|
| Lot 1 | Bidder 1 | 1 | 50 |
| Lot 1 | Bidder 1 | 2 | 54 |
| Lot 1 | Bidder 1 | 3 | 57 |
| Lot 1 | Bidder 2 | 1 | 49 |
| Lot 1 | Bidder 2 | 2 | 52 |
| . | . | . | . |
| . | . | . | . |
| . | . | . | . |
| Lot N | Bidder N | 3 | 51 |

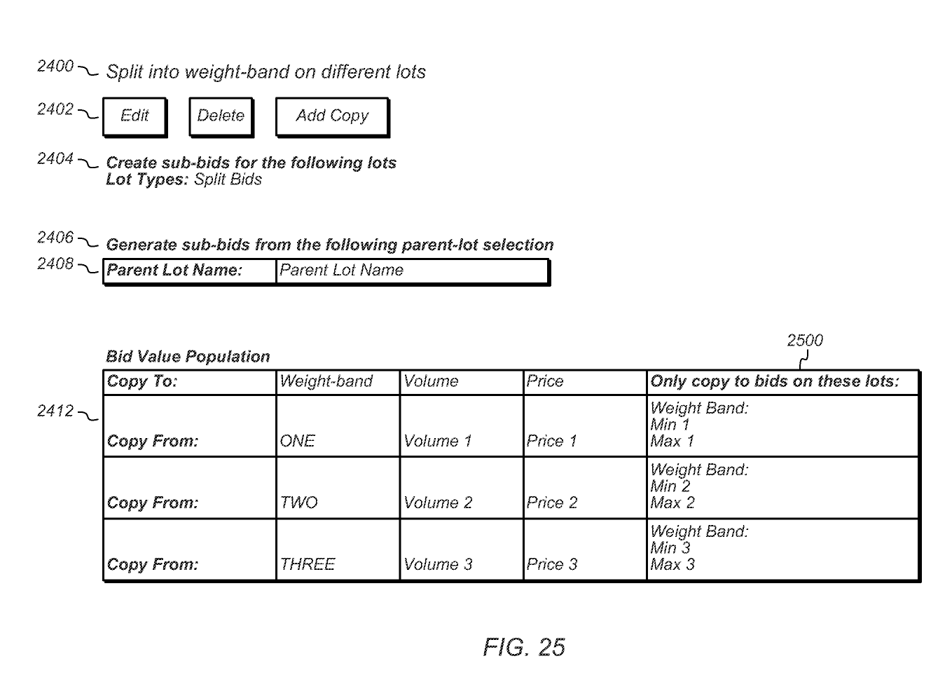

FIG. 25 illustrates configuration similar to the one in FIG. 24. However, in this example artificial bids for the different weight-bands are distributed to different items based on properties of the items. This is obtained by using separate filters 2500 for where sub-bids are create for the different copy-from parts. Utilizing this approach, sub-bids similar to the following may be created.

TABLE Sub-Bids 2

| Lot | Bidder | Weight Band | Price |
|---|---|---|---|
| Lot 1:1 | Bidder 01 | 1 | 49 |
| Lot 1:1 | Bidder 21 | 1 | 52 |
| Lot 1:1 | Bidder 27 | 1 | 50 |
| Lot 1:2 | Bidder 01 | 2 | 54 |
| Lot 1:2 | Bidder 21 | 2 | 57 |
| Lot 1:2 | Bidder 27 | 2 | 49 |
| Lot 1:3 | Bidder 01 | 3 | 52 |
| Lot 1:3 | Bidder 21 | 3 | 50 |
| Lot 1:3 | Bidder 27 | 3 | 54 |
| Lot 2:1 | Bidder 01 | 1 | 57 |
| Lot 2:1 | Bidder 21 | 1 | 49 |
| Lot 2:1 | Bidder 27 | 1 | 52 |

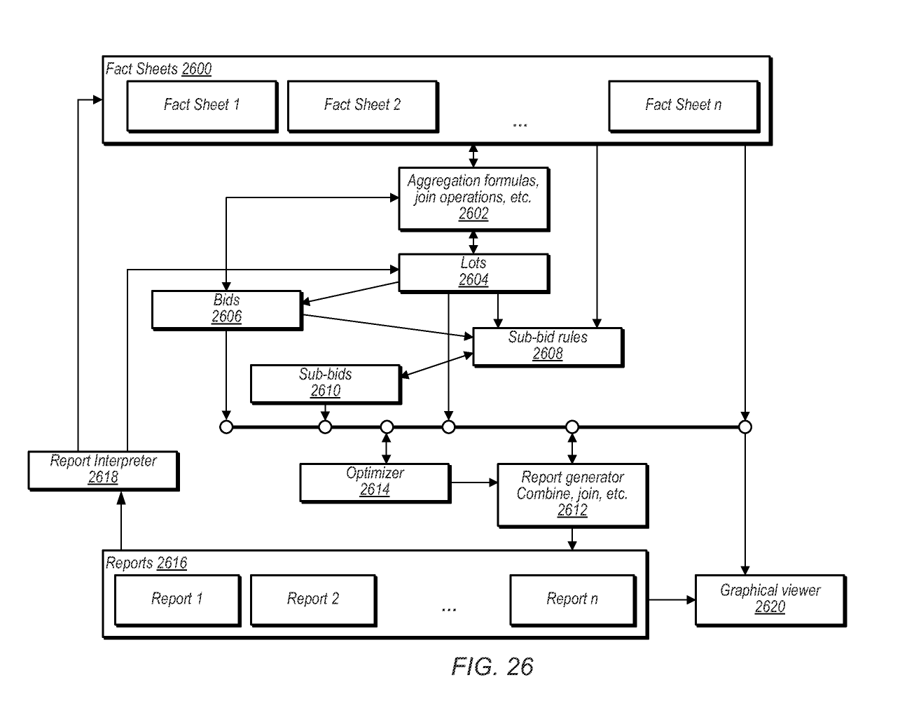

FIG. 26 illustrates how data can be transmitted between components in a tender defined on an embodiment of a customizable e-sourcing system. A set of user-defined fact sheets 2600 obtaining necessary background data are uploaded. The fact sheet data is then accessed by the Report Generator 2612 producing a Report 2616. The Report is then used to create Lots 2604 via a Report Interpreter 2618. Formulas 2602 are used to populate formula fields from fact sheets, such fields can exist both in fact sheets and in the lots. In association with the lot definitions, there can be a definition of bid fields used to collect bids 2606. The lot definitions and the bid fields are used by a Form Creator (not shown) to create bid forms, and bid forms returned from bidders are interpreted by a Form Interpreter (not shown) to collect bids 2606. Sub-bids 2610 are created from sub-bid rules 2608, based on data from lots, bids, and fact sheets. Created sub-bids are stored separate from the submitted bids, and different set s of sub-bids can exist simultaneously and be used differently in different scenarios. An optimizer 2614 is used to calculate allocations, the optimizer can access data from lots, bids, fact sheets, bidders, reports, and more. Similarly, the report generator 2612 utilizes necessary data. Output from a report generator can again be read by a Report Interpreter to create new fact data or new lots.

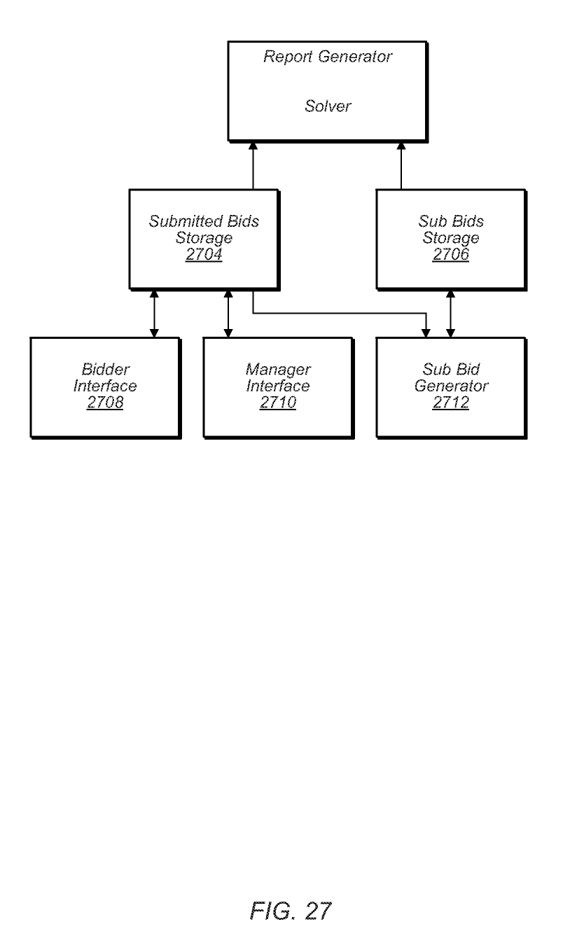

FIG. 27 illustrates an embodiment where sub-bids (or artificial bids) are stored separated from submitted bids. The sub-bid generator 2712 can access information about both submitted bids 2704 and sub-bids 2706, but can only write to the sub-bids storage 2706 (in some embodiments). The storage of bids and sub-bids respectively can be as different tables, as different types of databases, or in the same table but marked and where the sub-bid generator is configured to not write or modify the set of submitted bids. The embodiment is also configured in such a way that the bidders and managers can only interact directly with the submitted bids via Bidder Interface 2708 and Manager Interface 2710, while the sub-bids can be accessed indirectly as output from a solver or a report generator (not shown). Operations on bids and sub-bids can be asynchronous and there can be a first processor receiving new submitted bids at the same time as a second processor is creating sub-bids, the sub-bids can then be created based on the content in the Submitted Bids Storage 2704 at a specific point in time. In order to ensure that the data associated with the created sub-bids is consistent, the sub-bid generator can be initiated by first reading a set of Bid IDs. Whenever bid data is required from the database, the sub-bid generator can ensure that data for other Bid IDs, such as for bids added asynchronously, is ignored. The sub-bid generator can also have a mechanism for managing the case when bids are deleted during sub-bid generation. Such a mechanism can be to abort the sub-bid generation or to mark the bids used as parent bids to be kept temporarily. Furthermore, when sub-bids are later used during an optimization or report generation, there can be a consistency check that gives an error message if parent bids have been deleted.

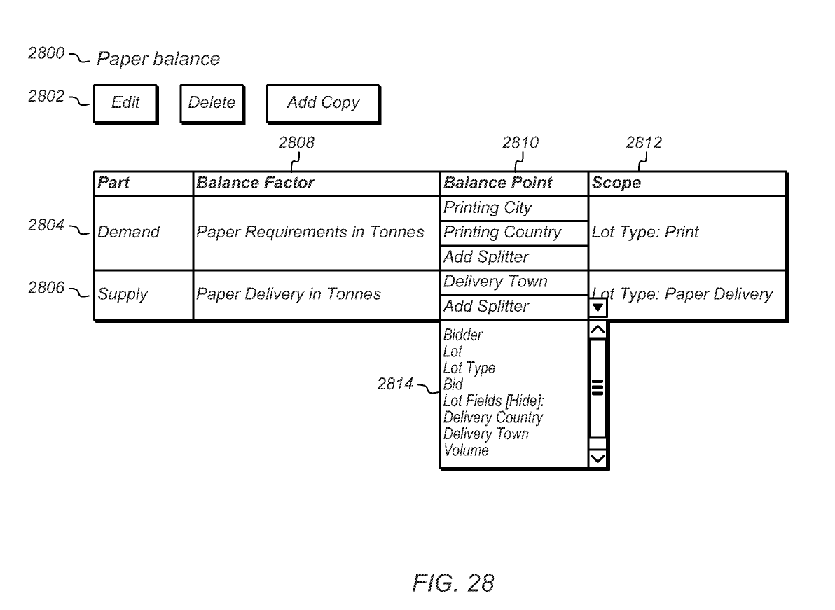

FIG. 28 shows a sample specification of a balance rule in a supply chain. The figure also indicates the structure of a potential rule editor. A rule can have a user-entered name 2800, and a set of action buttons 2802. The rule can have one or more Demand parts 2804 and Supply Parts 2806. A Part can have a Balance Factor 2808, this factor can be a selected field. A Part can also have one or more Balance Points 2810. Each Balance Point can be a selected field, and the editor can be configured to add more Balance points. The selection of a field can be a drop-down menu 2814. A Part can also have a Scope (or filter). There can be buttons (not shown) for operations such as deleting or adding Parts or Balance Points.

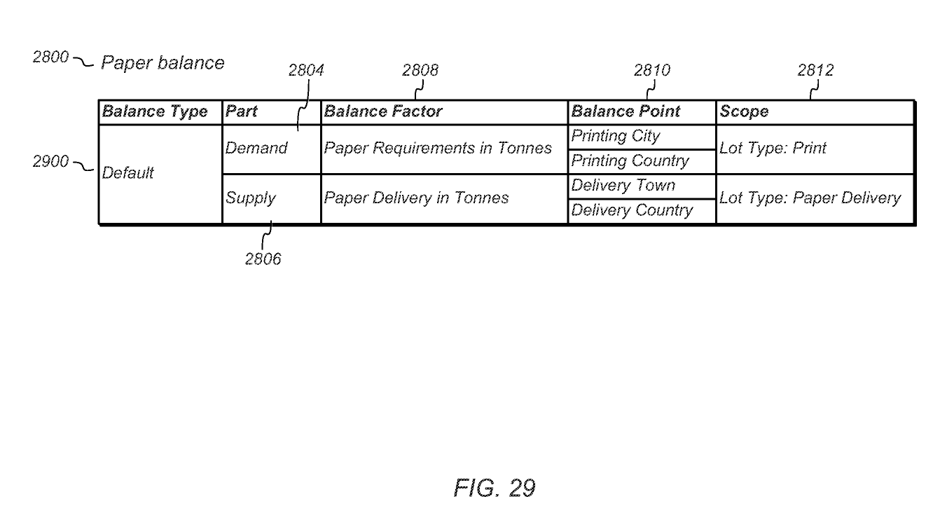

FIG. 29 shows a sample balance rule specification after being edited. Items in a drawing that are the same may be similarly numbered in other drawings. For example, items in FIG. 29 that are the same as those depicted in FIG. 28 are similarly numbered. Apart from the parts shown in FIG. 28, this embodiment also show a Balance Type 2900.

The model builder can use the balance rule shown in FIG. 29 to construct the model by creating constraints such as:

12x_{—}1+12x_{—}2+12x_{—}3−4x_{—}4−3x_{—}5>=0

The constraint ensure that at least the required amount of paper is supplied at a certain location. Variables x_{—}1 to x_{—}5 represents the allocation of specific bids. Variables x_{—}1, x_{—}2, and x_{—}3 represent bids in the supply, i.e. “Paper Delivery” bids, and variables x_{—}4 and x_{—}5 represents bids in the demand, i.e. “Print” bids. The coefficient 12 for x_{—}1, x_{—}2, and x_{—}3 stems from the values of field “Paper Delivery in Tonnes”. Accordingly, coefficients 4 and 3 for x_{—}4 and x_{—}5 stems from the values of field “Paper Requirement in Tonnes”.

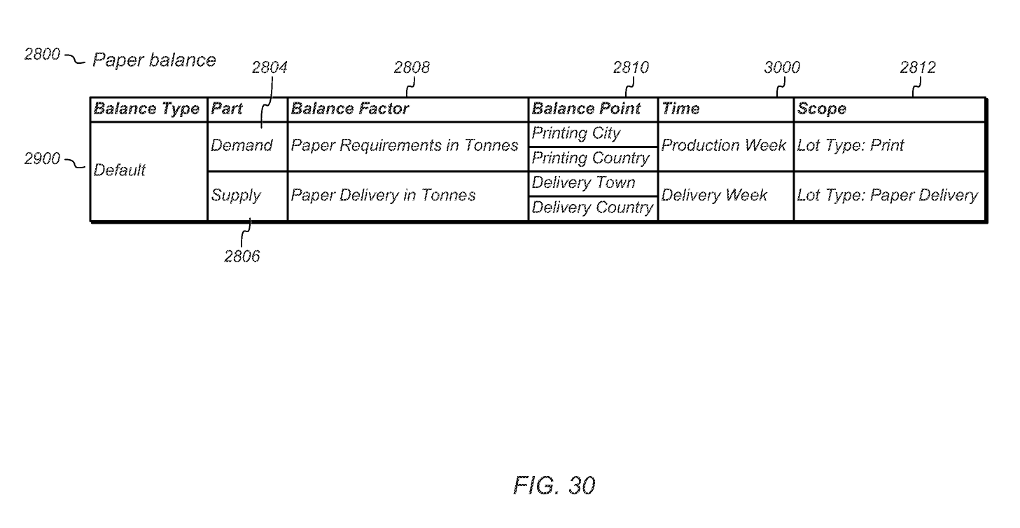

FIG. 30 illustrates a balance rule where an ordering is taken into account. In column “Time” 3000, the user has specified that in order for a “Supply” bid 2806 to be allocated, the bid's value of field “Delivery week” must be the same (or less than) the value of the field “Production week” for a matching bid in “demand” 2804.

One interpretation of a time field is that delivery of supply must precede the corresponding usage in demand. The notion of ordering and time can further form the basis for modelling costs stemming from differences in time, for example to apply a warehouse cost when delivery is earlier than usage.

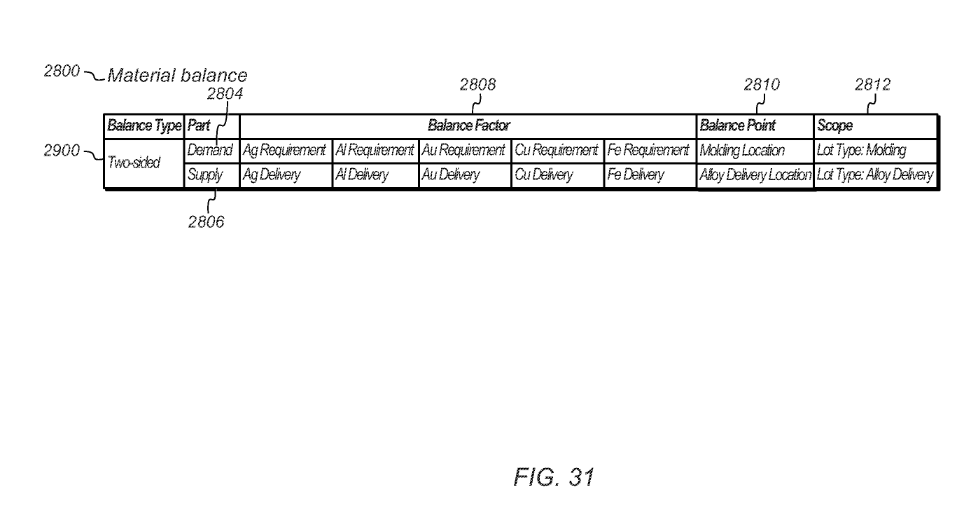

In FIG. 31, the usage of several quantifying expressions is illustrated. In this example, certain alloys are molded at different locations, using a supply of alloys. Then the rule can contain several Balance Factors 2808 and the model builder will typically produce one equation per quantifying expression. That is, for the example in FIG. 31, there will be one equation (per location) for each of Ag, Al, Au, Cu, and Fe.

For example, assume that at a certain location there is a bid, B1, for producing an alloy consisting of 200 kg Cu and 300 kg Fe. Further assume that there are two supply bids, one, B2, offering delivery of an alloy consisting of 500 kg Cu and 100 kg Fe, and another, B3, offering delivery of an alloy consisting of 50 kg Cu and 1,000 kg Fe. In one embodiment, these three bids contributes as follows to the equations of Fe and Cu (and do not contribute to equations of other metals). The variables x_{—}1, x_{—}2, and x_{—}3 denotes the allocation (from zero to one) of bids B1, B2, and B3 respectively.

200x_{—}1+500x_{—}2+50x_{—}3 . . . =0(Cu)

300x_{—}1+100x_{—}2+1000x_{—}3 . . . =0(Fe)

For the case that there are no other bids, than these three, fully allocating x_{—}1 hence means allocating x_{—}2 0.3737 and allocating x_{—}3 0.2626.

As discussed above in relation to FIG. 14, it may be preferable to have custom designed bid forms that are different for different categories, or even for individual suppliers. In various embodiments, spreadsheets and/or other types of documents can be tagged or marked with special commands to become readable by a sourcing system. Such tags can be placed in hidden sections of the form or be placed in a separate document used together with the bid form when parsing the received information.

Artificial bids, residing in memory or stored elsewhere, may have minimal data associated with it for efficiency or other reasons. For example, only a reference to the original bid may be associated with the bid, in contrast to storing all values of the original bid for the artificial bid as well.

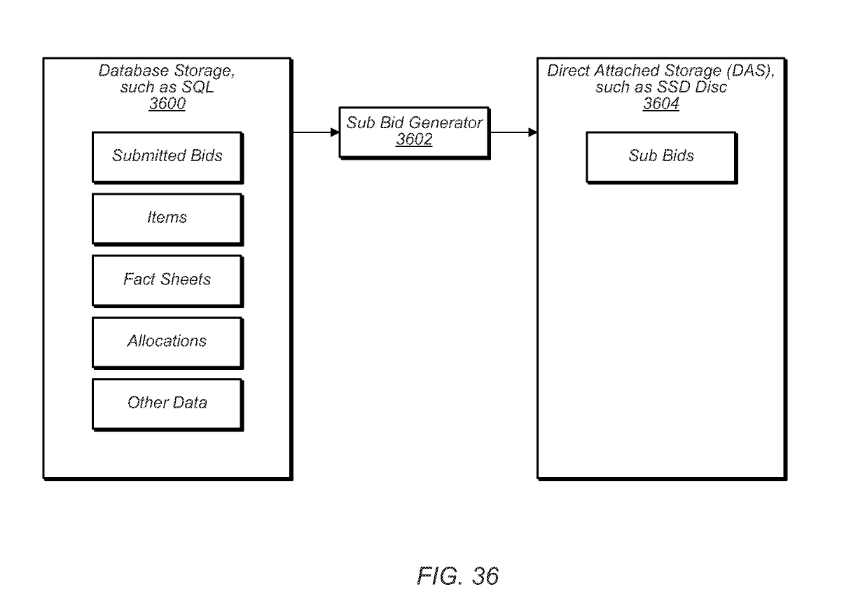

Artificial bids may be managed differently from standard bids. For example, they may be stored in a database with a different architecture, exemplified in FIG. 36. This can be for efficiency or other reasons. It can be that artificial bids are created every time a scenario is solved or a report being generated. That could lead to too long time for database inserts if stored in a database optimized for submitted bids. Formula evaluation can also be performed and triggered differently. For example, in various embodiments fields of submitted bids are reevaluated each time a field is changed, but fields of artificial bids are only evaluated when solving a scenario or generating a report.

As discussed above, it may sometimes be desirable to create artificial bids (“sub-bids”). Creating artificial bids (“sub-bids”) may be considered a special case of creating objects. Generally speaking, a sub-bid rule contains a description (or specification) of how to create new bids or allocation variables, for example, by duplicating, splitting, or combining objects (e.g., bids or other objects). The description may refer to objects from which to copy values or reference data by filtering or listings of references in predefined or manager defined fields. The copying can be from any types of objects, such as bids, lots, or fact tables. In various embodiments, when sub-bids are created, user-defined formulas can be calculated for those bids. Such sub-bid creation can be applied in different ways in different scenarios. In various embodiments, sub-bids can be cached and retrieved later. For example, a sub-bid can be generated in one scenario and used by another scenario.

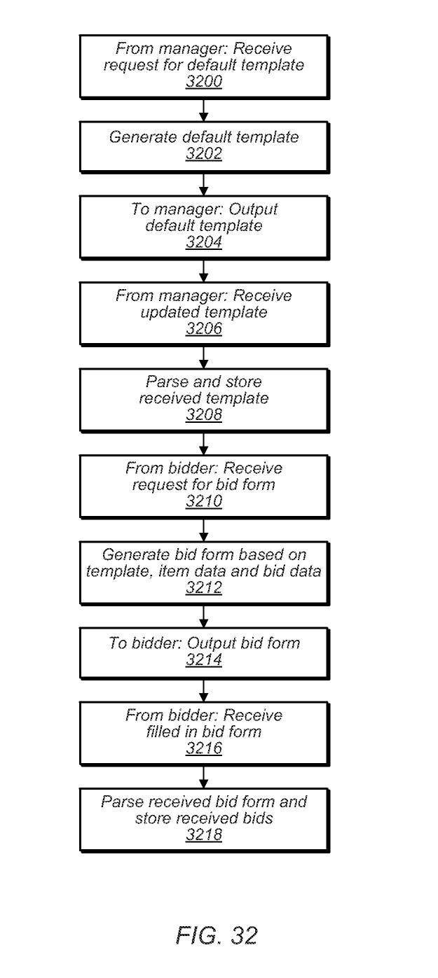

FIG. 32 illustrates an embodiment method for using a Form Template. First, the system receives a request for a default template 3200, and the Form Generator generates the template in step 3202 and outputs to the manager in step 3204. The manager then use the default template as a basis for a designed template by re-using tags and other markings from the default template. In step 3206 the system receives an updated template from the manager, this template is parsed and stored in a database 3208. Before storing in a database, there can be error detections and error correction interaction with the manager (not shown). In step 3210, the system receives a request for a bid form. In step 3212, the Form Generator retrieves the form template, and reads item data from a database in order to populate the form according to its markup. The form Generator can also read bid data that can be used to populate the form with the bidder's previously submitted bids, and with calculated feedback. The generated for is output in step 3214, processed by the bidders, and uploaded in step 3216. Finally, in step 3218, the bid form is parsed, and new or updated bids are stored in a database. Before storing in a database, there can be error detections and error correction interaction with the bidder (not shown).

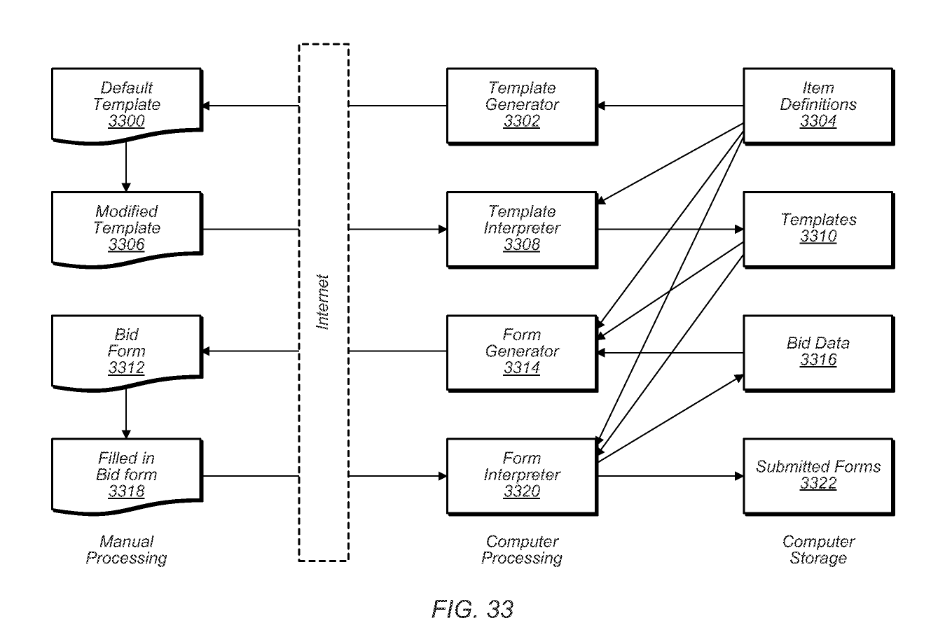

FIG. 33 illustrates an embodiment for bid form handling with computes storages, computer processing, and manual processing. A Template Generator (or Form Generator) 3302 generates a Default Template 3300. The Template Generator uses Item Definitions 3304, these items definitions also contains definitions of appropriate fields, such a Bid Fields. The Default Template is used to create a Designed Template 3306 which is provided to a Template Interpreter 3308. The Template Interpreter verifies the template against item definitions and stores the template, or a representation of the template, in a template storage 3310. The Template Interpreter can also be omitted, and the template can be stored directly and parsed later. When a bidder requests a bid form, a bid Form Generator 3314 retrieves data such as Item Definitions 3304, Templates 3310, bid Data 3316. The form Generator generates a Bid Form 3312. The bid Form is filled in ore modified by the bidder who is adding, deleting, or modifying bids, and the modified bid Form 3318 is submitted and received by a Form Interpreter 3320. The Form Interpreter retrieves data such as Item Definitions 3304, and Templates 3310, verifies the Template and the submitted bids, and stores submitted bid Data 3316 and the Submitted Form 3322. The Form Interpreter can also be associated with an Assert component (not shown) that retrieves other types of data, such as Bid Data, and verifies the bids.

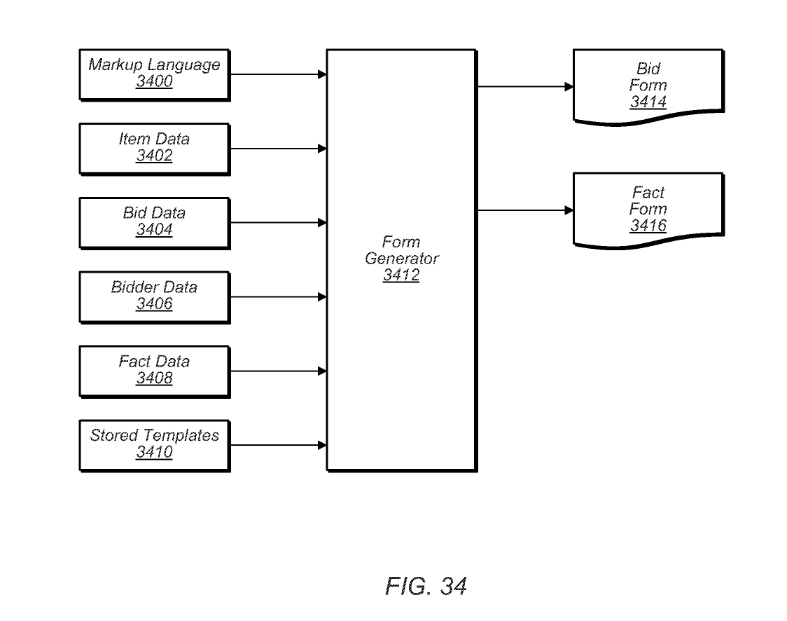

FIG. 34 illustrates an embodiment of a Form Generator that can generate a plurality of forms of different types. The Form Generator uses a Markup Language 3400, and based on a Stored Template 3410, and data such as Item Data 3402, Bid Data 3404, Bidder Data 3406, Fact Data 3408, and other data not shown, the Form Generator 3412 generates forms for downloading or uploading bids 3414, Fact sheets 3416, or other types of objects.

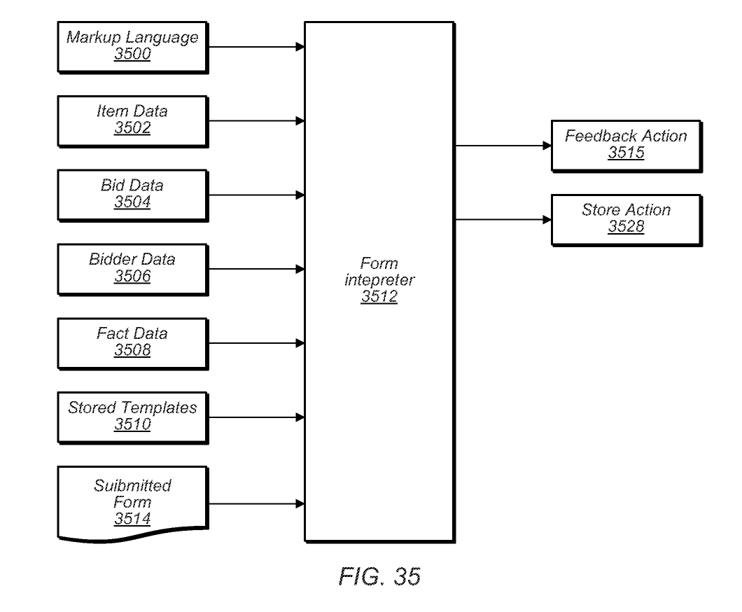

FIG. 35 illustrates an embodiment of a Form Interpreter that can interpret forms of one or more types, such as Bid Forms, Fact Forms, Item Forms, Bidder Forms, etc. The Form Interpreter uses a Markup Language 3500, and based on a Stored Template 3510, and data such as Item Data 3502, Bid Data 3504, Bidder Data 3506, Fact Data 3508, and other data not shown, the Form Interpreter 3512 interprets a received form 3514. Based on the results of the form interpretation, there can be a Feedback Action 3516 or a Store Action 3518, where the submitted data is stored in a database.

FIG. 36 illustrates an embodiment where sub-bids are stored in a different type of data base than other types of data. In this embodiment, an SQL server 3600 is used to store a number of data tables, including bids, a Sub-Bid Generator 3602 is used to generate sub-bids, and a Direct Access Storage 3604 (in one embodiment) is used to store the generated sub-bids (or artificial bids).

Data Cleaning:

In various embodiments there may be tools for doing different forms of data cleaning. For example, such cleaning may include detection and correction of spelling, versions of names, translations, non-standard characters, supplier dependent identifications, etc. One example of cleaning is rule-based data cleaning A rule-based data cleaning process can be an iterative process for cleaning a set of dirty tuples, usually acquired from a fact sheet uploaded to the system, using a set of data cleaning rules. In various embodiments, rules may take the form of either a transformation rule, a cleaning rule, or otherwise.

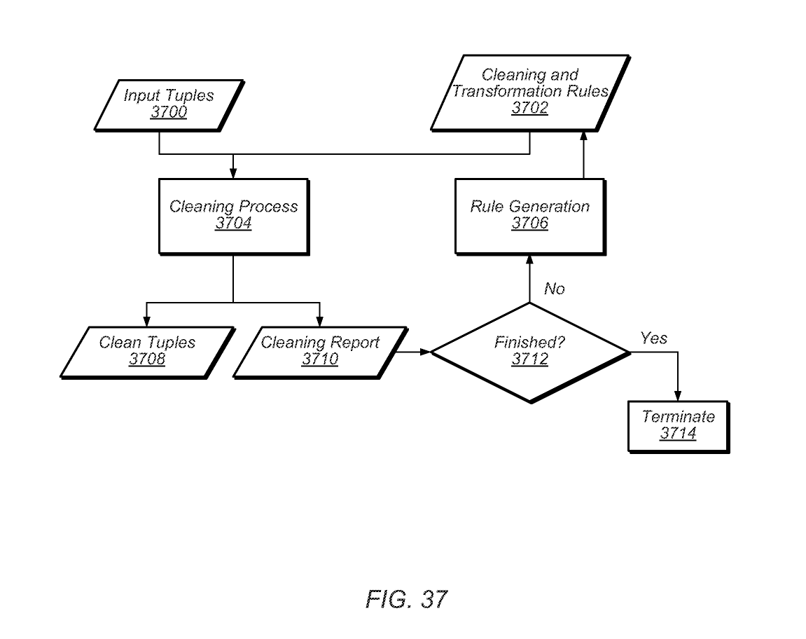

FIG. 37 illustrates an embodiment of data cleaning. The rule-based data cleaning process is the iterative process of cleaning a set of Input Tuples 3700, usually acquired from a fact sheet uploaded to the system. The cleaning can use a set of data cleaning rules 3702.

Data Cleaning Rules may take the form of either a transformation rule or a cleaning rule:

A transformation rule may define a mapping from substring of a value to a replacement. Commonly uses are abbreviation or synonyms. E.g. AWS--> Amazon Web Services.

A cleaning rule may define a mapping from parameter to parameter value, used to replace dirty data with clean data. E.g. Country--> Sweden.

Both transformation and cleaning rules may have a scope (see formulas) and a priority which defines the subset of the tuples the rule should be applied to and the order that the rules should be executed in.

Rules may be loaded from a project local store, an external excel sheet, or from a master data store. The rules can be adapted, by the system with user interaction, to fit with the input tuples in the case of a mismatching parameter name or other issue.

Given all inputs the rule-based data cleaning process defines the fix-point process of cleaning 3704, inspection of a report 3710, rule generation 3706, back to cleaning 3704, etc., that terminates once all data is clean, no more rules can be generated (the data can be cleaned no further), or some other termination criterion, 3712 and 3714.

A transformation rule may define a mapping from a substring of a value to a replacement. Commonly uses are abbreviation or synonyms, e.g. AWS translates to Amazon Web Services.

A cleaning rule may define a mapping from parameter to parameter value, used to replace input data with clean data, e.g. Country translates to Sweden.

Both transformation and cleaning rules may have a scope and a priority which defines the subset of the tuples the rule should be applied to and the order in which the rules should be executed.

Rules may be loaded from a project local storage, an external document such as a spread sheet, from a master data store, or otherwise. The rules can be adapted, by the system with user interaction, to fit with the input tuples in the case of a mismatching field names or other issues.

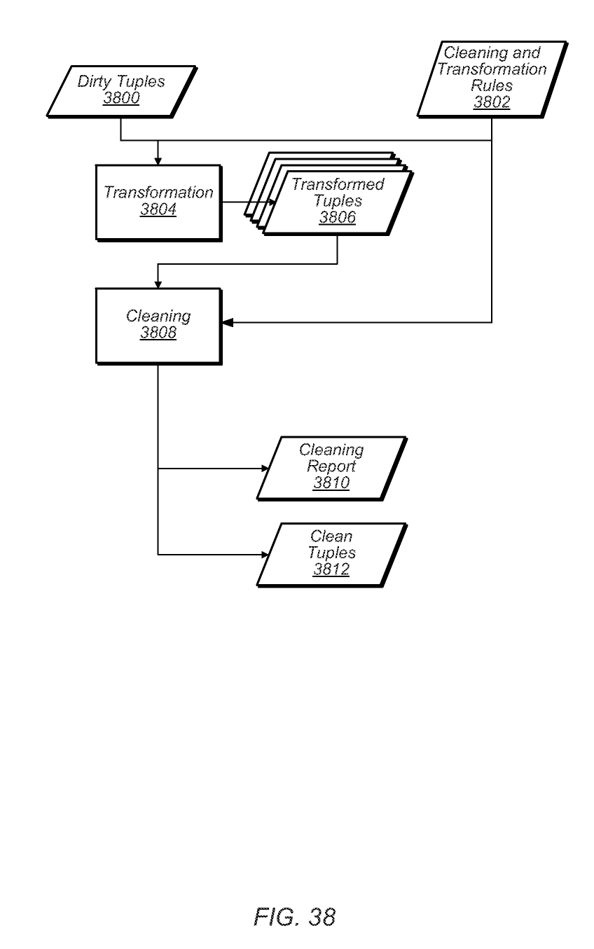

FIG. 38 illustrates one embodiment of a cleaning process. In the example shown, the data cleaning process can take a set of Input Tuples (or Dirty Tuples) 3800 and for each tuple perform the following steps:

(i) Collect each transformation rule 3802 that may be applied to this tuple.
(ii) For each combination of transformation rules transform the original tuple(s) 3804 to create a new (transformed) tuple 3806 and attempt to match it against cleaning rules 3808.
(iii) Keep the new tuple with the most cleaning rules applied to it.

The cleaning process may store the cleaned tuples 3812 and for each tuple generate at least the following in a cleaning report 3810:

The original tuple.
The transformation rules applied.
The cleaning rules applied.
The cleaned tuple.

If no cleaning rules could be applied to an input tuple, information about this may be stored in the cleaning report.

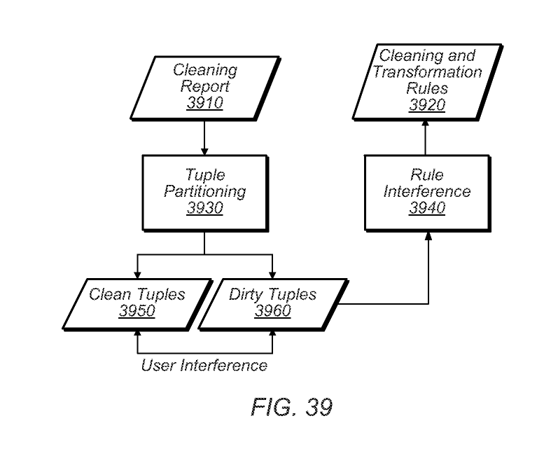

FIG. 39 illustrates a method for generating cleaning rules. Given a cleaning report 3910, a rule generator will inspect all tuples and partition them into sets of clean and dirty tuples by checking the following criteria:

(i) Each value in the tuple matches a cleaning rule's clean value.
(ii) Each value in the tuple matches the value of a clean tuple (as denoted by a user or the system).

If none of the specified criteria apply then the tuple is classified as dirty. After automatic classification of the tuples the user may browse each set using the process specified under “Data Visualization” and rectify each classification. This process may be applied recursively as new clean data, through user rectification, is made available to the partitioner.

Rule inference 3940 can be done as follows: After classification has reached a fix-point the remaining dirty tuples can be sub-divided into a suggested rule hierarchy with suggested data corrections. These correction can be based on each tuple's proximity to clean tuples. The user can then either approve, reject, or rectify the system suggested cleaning rules.

The final set of transformation and cleaning rules may be stored locally or in the master data for use in the next iteration of the data cleaning process 3920.

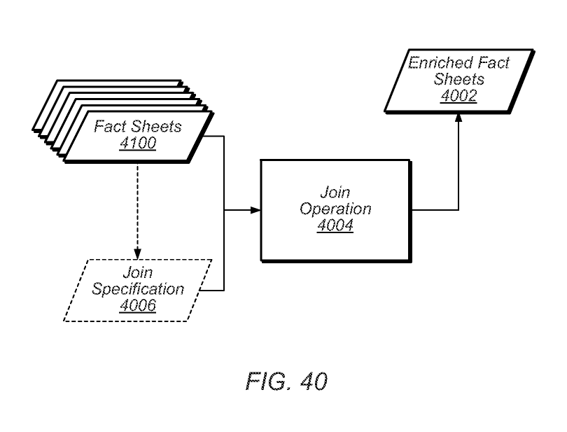

In various embodiment, the system includes data enrichment process to generate data as shown in FIG. 40. The data enrichment process takes a set of fact sheets 4000 and a join specification 4006 and performs a join operation 4004 on the specified fact sheets, resulting in a new Enriched Fact Sheet 4002. The Enriched Fact Sheet can be a new sheet, replace one of the input sheets, or some other type of table or document such as a report.

A join specification 4006 may contain the following details: (i) Join Type: Inner/Outer/Left Outer/etc., and (ii) Join Condition: can be similar to an Assert Formula.

There can be a simplified join operation without the need for a join specification. In this case, the system can attempt to construct the specification automatically based on for example sheet names, field names, and sheet contents c.f. so-called Natural Join.

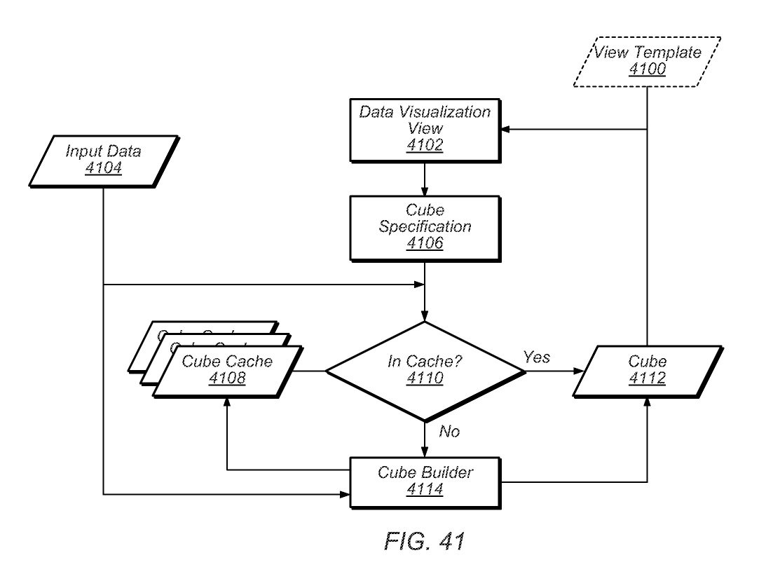

FIG. 41 illustrates an embodiment of an interactive data viewer, that can be used as a graphical viewer of reports, fact sheets, or other tables. The data viewer can display data as one or more tables, one or more charts, and combinations of charts and tables. The data visualization is the process of displaying data using different views produced by a viewer. The following views, among others, may be supported: (i) interactive aggregated table view, (ii) interactive chart view (iii) raw table view. Each view may contain the following features: (i) dynamic roll-up dimensions, (ii) filtering of what values in a specific dimension are visible, (iii) Showing and hiding of specific dimensions, (iv) joining with other sets of data, (v) performing actions on the data, such as for data cleaning purposes marking tuple(s) as clean or dirty. A view may be interactively changed into a different view without the loss of any feature states. A view may be bootstrapped using templates that can be stored either in the project or in a master data store. A view may generate a cube specification that may contain what dimensions, facts, filters, joins, and aggregates are necessary to maintain the view. A view may build a cube based on the cube specification. A cube may contain pre-calculated aggregates for facts over the dimensions. Once built a cube may be cached by the platform for future once in order to avoid having to re-calculate the same cube multiple times. When building a cube, more than the exact cube required may be built in order to predict future cubes needed.

Returning to FIG. 41, associated with the viewer, or with the data set, there can be a View Template 4100 initiating the cube settings. There can be a possibility for a user to store the current view as such a setting in order to start the next viewing session with the current view. The view settings define an initial Data Visualisation View 4102. If there are no view settings, the initial Data Visualization View is set as a default view. From the Data visualization View, a Cube Specification 4106 is derived. From the Cube Specification and Input Data 4104, a Cube Builder 4114 creates a Cube 4112. There can be a Cube Cache 4108 storing one or more cached cubes, avoiding cube building whenever possible by a test 4110.

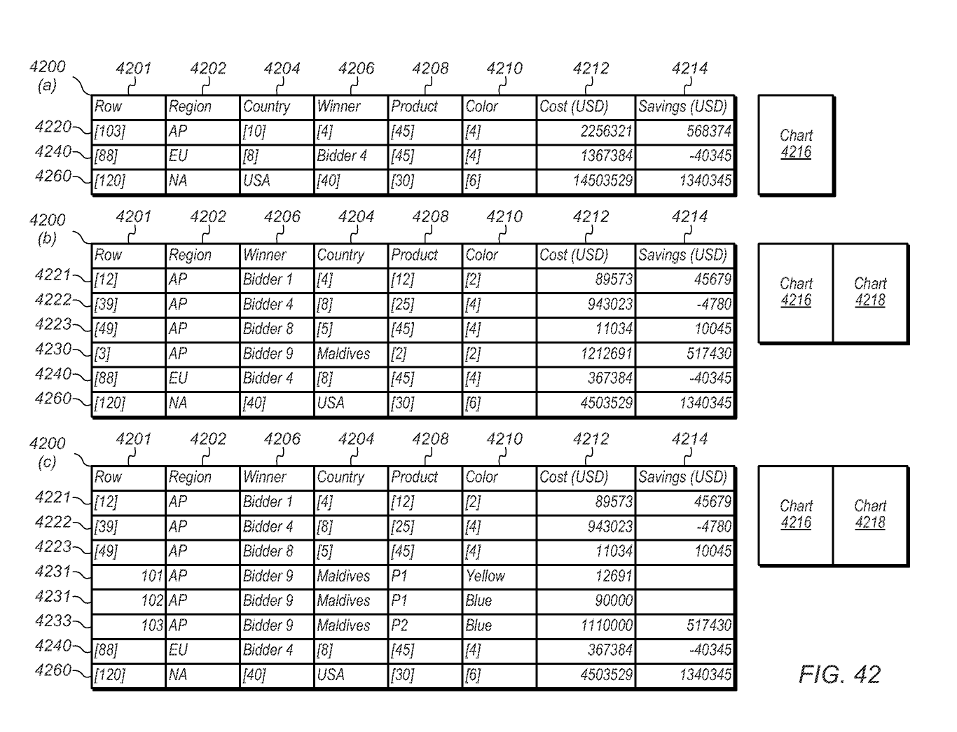

FIG. 42 illustrates an embodiment of a viewer as seen by the user. In this example, the viewer displays a table 4200 having columns 4201-4214. In this embodiment, there is no distinction between facts and dimensions. Instead, the user can chose to expand parts of the table, and each non-expanded part is shown as an aggregated value. The principle of not distinguishing between facts and dimensions can be used in various embodiments of a viewer as well as a report generator. In other embodiments, there is an explicit distinction between facts and dimensions. The aggregation can be mathematical operations such as max, min, sum, average, median, standard deviation, etc. Aggregation can also be operations such as “number of unique values”, or context-dependent such as “percentage allocated incumbent volume”. In this example, we have chosen two aggregation methods: each of the two columns “Cost (USD)” 4212 and “Savings (USD)” 4214 is aggregated as a sum, each other column is aggregated as a count of unique values within brackets, with the exception of single values that are shown in plain text. FIG. 42 is showing three stages (a), (b), (c), of table 4200 in an example viewing process, shown as 4200(a), 4200(b), and 4200(c). In Step (a), the user has expanded column “Region” 4202, resulting in three rows 4220, 4240, and 4260. All other columns are aggregated. The reason that the cell in column “Winner” and row “EU” does not contain a number within brackets is that there is only one unique value: “Bidder 4”. Next, the user choose to expand the table at one specific cell, namely the cell at column “Winner” 4206 and row 4220. The cell at this position displays the value “[4]” indicating that there are four winners. The result of expanding at the selected cell is shown in section (b). Here, row 4220 is expanded into four rows 4221, 4222, 4223, and 4230. Furthermore, column 4206 is moved to the first position to the right of the rightmost expanded column. This re-ordering of columns can be varied, in another embodiment the effect would have been that the column orders are kept, and that either only column 4206 is expanded, or that the un-expanded column to the left of column 4206 is expanded either completely or partially. In this example, the leftmost column, showing the number of rows, is “frozen” to be the leftmost column, expanded or not. In the described example, the user activated the column expansion with an option to keep the previous graph 4216, and adding a new graph 4218 representing the four newly expanded rows.

In section (c) of FIG. 42 (4200(c)), the user has further expanded at column “Row” 4201 and country “Maldives”, corresponding to row 4230. As a result, row 4230 is expanded into rows 4231, 4232, and 4233. In this example, the chart 4218 is updated while Chart 4216 remains unchanged. As can be seen in Column “Savings” 4214, there can be empty values.

We will now discuss an example. Consider an organization that is optimizing a large multi-stage, partly outsourced, production chain. The chain consists of an number of raw materials, conversion, packaging, and transportation between the different steps of the chain. The organization wishes to take a holistic view on the entire chain and run it as a multi-category e-sourcing tender, comprising the following steps:

(a) collect base information about the suppliers, plants etc. The collection is to be done with customized forms, based on for example graphical layout of the company. The data collection should also include various complex data-checks, including that some follow-up questions become mandatory as a consequence of responses to other questions. Different suppliers should have access to different information, and use different forms. For example, raw material suppliers should only have access to conversion forms for the case that they also can perform conversion.

(a.1) collect information from raw material suppliers about their production sites
(a.2) collect information from converters about their production sites
(a.3) collect information from packaging suppliers about their production sites
(a.4) collect, from all potential suppliers, information about ISO-certification, environmental policy, etc.
(b.1) collect, from internal system A, historic transactions and volumes for each raw material, conversion, transportation, and packaging item.
(b.2) collect, from internal system B, weekly forecast for each final product.
(b.3) collect, from internal system C, for each final product and raw material, how much of the raw material is needed per final item.
(b.4) collect, from external source C, information on taxation and custom fees per raw material and product type.
(b.5) collect, form internal system D, standard currency exchange rates to be used in cost calculations.
(b.6) collect, from internal system E, information on already contracted volumes
(b.7) collect, from internal system F, information about internal production sites
(b.8) collect, form internal system G, for each internal production site and raw material, the weekly capacity and cost of production.
(b.9) collect, form internal system H, for each internal production site and raw material, the weekly capacity and cost of conversion.
(b.10) collect, form internal system I, for each internal production site and raw material, the weekly capacity and cost of packaging.
(b.11) collect, from internal system J, information about current transport costs, and define how to estimate transport costs when prices are not available.
(b.12) collect, form external source K, geographical information based on postal codes, cities, regions, countries.
(b.13) collect, from local stakeholders, information per raw material and supplier, if there is a qualification cost for that supplier.
(b.14) collect, from local stakeholders, information per finished good and conversion supplier, if there is a qualification cost for that supplier. A qualification cost implies a one-time cost that applies when the supplier is allocated regardless of allocated volume. Qualification also requires utilization of an internal qualification resource. Different qualifications requires different amount of time of usage of internal qualification personnel.
(b.15) calculate, from the tables (b.2) and (b.3) total requirement for each raw material.
(c) collect price and related information from suppliers. Even though allocation is made by week, the suppliers should not have to enter prices based on weeks. The bid collection is to be done with customized forms, based on for example graphical layout of the company. The data collection should also include various complex data-checks, including that some pricing elements become mandatory as a consequence of responses to other bid elements. Different suppliers should have access to different information, and use different forms.
(c.1) collect from raw material suppliers, for each of the supplier's plants, production cost (including start-up costs and discounts) and weekly capacity per raw material.
(c.2) collect from converter, for each of the converter's plants, conversion cost for each finished good (including start-up costs and discounts). Also, collect information about costs if the supplier uses its own source for raw material. Information about waste factor and start-up cost for different conversion equipment should also be collected.

(d.1) based on the plant locations, provided in the bids by raw material suppliers, converters, and packaging suppliers, derive a set of potential transportation routes (lanes) that may be needed: from raw material suppliers to all applicable converters, and from converters to all applicable packaging suppliers, and create transportation lots for these routes.

(e.1) collect, from transport providers, prices for full truck loads (FTL), and partial truck loads (LTL) on the lots created in (d.1). There is a wish to let each transportation provider (carrier) use a two-level bid input: First, the carrier declares a number of lane types, each lane type has prices for FTL and LTL weight bands. Second, the carrier can declare interest in a particular lane simply by stating which lane type the lane type belongs to.

(f.1) based on all collected data, including bids, define an optimization model that properly models the potential flows through the supply chain. Produce a report that shows, for each final good, who are the potential suppliers of raw material, conversion, and packaging.
(f.2) run a set of scenarios, including:
(f.2.1) Ignoring capacity constraints
(f.2.2) As-is: allocation to incumbents
(f.2.3) With capacity constraints
(f.2.4) Different capacity analysis scenarios. What if capacity in a selection of production sites can be increased by 10%? What if suppliers have overestimated their capacity by 10%?
(f.2.5) Favoring country incumbents, where a country incumbent is regarded as incumbent on item X delivered to country Y if he is incumbent on any item delivered to country Y.
(f.2.6) Different demand variation scenarios. What if demand increases/decreases by 5%?
(f.2.7) Changes in fuels costs, exchange rates, interest rates (or other external factors).
(f.2.8) Alternative cost models and/or alternative networks. For example, a scenario ignoring transport could give insights into what business is award on geographical merits rather than competitive merits.
(f.2.9) Alternative sourcing, for example assume that a certain raw material can be sourced at a certain location at some default cost even if there presently are no corresponding bids in the tender.
(f.2.10) Define various sorts of scenarios once first results are investigated.
(g.1) Produce reports showing bid information and allocation in the scenarios, including:
(g.1.1) For each product, a cost breakdown of conversion costs, raw material costs, transport costs, taxes etc.
(g.1.2) For each raw material and conversion plant and week, show plant utilization versus capacity.
(g.2) Define custom reports once first results are investigated.
(h.1) Define for each item and local stakeholder, which items are to be seen by that stakeholder.
(h.2) Let each stakeholder download their own version of a report from (g.1), add markings which allocations are not feasible, and upload the modified report as rows in a table, where this table is configured so that each local stakeholder can only see/download the rows he/she has added.
(h.3) Run new scenarios where the information from (h.2) is taken into account.
(h.4) Analyze impact and costs of the respective stakeholders request.

The organization previously used a traditional approach without an e-sourcing system.

In (a.1)-(a.4), the organization has previously used a set of manually designed spreadsheet documents with questions. These documents have bees manually collected from potential suppliers, and information has been compiled manually into a summary report. In order to make the RFI forms appealing and easy to understand, there has been a number of formulas, conditional formatting, and macros built into the forms. Furthermore, for some suppliers there have been separately designed forms; for example have a number of question been omitted for incumbent suppliers. Now, there is a wish to keep the same format but still be able to automatically load the received RFI replies into the tender database, in order to use it in calculations, reports, etc.

In (b.1)-(b.14), the required data has previously been compiled manually and stored in a spreadsheet. Now, there is a wish to have this data loaded into the tender database for direct user in calculations, reports, etc.

In (c.1) and (c.2), the organization has previously used manually designed spreadsheets, different per category and sometimes different for different sets of bidders. For example, a bidder that can only supply a subset of the items, has received a smaller bid form. For the purpose of continuity, there is a wish to have similar bid forms. There is also a wish to add feedback. The bidders should know their rank on each item. The bidders should also know if there is a currently favorite allocation, and which of their bids have been allocated.

In (d.1)-(d.3) the previous manual approach has not made it possible to consider all possible combinations of supply through the chain. Instead, only a few alternatives to the incumbent situation have been considered.

The data is collected through a manually designed spreadsheet. If at all supported, the two level input may be implemented using a set of spreadsheet macros.

In (f), the allocation of business based on collected bids and other data is determined by some rules of thumb, including some simplified management of discounts and start-up costs. Weekly schedules are not considered, rather feasibility is investigated at the peak week. Calculations are performed by summing the partial costs in spreadsheets and make some comparisons.

In contrast, the business objective and desire is to examining all feasible combinations, combined with business constraints and weekly capacities, taking all costs, discounts and start-up costs into consideration and to calculate optimal allocations. The managers cannot beforehand list all relevant business constraints and scenarios. Rather, the listed ones above are just examples and the evaluation must include the possibility to define scenarios and business constraints, also once results/reports have been produced. Hence, they need to be able to formulate rules themselves in a rule editor.

The buying team produces reports (g) in spreadsheets by copy/pasting/importing data from other spreadsheets. The refresh process of reports, for example in response to new bids, typically involves several steps and a significant amount of manual work. In contrast, there is a wish to run custom reports defined on the fly and where the refresh process is a one button click.

Step (h) is essentially unsupported in a manual process. Local stakeholders interests are either taken into account in a limited manner, or some requests are taken into account as some type of rule of thumb in step (f). In contrast, the desired process of informing local stakeholder of award suggestions which have pivotal impact on their business (h.1-h.2), allow the stakeholders to give preferences in a structured manner (h.2), run new evaluations based on these preferences (h.3), and then make the costs and consequences of such preferences visible. It is also important that each stakeholder can access the input given by himself but not by others.

We will now exemplify how the request above would be managed by typical existing prior-art technique of transferring a manual process into a computerized process by adding customized components to an existing e-sourcing system.

For step (a), a set of engineers are given specifications of how the RFI forms are to be designed. The specifics of the forms and their connection to the sourcing system are implemented.

Steps (b.1)-(b.14) would be handled by creating a set of named database tables, each table having named columns. For each table, an import module would be developed, adopting to the format of the input data, parsing the input data according got the specified format.

The table (b.15) would be created by a programmed aggregation of data from (b.2) and (b.3).

Next, programming of item creation is done to enable performing Steps (c.1) and (c.2). For this purpose, a module is created that extracts information from internal systems A, B, and C, and table (b.15). Created item information are stored in a database table. For the data collection in step (c), the specifics of the forms and their connection to the sourcing system are implemented.

In Step (d.1), a set of transportation lots/items has to be created by programming the combining data from other items.

In (e.1), the two level bidding could be managed by collecting the bids in their simple format and then programming the copying of data between bids, either using macros in the spreadsheet or by some database manipulations.

In Step (f.1) there is a need to create a set of potential combinations of bids for raw material, conversion, and packaging, and use these bids to simulate potential paths through a supply chain, with added costs for transportation, tax, customs, etc., and create bids for the different weeks. The set of potential combinations can be derived from internal tables A, B, C, and (b.15) together with all bids on raw material, conversion, packaging, and transportation. The optimization model would also have to include cost components for customs and tax plus transportation cost taken from (b.11) and qualification costs taken from (b.14). A developer would be given the task of creating a module that builds a data structure defining all potential paths though the supply chain, including variables representing potential allocations along these paths. Some bids, such as raw material bids, would be represented by a number of allocation variables, corresponding to the fact that the same raw material supplier can support many converters with one particular raw material. Still, due to transportation, customs, and taxation, the cost for the allocation variables would vary. Furthermore creation of variables representing the different weeks is required. In order to produce the requested report representing potential suppliers through a chain, the produced data structure would be designed to be traceable through the supply chain.

In Step (g.1), for example the reports tracing costs and other properties through the supply chain would have to be defined beforehand, and custom programmed.

In Step (h.1)-(h.3), there would have to be a custom programmed module for the entire process.

We will now describe how the same tender would be implemented as an embodiment without the need for developing a tailored platform or extensive manual work.

In Step (a.1)-(a.4), a markup language would be used to add marks into the already designed forms. Or, a separate markup document would be used that specified where to fetch information from the form. Alternatively, the user can start from system created templates and modify these to obtain desired layout etc. In this way, the need for custom programming and/or manual processing is eliminated by the use of templates.

Steps (b.1)-(b.15): The manager user would define a fact sheet for each table, and create columns within each fact sheet. If some of the data tables to import are in a simple normalized format, they can be uploaded directly and the sheet will be created automatically. If the data table is in a more complex format, such as a non-normalized format, a template can be used to guide a form interpreter which will then interpret the input document and populate the fact sheet. Also, the sheet in (b.15) would be created either by a report, from with a fact sheet is created, or by user-defined formulas. In this way, the need for custom programming and/or manual processing is eliminated by the use of fact sheets and templates.

The creation of items in (c.1) and (c.2) would be done by defining reports on fact sheets, and using these reports for defining lots. Some lot values would be calculated via aggregation formulas. For the requested bid form design, marked templates would be used.

In Step (d.1), the transport lots would be created from a report on the received bids.

In (e.1) the two-level bidding would be managed by bid formulas, where lookup is used to copy values between bids.

In (f.1) the supply chain would be configured directly by the user, by for example using balance rules and sub-bid rules.

All reports in (g) are configured by the user without any needed programming.

Stakeholder reports can be configured by the user and content controlled by access restriction. These reports can then be used for manual allocation. This supports all steps of (h).

It is noted that the above-described embodiments may comprise software. In such an embodiment, program instructions and/or a database (both of which may be referred to as “instructions”) that represents the described systems and/or methods may be conveyed or stored on a computer readable medium. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

In various embodiments, one or more portions of the methods and mechanisms described herein may form part of a cloud computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A computer-implemented method of constructing and solving optimization models comprising:
receiving via a computing device a specification comprising at least a reference to an item and a reference to an object;
creating an artificial bid based at least in part on said specification, wherein said artificial bid is associated with said item;
deriving a value associated with said artificial bid, said deriving based at least in part on said object;
formulating an optimization problem;
solving said optimization problem; and
outputting a result of said solving, where said result comprises allocation information related to said artificial bid.

2. The method of claim 1, wherein said item represents a good or a service.

3. The method of claim 1, wherein said object is one of bid, item, or bidder.

4. The method of claim 1, wherein said object is a fact row.

5. The method of claim 4, wherein said fact row represents information stored in a portion of a table.

6. The method of claim 5, wherein said portion is a row in said table.

7. The method of claim 1, wherein said formulating is based on at least said attribute value of said artificial bid.

8. The method of claim 1, wherein said artificial bid represents a potential allocation of at least part of an item to at least one bidder.

9. The method of claim 1, wherein said specification further includes a second object and wherein said deriving is based at least in part on said second object.

10. The method of claim 1, wherein said reference to an object is expressed as a selection based on one or more values associated with said object.

11. The method of claim 1, wherein said specification contains a reference to a rule and said selection is based on properties of said rule.

12. The method of claim 1, wherein said reference to an item is derived from a selection based on one or more values associated with said item.

13. A system for constructing and solving optimization models in e-sourcing, the system comprising:
an artificial bid component configured to:
receive a specification comprising at least a reference to an item and a reference to an object;
create an artificial bid based at least in part on said specification, wherein said artificial bid is associated with said item;
derive a value associated with said artificial bid, said derive based at least in part on said object;
a solver component configured to:
formulate an optimization problem;
solve said optimization problem; and
an output component configured to output a result of said solving, wherein said result comprises allocation information related to said artificial bid.

14. The system of claim 13, wherein said item represents a good or a service.

15. The system of claim 13, wherein said object is one of bid, item, or bidder.

16. The system of claim 13, wherein said object is a fact row.

17. The system of claim 16, wherein said fact row represents information stored in a portion of a table.

18. The system of claim 17, wherein said portion is a row in said table.

19. A non-transitory computer readable storage medium comprising program instructions, wherein said instructions are executable to:
receive a specification comprising at least a reference to an item and a reference to an object;
create an artificial bid based at least in part on said specification, wherein said artificial bid is associated with said item;
derive a value associated with said artificial bid, said derive based at least in part on said object;
formulate an optimization problem;
solve said optimization problem; and
output a result of said solving, where said result comprises allocation information related to said artificial bid.

20. The non-transitory computer readable storage medium of claim 19, wherein said item represents a good or a service.
